(19) United States
(12) Patent Application Publication
(10) Pub. No.: US 2018/0060540 A1
(43) Pub. Date: Mar. 1, 2018

(54) MEDIDATA CLINICAL TRIAL SYSTEM INTEGRATION WITH ORACLE CODING SYSTEM

(71) Applicant: DBMS Consulting, Inc., New York, NY (US)

(72) Inventors: Donna Caruso, Westlake Village, CA (US); Denise Clark, Maineville, OH (US)

(21) Appl. No.: 15/673,174

(22) Filed: Aug. 9, 2017

Related U.S. Application Data
(60) Provisional application No. 62/372,747, filed on Aug. 9, 2016.

(51) Int. Cl. G06F 19/00; G06F 17/30

(52) U.S. Cl. CPC G06F 19/363; G06F 19/3487; G06F 19/326; G06F 17/30575; G06F 17/30371

(57) ABSTRACT

A method of collecting, monitoring and comparing data in a multi-variable, multi-participant clinical analysis system and integrating the collection and monitoring with a thesaurus database is disclosed. The method utilizes one or more computer-based units for collecting, validating, integrating and storing the integrated data from multiple participants in a clinical study. The method also utilizes a remote main computer system connected to the computer-based collection units for receiving the uploaded integrated data from the collection unit for further processing and downloading new or modified data and collection instructions to the remote collection units with software and interfacing apparatus cooperating for downloading and inputting new or updated data, the collection units and the main computer being synchronized so that the data in all the connected units is the same.

Benefit is claimed of Provisional Application Ser. No. 62/372,727 filed Aug. 9, 2016.

### SUMMARY

The System described herein, referred to as the DBMS/TMS to Medidata Rave®Integration System, or TMSINT, is provided as a Commercial off the shelf (COTS) solution that enables a client (the System user) using the Medidata Rave electronic data capture (EDC) system to integrate the clients source study data requiring medical coding with the Oracle® Thesaurus Management System (TMS) Repository to perform medical coding and return the classifications back to the Medidata Rave EDC system. While not limited in use to data collection and subsequent analysis and tabulation of data, the primary use of the system is to collect, enter and compare patient outcomes in clinical trials of experimental drugs, medical procedures and medical devices, particularly clinical trials where there are multiple variables. MEDIDATA and MEDIDATA RAVE are registered trademarks of Medidata Solutions, Inc of New York for downloadable software for enabling clinical researchers to collect data on individuals subject to clinical trials. Once the client and participant identity is defined and configured, the TMS to Medidata Rave Integration application is available to run at a scheduled frequency or manually (ad-hoc) to extract clinical data from the client's Medidata Rave EDC source system, process the data in the Thesaurus Management System and subsequently write applicable data back to the client's Medidata Rave source system.

The key benefits of the TMS to Medidata Rave Integration application are:

1. Bi-directional integration of data in the Medidata Rave EDC system and the TMS Repository using the DBMS TMS to Medidata Rave Integration (TMSINT) application,

2. Secure data transfer via Rave Web Services (RWS) technology and encrypted authentication,

3. Coding and Recoding data from the Medidata Rave EDC system in the TMS Repository,

4. Delivering the data coded and recoded in the TMS Repository to the Medidata Rave EDC system,

5. Delivering the TMS actions (queries) in the TMS Repository to the Medidata Rave EDC system, and

6. Providing a query response from the Medidata Rave EDC system to the TMS Repository.

The key processes of the TMS to Medidata Rave Integration application are:

1. Data Extraction processes that read and stage data from the Medidata Rave EDC system to the TMS to Medidata Rave Integration application's custom staging tables in the Oracle RDBMS.

2. INBOUND_Data Formatting where the TMS to Medidata Rave Integration application's custom Staging APIs format the data in the application's custom staging tables over to the inbound tables in the Oracle RDBMS.

3. INBOUND_Data Processing where the TMS to Medidata Rave Integration application's custom INBOUND APIs processes the data in the application's inbound tables with the Oracle Thesaurus Management System (TMS) Repository. This process includes maintaining the client data “Synchronized” with the TMS Repository and addresses and interrogates the following conditions:
Has the Verbatim Term Assignment (VTA) been declassified? (patient coding is now a patient omission)
Has the VTA been classified (patient omission is now a patient coding record)
Has the VTA been re-classified? (manual reclassification or direct-match reclassification during versioning)
Has the VTA's parent DT been updated? (dictionary version upgrade)
Has the VTA's parent DT been made inactive? (dictionary version upgrade)
Has the VTA's parent DT been promoted? (dictionary version upgrade)
Has the VTA's parent DT been demoted? (dictionary version upgrade)
Has one or more components of the “Deriviation Path” changed? (i.e., has the dictionary version been upgrade)

4. INBOUND data is processed in the TMS Repository and INBOUND_Data is moved to the CODING Tables:
Programmatically codes an exact match to a dictionary term or an existing VTA in the Domain linking the TMS verbatim term to a dictionary term, and
Programmatically uses the DBMS custom Autoencoder Search Objects to code near-matches to a dictionary term or an existing VTA in the Domain linking the TMS verbatim term to a dictionary term.
If a match is still not found, using manual intervention, The TMS to Medidata Rave Integration application's custom APIs create an omission in TMS and a record in the source terms table.
An omission is handled in TMS by either coding the term or by applying an Action.

5. The TMS to Medidata Rave Integration application enables the user to proceed with Medical Coding in the TMS Repository to:
Classify Omissions,
Create, Maintain, Approve Action for Query in the Medidata Rave EDC system,
Approve Classifications (optional),
Reclassify Classifications, and
Declassify with Action

6. OUTBOUND_Data Processing: The TMS to Medidata Rave Integration application's custom OUTBOUND APIs process the data in the Oracle Thesaurus Management System (TMS) Repository with the application's outbound tables. This process includes keeping client data “Synchronized” with the TMS Repository and addresses and interrogates the following conditions:
Has the VTA been declassified? (patient coding is now a patient omission)
Has the VTA been classified (patient omission is now a patient coding record)
Has the VTA been re-classified? (manual reclassification or direct-match reclassification during versioning)
Has the VTA's parent DT been updated? (dictionary version upgrade)
Has the VTA's parent DT been made inactive? (dictionary version upgrade)
Has the VTA's parent DT been promoted? (dictionary version upgrade)
Has the VTA's parent DT been demoted? (dictionary version upgrade)
Has one or more components of the “Derivation Path” changed? (dictionary version upgrade)

7. OUTBOUND_Data Formatting: The TMS to Medidata Rave Integration application's custom Staging APIs process the data in the application's custom outbound tables to the import staging tables.

8. Data Import: Writes the import staging data containing the following data to the Medidata Rave EDC system.
Coding classifications and related dictionary details.
Open queries for the Sites to respond to the coder's queries.

### BACKGROUND

Generally speaking, the technology at issue teaches a method that allows users to make object (software) applications and relational databases to work together, despite the differences in the ways software applications and database systems organize data. Specifically, the technical problem is that no prior approach was available to provide real-time transactional XML data exchange interfaces and Data Processing APIs (Application Programming Interfaces) that support data integration and data processing via database manipulations for clinical EDC (Electronic Data Capture) applications' (e.g., Rave EDC) coding data with clinical terminology and coding applications (e.g., Oracle Thesaurus Management System).

An example of such a rational database system is provided by Oracle Corporation, Redwood City Calif. This database, as described by Oracle, is a collection of data treated as a unit. The purpose of a database is to store and retrieve related information and provide a means for managing voluminous quantities of related information. Generally, a server is programmed to reliably manage the large amount of data in a multiuser environment while providing multiple users the capability of concurrently accessing the same data. The database server also prevents unauthorized access, prevents unintentional changes to the data in the system and provides solutions for failure recovery.

The Oracle Database was one of the first databases designed for enterprise grid computing while providing flexible ways to manage information and applications. Enterprise grid computing establishes large pools of industry-standard, modular storage and servers such that each new system can be rapidly provided from the pool of components and capacity can be readily added or reallocated from the resource pools as required. The database has both logical and physical structures and because the physical and logical structures are separate, the physical storage of data can be managed without affecting the access to logical storage structures.

Oracle has several patents covering their database including, but not limited to U.S. Pat. No. 5,850,547, U.S. Pat. No. 5,991,754, U.S. Pat. No. 6,023,695, U.S. Pat. No. 7,165,065, U.S. Pat. No. 7,171,427, U.S. Pat. No. 7,299,223, U.S. Pat. No. 7,366,730, U.S. Pat. No. 7,415,457, U.S. Pat. No. 8,001,112, U.S. Pat. No. 8,200,612, U.S. Pat. No. 8,209,280, U.S. Pat. No. 8,566,341, U.S. Pat. No. 8,612,421, U.S. Pat. No. 8,812,488, U.S. Pat. No. 8,868,544, U.S. Pat. No. 9,230,007, U.S. Pat. No. 9,317,529, US Application 2004/0254947, US Application 2004/0260690, US Application 2005/0004904, US Application 20050033741, US Application 20050076065 and US Application 20110113031.

Prior approaches to allow software to operate in conjunction with the Oracle Database were addressed in several patents.

U.S. Pat. No. 5,857,197, issued Jan. 5, 1999, “System and Method for Accessing Data Stores as Objects,” (the '197 Patent) teaches the use of an adapter abstraction layer using two adapters (interfaces). According to the patentee, in regard to the two adapters or interfaces, one specializes in the object model and the other specializes in the relational database model. The '197 Patent is said to teach “basic persistence architecture” of the method with advanced features related to development, modeling, and caching which were claimed in subsequent patents.

U.S. Pat. No. 6,385,604 is directed to a method of and apparatus for joining and aggregating data elements integrated within a relational database management system (RDBMS) using a non-relational multi-dimensional data structure

U.S. Pat. No. 6,741,983 is directed to a method of indexed storage and retrieval of multidimensional information.

U.S. Pat. No. 6,985,912, issued Jan. 10, 2006, “Dynamic Object-Driven Database Manipulation and Mapping System Having a Simple Global Interface and an Optional Multiple User Need Only Caching System With Disable and Notify Features,” (the '912 Patent) is directed to the problem of user manipulation of stored data and addresses the synchronization of various copies of data.

U.S. Pat. No. 6,999,956, issued Feb. 14, 2006, “Dynamic Object-Driven Database Manipulation and Mapping System,” (the '956 Patent) teaches mapping of data between the object and relational programs using metadata in a library.

U.S. Pat. No. 7,043,481, issued May 9, 2006, “System, Method and Software for Creating, Maintaining, Navigating or Manipulating Complex Data Objects and Their Data Relationships,” (the '481 Patent) describes a Complex Data Object Graph (CDOG) model that captures the various relationships between objects and teaches how to represent, manage, an effectively access the various relationships.

U.S. Pat. No. 7,103,600, issued Sep. 5, 2006 is titled “Displayable Presentation Page and SQL Searchable Relational Data Source Implementation of a System, Method and Software for Creating or Maintaining Distributed Transparent Persistence of Complex Data Objects and Their Data Relationship.” (the '600 Patent) and U.S. Pat. No. 7,167,62, issued Jan. 23, 2007 is titled, “Session Bean Implementation of a System, Method and Software for Creating or Maintaining Distributed Transparent Persistence of Complex Data Objects and Their Data Relationships.” (the '862 Patent) teach how to maintain persistence in saving and storing objects and their relationships.

U.S. Pat. No. 7,149,730, issued Dec. 12, 2006, “Dynamic Class Inheritance and Distributed Caching with Object Relational Mapping and Cartesian Model Support in a Database Manipulation and Mapping System,” (the '730 Patent) is directed to working with multiple data stores that contain information organized differently.

U.S. Pat. No. 7,272,612 is directed to method of partitioning data records.

U.S. Pat. Nos. 7,454,411 and 7,882,106 are directed to methods of indexed storage and retrieval of multidimensional information.

U.S. Pat. No. 8,099,733 is directed to parallel data processing architecture.

U.S. Pat. No. Re. 40,526, which is a reissue of U.S. Pat. No. 5,617,567, is directed to a data processing system and method for retrieving an entity specified in a search path record from a relational database.

U.S. Pat. No. Re. 40,520, which is a reissue of U.S. Pat. No. 5,826,259, is directed to an expandable data processing system and method.

According to the Oracle Systems literature a user can partially or fully integrate the Oracle® Thesaurus Management System (TMS) with non-Oracle source data systems, but they leave it to the user to handle the data exchange. If full integration is desired, the user must “customize” the external system to make it compatible with TMS.

More specifically, full integration requires the installation of TMS objects into the external system, for stable operation of the external system in the global Oracle environment. If fully integrated, TMS maintains external data in both the tms_source_terms table and the tms_vt_omissions table. The fully integrated system will then benefit from the full range of functionality provided by the TMS. The fully integrated external system will then feed source terms to TMS with contextual data specified by the user (such as Document Number) so that if the data is reclassified or declassified TMS can then send information about each affected source term back to the external source data system.

In TMS, the user runs Autoclassification, manually classifying remaining terms (omissions), assigning Actions, and reclassifying or declassifying as necessary and specifies the information derived from TMS for each source term. TMS then sends that data to the source data system associated with each source term.

However, for a user to fully integrate a non-Oracle system with TMS, Oracle leaves it up to the user to devise ways to:
Associate the source term collection unit, (for example a study or case depending on the source data system)-with TMS domains and dictionaries (the X Area is the source term collection unit in both the tms_source_terms table and the tms_vt_onlissions table)
Define objects to receive values derived from TMS
Integrate TMS with the external system's discrepancy management function, and
Exchange data between the two systems

The technical problem is that Oracle TMS does NOT provide users with any instructions or suggestions on how to fully integrate with non-Oracle source data systems. The customers “must handle the data exchange”, “must devise ways to: 1) associate the source term collection unit for a study or case, with TMS domains and dictionaries 2) Define objects to receive values derived from TMS, 3) Integrate TMS with the external system's discrepancy management function, and 4) Exchange data between the two systems”. Extensive customization of the external system is also required, such as installing Oracle TMS objects into other proprietary external data system environments, which may not be possible, or in fact prohibits, when those systems are hosted by a third party.

The DBMS TMSINT system described herein provides a technical solution that provides users with a system, which fully integrates a non-Oracle source data systems, referred to as Medidata Rave. The DBMS TMSINT system handles the data exchange and associates the source term collection unit with TMS domains and dictionaries. TMSINT defines objects to receive values derived from TMS and integrates TMS with the external system's query management functionality. TMSINT exchanges data between the two systems in a scheduled or on-demand (immediate) manner and does NOT require the external system to install Oracle TMS objects into other proprietary external data system environments.

### BRIEF DESCRIPTION OF THE DRAWINGS

FIG. 1 is a schematic diagram showing the data flow for the TMS to Medidata Rave Integration application. For clarity FIG. 1 has been divided into two pieces with the left portion appearing as FIG. 1A on Figure page 1/39 and the right portion appearing as FIG. 1B on Figure page 1/39.

FIG. 2 is a schematic representation of the extraction of Client Source Data via Web-Services.

FIG. 3 is an example of a Client TMS Integration Definition Worksheet.

FIG. 4 is an example of an auto match display.

FIG. 5 is an example of an auto match display showing locating equivalent terms.

FIG. 6 is an example of an auto match display showing locating non-equivalent terms.

FIGS. 7 and 8 are example displays showing re-submit terms to be re-coded.

FIG. 9 is an example of a screen display showing export coding data and queries from TMS.

FIGS. 10 and 11 are examples of a screen display showing associated source data and actions/queries created in TMS.

FIG. 12 is an example of a screen display showing multiple synonym lists created to enable different synonym lists to be linked to different studies with the TMS Domain/Dictionary functionality.

FIG. 13 is an example of multiple screen displays showing different TMS enabled approval workflows by domain illustrating that one study/program can automatically approve a VTA when it is classified while the other study can enforce the manual approval process after classification.

FIG. 14 is an example of a screen display showing TMS accessed by multiple users at the same time allowing the coder to filter using the TMS Omission Filter.

FIG. 15 is an example of a screen display showing, while coding, that the user can sort coded data within the TMS Classify VT Omissions. For clarity FIG. 15 has been divided into two pieces with the top portion appearing as FIG. 15A on Figure page 13/39 and the bottom portion appearing as FIG. 15B on Figure page 14/39.

FIG. 16 is an example of multiple displays on a single screen showing TMS browsing capabilities that makes ingredients visible when coding in WHO DDE and all multi-axial relationships are able to be seen.

FIG. 17 illustrates that the TMSINT application then propagates the Ingredients and Dictionary Version to Medidata Rave.

FIG. 18 illustrates that the TMSINT application allows the user to “Drill Down” through the data to obtain auxiliary information.

FIG. 19 are three examples of screens showing the ability of TMS to attach and view status codes or notes to coded and uncoded terms. For clarity FIG. 19 has been divided into two pieces with the top portion appearing as FIG. 19A on Figure page 18/39 and the bottom portion appearing as FIG. 19B on Figure page 19/39.

FIG. 20 is an example of a screen display showing approval of VTAs. For clarity FIG. 20 has been divided into two pieces with the top portion appearing as FIG. 20A on Figure page 20/39 and the bottom portion appearing as FIG. 20B on Figure page 21/39.

FIG. 21 illustrates that the user has the option to use a two-step coding process with a second coder acknowledging approval of the code.

FIG. 22 is a screen shot illustrating that TMS is able to perform ATC coding for medications in a single step. For clarity FIG. 22 has been divided into two pieces with the top portion appearing as FIG. 22A on Figure page 23/39 and the bottom portion appearing as FIG. 22B on Figure page 24/39.

FIG. 23 is a screen shot illustrating that for Drug Dictionaries without Primary Links or Paths on the ATC Levels, the Indication Omissions window is available. For clarity FIG. 23 has been divided into two pieces with the top portion appearing as FIG. 23A on Figure page 25/39 and the bottom portion appearing as FIG. 23B on Figure page 26/39.

FIG. 24 illustrates Auto-coding to previously coded verbatim code individual (VTIs). For clarity FIG. 24 has been divided into two pieces with the top portion appearing as FIG. 24A on Figure page 27/39 and the bottom portion appearing as FIG. 24B on Figure page 28/39.

FIG. 25 illustrates automatic ATC classification of a drug based on previous ATC classification of the same drug having the same indication. For clarity FIG. 25 has been divided into two pieces with the top portion appearing as FIG. 25A on Figure page 29/39 and the bottom portion appearing as FIG. 25B on Figure page 30/39.

FIG. 26 illustrates the TMSINT application Custom auto-coding search object algorithms automatically coding verbatim terms to the Medical and Drug Dictionaries.

FIG. 27 is a flow diagram illustrating the Oracle TMS to Medidata Rave Integration (TMSINT) application with Autocoder.

FIG. 28 is a screen image illustrating the Custom Autocoder Partial Word Substitution Design.

FIG. 29 is a screen image illustrating the Custom Autocoder Full Word Substitution Design.

FIG. 30 is a schematic representation of the Oracle TMS to Medidata Rave Integration (TMSINT): Architecture incorporating features of the invention. For clarity FIG. 30 has been divided into two pieces with the left portion appearing as FIG. 30A on Figure page 35/39 and the bottom portion appearing as FIG. 30B on Figure page 36/39.

FIG. 31 is a schematic representation of the OHS 5.1.x Logical Architecture.

FIG. 32 is a screen image illustrating user administration of overview of the system comprising creating, configuring, modifying, and inactivating portions of the stored records.

FIG. 33 is a sample of a Client definition based on a new client worksheet.

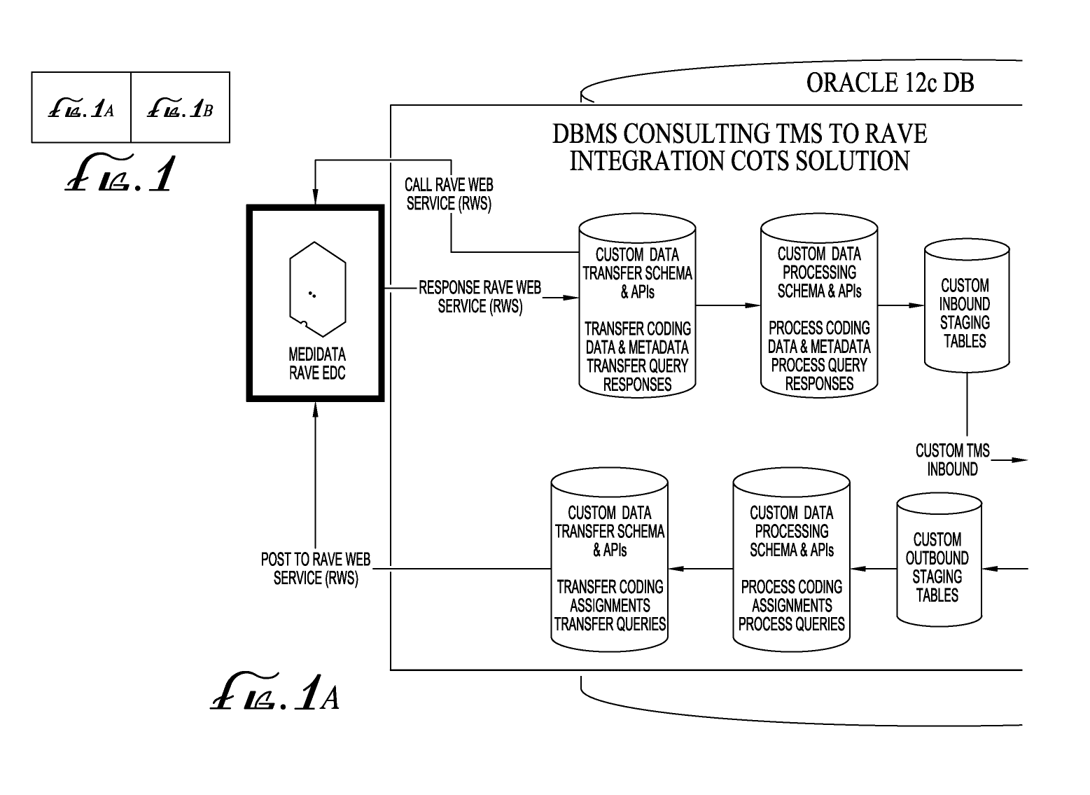

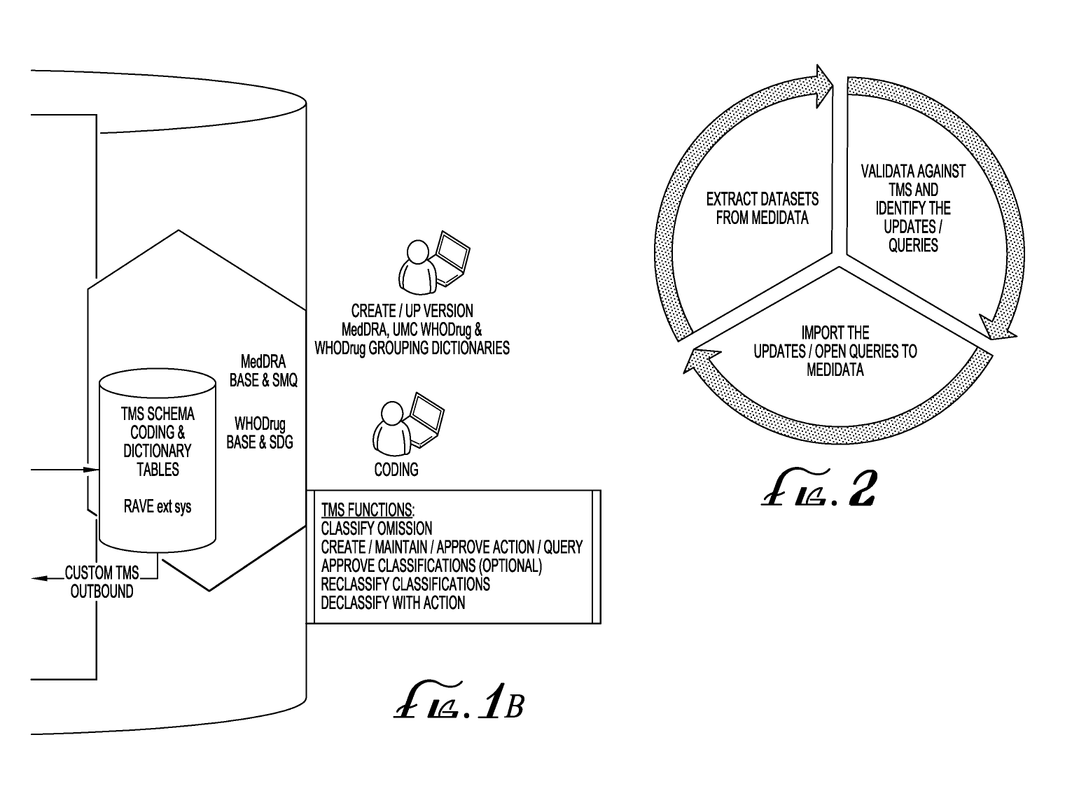

### DETAILED DISCUSSION

The TMSINT system described herein provides the approaches and methods for:
1) Real-time transactional XML data exchange interfaces and Data Processing APIs (Application Programming Interfaces) that support data integration and data processing via database manipulations for clinical EDC (Electronic Data Capture) applications' (e.g., Rave EDC) coding data with clinical terminology and coding applications (e.g., Oracle Thesaurus Management System).
2) A user interface to configure the XML data exchange between the EDC (Electronic Data Capture) applications and clinical terminology and coding applications.

The XML data exchange can be scheduled to run at predetermined frequencies and run on-demand.

The key processes of the application are:

Integration Configuration: Allows the transactional data exchange interfaces to be configured at the clinical study level via a user interface.

Data Extract: Reads and stages data from the clinical EDC applications to the TMSINT system's custom staging tables in the Oracle RDBMS.

INBOUND_Data Formatting: The TMSINT system's custom Staging APIs process the data in the application's staging tables to the application's inbound tables in the Oracle RDBMS.

INBOUND_Data Processing: The TMSINT system's custom INBOUND APIs process the data in the application's inbound tables with the clinical terminology and coding application. This process includes keeping client data “Synchronized” with the clinical terminology and coding application and interrogates the clinical coding conditions such as declassification, classification, reclassification, data updates, data promotions, data demotions and changes to the terminology hierarchy derivational path.

Processing INBOUND data in the clinical terminology and coding application and Moving INBOUND_Data to the CODING Tables:
Programmatically codes an exact match to a dictionary term or an existing VTA in the Domain linking the coding application verbatim term to a dictionary term.
Programmatically uses the DBMS Auto encoder Search Objects to code near-matches to a dictionary term or an existing VTA in the Domain linking the coding application verbatim term to a dictionary term.
If a match is still not found, manual intervention is required. The TMSINT system's custom APIs create an omission in coding application and a record in the source terms table.
An omission must be handled in the coding application by either coding the term or by applying an Action.

The TMSINT system enables the user to proceed with Medical Coding in the coding application to:
Classify Omissions
Create, Maintain, Approve Action for Query in the EDC application.
Approve Classifications (optional)
Reclassify Classifications
Declassify with Action

OUTBOUND_Data Processing and Database Manipulation: The TMSINT system's custom OUTBOUND APIs process the data in the coding application with the system's outbound tables. This process includes keeping client data “Synchronized” with the TMS Repository and interrogates the clinical coding conditions such as declassification, classification, reclassification, data updates, data promotions, data demotions and changes to the terminology hierarchy derivational path.

OUTBOUND_Data Formatting: The TMSINT system's custom Staging APIs process the data in the application's outbound tables to the import staging tables.

Data Import: Writes the import staging data containing the following data to the clinical EDC application.
Coding classifications and related dictionary details.
Open queries for the Sites to respond to the coder's queries.

The mandatory and optional components that are required for client usage of the DBMS TMS to Medidata Rave Integration (TMSINT) application are set forth below in detail. A series of metadata tables are used to store specific information about a client's Medidata Rave source system data. The TMS to Medidata Rave Integration application relies on the application metadata tables to programmatically parse, extract, process and re-import data back into the client's Medidata Rave source system.

The main components of the client requirements definition and configuration processes include the following topics:

1. TMS Setup & Definition
TMS Dictionaries
TMS External System Definitions
TMS Drill-Down Views
TMS Custom Search Objects
TMS Custom VTA Load Utility
TMS Custom Dictionary VTA Copy Utility

2. Oracle Account Setup
Application Administrator Account
Data-Transfer Account
Data-Processing Account

3. TMS to Medidata Rave Integration Setup & Requirements Definition
Client Definition
Datafile Definition
Dictionary Mapping
External System Mapping
Ancillary Data
Account Registration

4. TMS to Medidata Rave Integration Client Metadata Requirements Definition Template

5. Gathering Client Requirements

TMS Setup—Described below are the setup and definition within the TMS application. Before the client can be configured within the TMS for Medidata Rave Integration application, the TMS setup must be completed.

TMS Dictionaries—Any TMS dictionaries that are used by the TMS to Medidata Rave Integration application are defined and created in TMS before they can be referenced in the TMS to Medidata Rave Integration application. TMS dictionaries are not shared between clients. All dictionaries used by the TMS to Medidata Rave

Integration application are specific to a given client and are determined based on the individual client's requirement.

However, several prewritten “standard” dictionary packages are available that can be easily implemented for a client. Each standard dictionary package, as shown below, includes the TMS dictionary definition, initial dictionary loading, dictionary versioning upgrade and canned impact reporting. The client specifies at the onset what vendor dictionary format (if applicable) and dictionary version are to be initially loaded for TMS to Medidata Rave Integration use and specify a version upgrade schedule. Specific information on the TMS dictionary definition and “derivation path” are separately provided to the client.

All dictionary versioning requires the creation of a TMS virtual dictionary upon upgrade. However, the creation and copy of vtas to virtual dictionary domains are not required unless the client wishes to allow coding to TMS virtual dictionaries which are specified by requirement at the onset of the project.

The DBMS prewritten “standard” TMS dictionary packages are as follows

SO meddra Dictionary—The MSSO meddra dictionary package includes the TMS dictionary definition of a standard “Primary Path” meddra dictionary. The dictionary classification level is the LLT level. The “derivation path” includes the LLT, PT and the HLT, HLGT and SOC of the primary path. As LLTs are made non-current by the vendor, they are logically deleted within the TMS repository. Due to the limited variation of the meddra dictionary implementation, this dictionary package may be used by most if not all clients.

UMC WHO Drug Dictionary (B2 format)—The UMC WHO drug B2 dictionary package includes the TMS dictionary definition of a standard “Primary Link” drug dictionary. The dictionary classification level includes both the preferred drug term (PT) and the trade drug term synonym (SYN) drug levels. The dictionary includes the UMC ATC5 dictionary level. The UMC ATC long text value is provided as an additional attribute (VALUE_1) for all ATC levels. The UMC provided ingredient-list is implemented as a TMS informative note (“INGLIST”) assigned to the PT dictionary level. The defined dictionary levels are ATC1-ATC5, PT, SYN, ING, SRC and CCODE. Manufacturers are considered obsolete in the B2 format by the vendor and are not used. The “derivation path” includes the SYN, PT and the ATC hierarchy of the designated primary ATC. Any of the UMC provided B2 formats may be used with this dictionary definition such as the DD, DDE or DDE-HD formats.

UMC WHO Drug Dictionary (C format)—The UMC WHO drug C dictionary package includes an implementation as available from Oracle. Any if the UMC provided C formats may be used with this dictionary definition such as the DD, DDE or DDE-HD formats.

UMC WHO Drug Dictionary (B3 format)—The UMC WHO drug B3 format will be implemented as a standard dictionary package in future releases. This version of the drug dictionary is not currently compatible for use with the TMS application and will be implemented for later releases of TMS with expanded column lengths.

MSSO meddra & SMQ Filter Dictionary—The MSSO meddra & SMQ dictionary package includes the standard meddra dictionary as specified above as well as the additional SMQ (Standard meddra Query) filter dictionary. This dictionary is a vendor-only dictionary and does not support custom SMQs. When selecting this dictionary package, the meddra and SMQ filter dictionary will be defined, loaded and versioned at the same time. Both dictionaries will be treated programmatically as one dictionary in the context of loading and upgrading. The SMQ filter dictionary is implemented as a standard SMQ filter dictionary as specified by the vendor.

UMC WHO Drug & SDG Filter Dictionary—The UMC WHO Drug & SDG dictionary package includes the standard B2 dictionary as specified above as well as the additional SDG (Standard Drug Query) filter dictionary. This dictionary is a vendor-only dictionary and does not support custom SDGs. When selecting this dictionary package, the WHO Drug and SDG filter dictionary will be defined, loaded and versioned at the same time. Both dictionaries will be treated programmatically as one dictionary in the context of loading and upgrading. The SDG filter dictionary is implemented as a standard SDG filter dictionary as specified by the vendor. Functionality will be provided to programmatically allow the creation of ATC/SDG and PT/SDG relationships that are overlapping or the removal of overlapping ATC/SDG and PT/SDG relationships.

Custom meddra SMQ Filter Dictionary—The Custom meddra & SMQ dictionary package includes the standard meddra dictionary as specified above as well as the additional SMQ (Standard meddra Query) filter dictionary with additional custom SMQ dictionary levels (CMQs). The meddra dictionary is a vendor-only dictionary. However, the SMQ dictionary supports the creation of custom CMQs. When selecting this dictionary package, the meddra and SMQ filter dictionary will be defined, loaded and versioned at the same time. Both dictionaries will be treated programmatically as one dictionary in the context of loading and upgrading.

Custom WHO Drug SDG Filter Dictionary—The Custom WHO Drug & SDG dictionary package includes the standard B2 WHO Drug dictionary, as specified above. As well as the additional SDG (Standard Drug Groups) filter dictionary with additional custom SDG dictionary levels (CDGs). The WHO Drug dictionary is a vendor-only dictionary. However the SDG dictionary supports the creation of custom cdgs. When selecting this dictionary package, the WHO Drug and SDG filter dictionary will be defined, loaded and versioned at the same time. Both dictionaries will be treated programmatically as one dictionary in the context of loading and upgrading.

TMS External Systems—The TMS to Medidata Rave Integration application requires that the TMS external system the client will use for the TMS to Rave integration is defined within the TMS repository prior to defining and configuring the TMS to Medidata Rave Integration application.

TMS allows for up to eight external column values for a given external system. Each external value may be up to 500 characters in length. These external values are “key” values within the client's source system used to identify unique patient records within the client's source system. These values typically include Study, Site, DCM, Patient, etc. And may be customized as needed. Since these values are “key” values, they are expected to remain constant. The TMS to Medidata Rave Integration application has been designed to allow for a Site location to change provided one of the eight external column names is specified as “SITE”. This value is the designated “snowbird” column to accommodate those patients that live in a different location during different calendar months, for example the winter months. If no external column name is named “SITE”, this functionality will not be enabled and any update to a “key” value will cause the system to treat the patient record as if it were a brand new patient record and will disconnect any audit trail capability between previous versions of the patient record.

If more than the eight values provided by TMS are needed to uniquely identify a patient record within the client's source system, the TMS to Medidata Rave Integration application can store up to two values per individual column allowing the ability to store sixteen external values. If columns are “shared” in this manner, there may be no more than two values stored per external column and the data values will be delimited with the “I” character within TMS. Any custom omission status requirements will need to be specified as a requirement by the client at the onset of the project. If no requirement is specified, the default omission status “Site from Coder” will be used from the TMS pre-defined “DISCREPANCY REV STATUS CODE” codelist.

TMS Custom Drill-Down Views—An optional Custom TMS Drill-Down views solution for the medical coder to see auxiliary study data from the Rave source system while coding in TMS (e.g., the county, indication, route, dosage for medications or any other applicable study data the coder requires to make the right choices while coding) is provided. These Custom TMS Drill-Down views are optionally available and may be defined for any client TMS external system. The number of drill-down views that may be created in TMS is contingent on the number of external columns defined within the external system. Additional client requirements will need to be specified to indicate what data will be displayed in each drill-down view as well what external column the drill-down view will be associated with. When one or more drill-down views are specified, the corresponding ancillary data is defined within the TMS to Medidata Rave Integration application. See Ancillary Data Definition section below.

TMS Custom Search Objects An optional Custom TMS search object solution within TMS to enable Verbatim terms to code to non-equivalent dictionary terms with the use of word swapping, word substitutions, special character/number/punctuation/stop word removal, and other types of matching algorithms during the classification process in TMS is provided. The Custom TMS search object solution that is provided is designed for use with the meddra AE dictionary and/or WHO drug dictionary. The defined word substitutions and stop word removal are configurable for each client using a TMS codelist.

TMS Custom VTA Load Utility—An optional Custom TMS VTA load utility to enable a client to populate the TMS meddra or whodrug dictionaries with their existing synonym or verbatim term assignment (VTA) lists is provided The client provides a spreadsheet containing desired Synonym or VTA mappings that may be loaded into the client's TMS meddra or whodrug dictionaries.

TMS Dictionary Custom VTA Copy Utility An optional Custom TMS dictionary VTA copy utility is provided which will enable a client to copy VTAs from one TMS dictionary to another TMS dictionary within the same TMS database instance for the purpose of keeping the coding “synchronized” between a designated source and target dictionary.

Oracle Account Setup

The TMS to Medidata Rave Integration application requires the following Oracle client specific accounts to be defined with the Oracle database.

Client Data-Transfer Account—Each client using the TMS to Medidata Rave Integration application has a designated Oracle data-transfer schema. The schema name is a user name of TMSINT_XFER_<clientcode> where <clientcode> is the 3-6 character code used to identify a given client. The data-transfer schema is not a privileged Oracle account and is responsible for the transfer of data from and to the client source system. Each client specific data-transfer schema may see only data that is applicable to the given client. The data-transfer schema will be created with the following objects set forth in Table 1:

TABLE 1

| | OBJECT | | |
|---|---|---|---|
| OBJECT NAME | TYPE | OWNER | DESCRIPTION |
| TMSINT_XFER_HTML_{—} | Table | Transfer | Oracle staging table |
| EXTRACT | | schema | containing all HTML data |
| | | | extracted from the client |
| | | | source system that is |
| | | | subject to TMS |
| | | | processing. Data written |
| | | | to the table by the data- |
| | | | transfer schema and |
| | | | marked with a process |
| | | | flag of “N”. Once data has |
| | | | been processed by the |
| | | | data-processing schema, |
| | | | the data will be removed. |
| | | | This table is a staging |
| | | | table and data will not |
| | | | persist. Clinical data |
| | | | written to the table from |
| | | | the client's source system |
| | | | is cumulative in nature. |
| TMSINT_XFER_HTML_{—} | Table | Transfer | Oracle staging table |
| IMPORT | | schema | containing all HTML data |
| | | | processed in TMS and is |
| | | | pending update in the |
| | | | client's source system. |
| | | | Data written to this table is |
| | | | also cumulative and will |
| | | | contain client data that |
| | | | has successfully coded in |
| | | | TMS and is approved as |
| | | | well as clinical data that |
| | | | did not successfully code |
| | | | in TMS and has been |
| | | | actioned (open query) in |
| | | | TMS. |
| TMSINT_XFER_UTILS | Synonym | TMSINT | Oracle package containing |
| | (Package) | Administrator | all APIs applicable to the |
| | | | data-transfer schema for |
| | | | inserting, updating, |
| | | | deleting and querying data |
| | | | in the extract and import |
| | | | tables. |
| TMSINT_XFER_HTML_{—} | Synonym | TMSINT | Oracle object types |
| EXTRACT_OBJR | (Object | Administrator | applicable to the |
| TMSINT_XFER_HTML_{—} | Types) | | TMSINT_XFER_HTML_{—} |
| EXTRACT_OBJT | | | EXTRACT table |
| TMSINT_XFER_HTML_{—} | Synonym | TMSINT | Oracle object types |
| IMPORT_OBJR | (Object | Administrator | applicable to the |
| TMSINT_XFER_HTML_{—} | Types) | | TMSINT_XFER_HTML_{—} |
| IMPORT_OBJT | | | IMPORT table |
| TMSINT_PROC_LOGGING_{—} | Synonym | TMSINT | Oracle object types |
| OBJR | (Object | Administrator | applicable to the |
| TMSINT_PROC_LOGGING_{—} | Types) | | TMSINT_PROC_LOGGING |
| OBJT | | | table. The Oracle table |
| | | | is owned by the data- |
| | | | processing schema; |
| | | | however, all Oracle object |
| | | | types are owned by the |
| | | | administrator schema |

Client Data-Processing Account—Each client using the TMS to Medidata Rave Integration application has a designated Oracle data-processing schema. The schema name is a user name of TMSINT_PROC_<ClientCode> where <ClientCode> is the 3-6 character code used to identify a given client. The data-processing schema is a privileged Oracle account and is responsible reading data extracted from the client's source system by the data-transfer schema, processing the data in TMS and writing the data back to the data-transfer schema import table. Each client specific data-processing schema may see only data that is applicable to the given client. The data-processing schema will be created with the following objects set forth in Table 2:

TABLE 2

| | OBJECT | | |
|---|---|---|---|
| OBJECT NAME | TYPE | OWNER | DESCRIPTION |
| TMSINT_PROC_INBOUND | Table | Processing | Oracle staging table |
| | | schema | containing data from the |
| | | | data-transfer table |
| | | | TMSINT_XFER_HTML_{—} |
| | | | EXTRACT that has been |
| | | | formatted into logical |
| | | | records usable by TMS |
| TMSINT_PROC_INBOUND_{—} | Table | Processing | Oracle staging table |
| DTLS | | schema | containing data from the |
| | | | data-transfer table |
| | | | TMSINT_XFER_HTML_{—} |
| | | | EXTRACT that has been |
| | | | formatted into logical |
| | | | records usable by TMS |
| | | | (Ancillary Data only) |
| TMSINT_PROC_INBOUND_{—} | Table | Processing | Oracle staging table |
| DERV | | schema | containing the TMS |
| | | | derivation path for those |
| | | | records processed in |
| | | | TMSINT_PROC_INBOUND |
| | | | that were successfully |
| | | | coded in TMS (VTAs) |
| TMSINT_PROC_CODING | Table | Processing | Oracle table containing all |
| | | schema | client data currently within |
| | | | the TMS repository. The |
| | | | data in this table will |
| | | | persist and will be updated |
| | | | accordingly during TMS |
| | | | processing based on |
| | | | INBOUND data. |
| TMSINT_PROC_CODING_{—} | Table | Processing | Oracle table containing all |
| DTLS | | schema | current client ancillary |
| | | | data. The data in this |
| | | | table is persistent and will |
| | | | be updated during TMS |
| | | | processing based on the |
| | | | INBOUND-DTLS table. |
| TMSINT_PROC_CODING_{—} | Table | Processing | Oracle table containing all |
| DERV | | schema | current client derivation |
| | | | path data. The data in this |
| | | | table is persistent and will |
| | | | be updated during TMS |
| | | | processing based on the |
| | | | INBOUND-DERV table |
| TMSINT_PROC_CODING_JN | Table | Processing | Oracle table containing |
| | | schema | audit-trail (journaling) data |
| | | | from |
| | | | TMSINT_PROC_CODING |
| | | | when a record is updated |
| | | | or deleted from |
| | | | TMSINT_PROC_CODING |
| TMSINT_PROC_CODING_{—} | Table | Processing | Oracle table containing |
| DTLS_JN | | schema | audit-trail (journaling) data |
| | | | from |
| | | | TMSINT_PROC_CODING_{—} |
| | | | DTLS when an ancillary |
| | | | data record is added, |
| | | | deleted or updated in |
| | | | TMSINT_PROC_CODING_{—} |
| | | | DTLS. |
| TMSINT_PROC_CODING_{—} | Table | Processing | Oracle table containing |
| DERV_JN | | schema | audit-trail (journaling) data |
| | | | from |
| | | | TMSINT_PROC_CODING_{—} |
| | | | DERV when a TMS |
| | | | derivation path record is |
| | | | updated in |
| | | | TMSINT_PROC_CODING_{—} |
| | | | DERV. |
| | | | (Dictionary version |
| | | | upgrades) |
| TMSINT_PROC_UTILS | Synonym | TMSINT | Oracle package containing |
| | (Package) | Administrator | all APIs applicable to the |
| | | | data-processing schema |
| | | | TMS functionality |
| TMSINT_ADM_DICT_{—} | Synonym | TMSINT | Oracle view containing |
| VERSIONS | (View) | Administrator | TMS dictionaries and their |
| | | | corresponding type and |
| | | | version |
| TMSINT_ADM_DICT_ING_{—} | Synonym | TMSINT | Oracle view containing |
| LISTS | (View) | Administrator | TMS WHO Drug dictionary |
| | | | PT-SYN Ingredients List |
| | | | that may be derived back |
| | | | to the client source system |
| | | | (TMS Info-notes are not |
| | | | derivable) |
| TMSINT_ADM_DERV_PATH_{—} | Synonym | TMSINT | Oracle view containing the |
| LEVELS | (View) | Administrator | TMS Dictionary derivation |
| | | | path dictionary levels |
| TMSINT_ADM_DERV_PATH_{—} | Synonym | TMSINT | Oracle view containing the |
| COLUMNS | (View) | Administrator | TMS Dictionary derivation |
| | | | path dictionary level |
| | | | columns that will be |
| | | | written to the DERV table |
| | | | (code, term, status, |
| | | | category, value_1, |
| | | | content_id, etc.) |
| TMSINT_XFER_HTML_{—} | Synonym | TMSINT | Oracle object types |
| EXTRACT_OBJR | (Object | Administrator | applicable to the |
| TMSINT_XFER_HTML_{—} | Types) | | TMSINT_XFER_HTML_{—} |
| EXTRACT_OBJT | | | EXTRACT table |
| TMSINT_XFER_HTML_{—} | Synonym | TMSINT | Oracle object types |
| IMPORT_OBJR | (Object | Administrator | applicable to the |
| TMSINT_XFER_HTML_{—} | Types) | | TMSINT_XFER_HTML_{—} |
| IMPORT_OBJT | | | IMPORT table |
| TMSINT_PROC_INBOUND_{—} | Synonym | TMSINT | Oracle object types |
| OBJR | (Object | Administrator | applicable to the |
| TMSINT_PROC_INBOUND_{—} | Types) | | INBOUND tables |
| OBJT | | | |
| TMSINT_PROC_INBOUND_{—} | | | |
| DTLS_OBJR | | | |
| TMSINT_PROC_INBOUND_{—} | | | |
| DTLS_OBJT | | | |
| TMSINT_PROC_INBOUND_{—} | | | |
| DERV_OBJR | | | |
| TMSINT_PROC_INBOUND_{—} | | | |
| DERV_OBJT | | | |
| TMSINT_PROC_CODING_{—} | Synonym | TMSINT | Oracle object types |
| OBJR | (Object | Administrator | applicable to the CODING |
| TMSINT_PROC_CODING_{—} | Types) | | tables |
| OBJT | | | |
| TMSINT_PROC_CODING_{—} | | | |
| DTLS_OBJR | | | |
| TMSINT_PROC_CODING_{—} | | | |
| DTLS_OBJT | | | |
| TMSINT_PROC_CODING_{—} | | | |
| DERV_OBJR | | | |
| TMSINT_PROC_CODING_{—} | | | |
| DERV_OBJT | | | |
| TMSINT_PROC_CDING_JN_{—} | Synonym | TMSINT | Oracle object types |
| OBJR | (Object | Administrator | applicable to the CODING |
| TMSINT_PROC_CDING_JN_{—} | Types) | | JN audit tables |
| OBJT | | | |
| TMSINT_PROC_CDING_{—} | | | |
| DTLS_JN_OBJR | | | |
| TMSINT_PROC_CDING_{—} | | | |
| DTLS_JN_OBJT | | | |
| TMSINT_PROC_CDING_{—} | | | |
| DERV_JN_OBJR | | | |
| TMSINT_PROC_CDING_{—} | | | |
| DERV_JN_OBJT | | | |
| TMSINT_PROC_LOGGING_{—} | Synonym | TMSINT | Oracle object types |
| OBJR | (Object | Administrator | applicable to the |
| TMSINT_PROC_LOGGING_{—} | Types) | | TMSINT_PROC_LOGGING |
| OBJT | | | table. The Oracle table |
| | | | is owned by the data- |
| | | | processing schema; |
| | | | however, all Oracle object |
| | | | types are owned by the |
| | | | administrator schema |

TMS to Medidata Rave Integration Client Setup & Definition

The following is a description of the components of the TMS to Medidata Rave Integration application definition process that is specific to a given client. It should be noted that a client may not be defined within the TMS to Medidata Rave Integration application until the TMS definition has been completed. The TMS dictionaries, external systems, etc. must exist within the TMS application prior to setting up the client within the TMS to Medidata Rave Integration application. The administrator is the only_user authorized to manage client definitions and setup. The Oracle database package TMSINT _ADM _UTILS owned by the administrator contains the application APIs in which the administrator may create, update, delete, enable or disable client related data.

Client Definition—The first step for defining a client within the TMS to Medidata Rave Integration application is to create a client definition entry in a metadata table TMSINT_ADM_CLIENTS. Only the administrator is authorized to create a new client. Each client has a unique AliasCode and unique ClientID that will be used by the application. The ClientID and ClientAlias values may not be modified after the creation of the client record. The ClientID is used as a foreign key reference in other tables for linking attributes to a specific client. Oracle database objects and Oracle user accounts are subsequently created using the ClientAlias value. Described below are various TMSINT ADM CLIENTS files.

Creating a Client—The API CREATE_CLIENT is used to create a client definition record in the TMSINT ADM CLIENTS table. The administrator selects a unique 3-6 character code that will identify the client. The client code is used internally by the application only and will not be used by or written to the client's source system. Therefore, this value may be selected by the administrator. It is preferred that the client code visually identify the client to which it is assigned. For example, “NOV” may be used for Novartis, “BMS” may be used for Bristol-Myers Squibb and “INV” may be used for Inventive Health. The client description may be any value up to 200 characters and is recommended to be the full name of the client. A ClientID will automatically be assign during execution of the API. A ClientID is required for any additional setup or definition for the client.

Updating a Client—The API UPDATE_CLIENT is used to update an existing client definition record in the TMSINT_ADM_CLIENTS table. The only expected updates to a client definition after creation are the update of the client description or the active flag. Setting the activate flag from “Y” to “N” will stop all integration processing for the client. Likewise, setting the active flag from “N” to “Y” will restart integration processing for the client provided at least one datafile is also active. Any required value within the table in which the API has a default of NULL is simply a means to allow the user to enter only the values that they want to update. For example, the pActiveFlag parameter has a default value of NULL. If the pActiveflag value is not provided or a NULL value is provided, the API will assume the user is not updating that value and the current value will not be changed.

Deleting a Client—The API DELETE_CLIENT is used to delete client definition record from the TMSINT_ADM_CLIENTS table. When a client is deleted, all subordinate client metadata will likewise be deleted (datafiles, dictionary mappings, etc.). The Oracle accounts associated with the client are manually deleted from the database by the DBA; however, the registration of the Oracle accounts will be deleted from the application.

Querying a Client—The API QUERY_CLIENT is used to query any client definition record in the TMSINT_ADM_CLIENTS table. The API is a pipelined function based on the TMSINT_ADM_CLIENTS table and may therefore be executed as any query from the SQL command line.

Datafile Definition—After a client definition has been defined and a ClientID assigned, individual datafiles are then be created. Datafile definitions for a client are stored in a metadata table entitled TMSINT_ADM_DATAFILES. A client may have one or more datafiles. At least one active datafile is required for integration processing. Normally there is a one to one correspondence between a clinical study and a datafile and each study will have its own record entry in the TMSINT_ADM_DATAFILES table. Metadata in the TMSINT_ADM_DATAFILES table will specify the URL and credentials (if any) required to connect to the client's source system for both the extraction of data as well as the import of data. Data extracted and imported will be in an HTML format. Additionally, the HTML tags for both the beginning of the HTML file and beginning of new patient record is specified. The end of file and end of record file HTML tags may be derived from the beginning of file and beginning of record values. The ActiveFlag value can be used to enable and disable the given file from integration processing.

Creating a New Datafile—The API CREATE_DATAFILE is used to create a new datafile definition record in the TMSINT ADM DATAFILES table. Each datafile record carries the parent ClientID of the client in which it is applicable. When the datafile has been created, a DatafileID is assigned and returned.

Updating a Datafile—The API UPDATE_DATAFILE is used to update an existing datafile definition record in the TMSINT_ADM_DATAFILES table. This API is also used to update URL passwords if they are periodically updated by the client. Additionally, datafiles can be enabled or disabled from integration processing by updating the ActiveFlag. Any required value with the table in which the API has a default of NULL is simply a means to allow the user to enter only the values that they want to update. For example, the pActiveFlag parameter has a default value of NULL. If the pActiveflag value is not provided or a NULL value is provided, the API will assume the user is not updating that value and the current value will not be changed. Deleting a Datafile—The API DELETE_DATAFILE is used to delete datafile definition records from the TMSINT_ADM_DATAFILES table. When a datafile is deleted, all subordinate client metadata will likewise be deleted (dictionary mappings, external system mappings, ancillary data, etc.).

Querying a Datafile—The API QUERY_DATAFILE is used to query any datafile definition record in the TMSINT_ADM_DATAFILES table. The API is a pipelined function based on the TMSINT_ADM_DATAFILES table and may therefore be executed as any query from the SQL command line.

Dictionary Mapping Definition—After a datafile has been defined in TMSINT_ADM_DATAFILES and a DatafileID has been assigned, each distinct DCM-VT combination within the datafile is then defined in a TMSINT_ADM_DICT_MAPPING metadata table to map the DCM-VT to a client specific TMS dictionary for coding. For example, assuming that a given datafile contained an AE (Adverse Event), MH (Medical History) and CM (Concomitant Medication) data then three records would need to be created mapping the DCM-VT to the MedDRA and WHO Drug TMS dictionaries, respectively. The TMSINT_ADM_DICT_MAPPING table will ultimately specify how the DCM and VT will be parsed from the client source system HTML extract data, what TMS dictionary to use for coding, and how to construct the HTML coding file and HTML action file data that will be returned to the client source system for update after TMS processing.

Creating a New Dictionary Mapping—The API CREATE_DICT_MAPPING is used to create a new datafile dictionary mapping record in the TMSINT_ADM_DICT_MAPPING table. Each mapping record carries the parent DatafileID of the client datafile in which it is applicable. When the dictionary mapping has been created, a DictMappingID will be assigned and returned.

Updating a Dictionary Mapping—The API UPDATE_DICT_MAPPING is used to update an existing datafile dictionary mapping record in the TMSINT_ADM_DICT_MAPPING table. This API may be used to update any of the non-key values at any time. Additionally, dictionary mappings may be enabled or disabled from integration processing by updating the ActiveFlag. Any required value with the table in which the API has a default of NULL provides a means to allow the user to enter only the values that they want to update. For example, the pActiveFlag parameter has a default value of NULL. If the pActiveflag value is not provided or a NULL value is provided, the API will assume the user is not updating that value and the current value will not be changed.

Deleting a Dictionary Mapping—The API DELETE_DICT_MAPPING is used to delete datafile definition record from the TMSINT_ADM_DICT_MAPPING table. When a dictionary mapping is deleted, all subordinate ancillary metadata will likewise be deleted.

Querying a Dictionary Mapping—The API QUERY_DICT_MAPPING is used to query any datafile dictionary mapping records in the TMSINT_ADM_DICT_MAPPING table. The API is a pipelined function based on the TMSINT_ADM_DICT_MAPPING table and may therefore be executed as any query from the SQL command line.

External System Mapping Definition—After a datafile has been defined in TMSINT_ADM_DATAFILES and a DatafileID has been assigned, each datafile is then mapped to a client specific TMS External System within TMS within the TMSINT_ADM_EXT_MAPPING metadata table. TMS allows for the definition of up to eight custom columns (EXT_VALUE_1 . . . EXT_VALUE_8) to store source system “key” data values. For each client datafile, the TMSINTADM_DICT_MAPPING will contain one record for each defined TMS external column. The TMSINT_ADM_EXT_MAPPING table will ultimately specify how each of the source system “key” values will be parsed from the client source system HTML extract data, how they are mapped to the TMS external system, and finally how to construct the HTML coding file and HTML action file data that will be returned to the client source system for update after TMS processing. Since TMS external column values are considered to be a “key” value used in the client source system to uniquely identify a specific patient record, the data values are expected to remain static. The exception to this is any external column defined with the name “SITE” which is designated as a “snowbird” column for patients that change locations (Site) during part of the year. Functionality has been included to include updates to the “SITE” column only. Updates to any additional external value would simply treat the record as a new patient record.

Creating a New External System Mapping—The API CREATE_EXT_MAPPING is used to create a new external system mapping record in the TMSINT_ADM_EXT_MAPPING table. Each mapping record carries the parent DatafileID of the client datafile in which it is applicable. When the dictionary mapping has been created, an ExtMappingID will be assigned and returned. A mapping should be created for each column defined within the TMS external system. If the external system has only six of the eight possible external columns defined, then the datafile will have six mapping records.

Updating an External System Mapping—The API UPDATE_EXT_MAPPING is used to update an existing external system mapping record in the TMSINT_ADM_EXT_MAPPING table. This API may be used to enable or disable the collection of a given external data value from integration processing by updating the ActiveFlag. Any required value with the table in which the API has a default of NULL provides a means to allow the user to enter only the values that they want to update. For example, the pActiveFlag parameter has a default value of NULL. If the pActiveflag value is not provided or a NULL value is provided, the API will assume the user is not updating that value and the current value will not be changed.

Deleting an External System Mapping—The API DELETE_EXT_MAPPING is used to delete datafile definition record from the TMSINT_ADM_EXT_MAPPING table. When a dictionary mapping is deleted, the corresponding data value will no longer be parsed from the inbound source system data and will no longer be included in the outbound HTML coding or response/action file.

Querying an External System Mapping—The API QUERY_DICT_MAPPING is used to query any datafile dictionary mapping records in the TMSINT_ADM_DICT_MAPPING table. The API is a pipelined function based on the TMSINT_ADM_DICT_MAPPING table and may therefore be executed as any query from the SQL command line.

Ancillary Column Definition—The definition of Ancillary data is an optional component of the TMS to Medidata Rave Integration application. The definition of ancillary data is defined in a metadata table TMSINT_ADM_ADD_COLS. Ancillary data or add on-columns are individual data values in the client source system that are associated to a specific DCM within a datafile that are retrieved from the client source system for the purpose of displaying ancillary data during TMS omission management activities via TMS Drill-Down Views. The TMSINT_ADM_ADDON_COLS table will ultimately specify what data column values for a given DCM and datafile should be retrieved from the client source system and how the values will be parsed from the client source system HTML extract data.

Creating a New Ancillary Column Definition—The API CREATE_ADDON_COL is used to create a new ancillary column record in the TMSINT_ADM_ADDON_COLS table. Each mapping record carries the parent DatafileID of the client datafile and the DCM name in which it is applicable. When the ancillary column definition has been created, an AddonColID will be assigned and returned.

Updating an Ancillary Column Definition—The API UPDATE_ADDON_COL is used to update an existing ancillary column definition record in the TMSINT_ADM_ADDON_COLS table. This API may be used to enable or disable the collection of a given ancillary column value during integration processing by updating the ActiveFlag. Any required value in the table in which the API has a default of NULL is a means to allow the user to enter only the values that they want to update. For example, the pActiveFlag parameter has a default value of NULL. If the pActiveflag value is not provided or a NULL value is provided, the API will assume the user is not updating that value and the current value will not be changed.

Deleting an Ancillary Column Definition—The API DELETE_ADDON_COL is used to delete ancillary column definitions from the TMSINT_ADM_ADDON_COL table. When an ancillary column definition is deleted, the corresponding data value will no longer be parsed from the inbound source system data and will appear as a NULL value if referenced in a TMS drill-down view.

Querying an External System Mapping—The API QUERY_DICT_MAPPING is used to query any datafile dictionary mapping records in the TMSINT_ADM_DICT_MAPPING table. The API is a pipelined function based on the TMSINT_ADM_DICT_MAPPING table and may therefore be executed as any query from the SQL command line.

Oracle Account Registration—Each client is required to have a client specific Oracle data-transfer schema and an Oracle data-processing schema registered in the TMS to Medidata Rave Integration application table TMSINT_ADM_ORA_ACCOUNTS table. The actual Oracle accounts must exist in the Oracle database before they may be registered. The data-transfer schema is responsible for the “transfer” of data from the client source system to the Oracle database and from the Oracle database back to the client source system. The data-processing schema is responsible for picking up client data written to database by the data-transfer schema, processing the data in TMS and writing the results back to the database to be written back to the source system by the data-processing schema. All data-transfer schemas must have the name TMSINT_XFER_<ClientCode> and all data-processing schemas must have the name TMSINT_PROC_<ClientCode>.

Registering an Oracle Account—The API REGISTER_ORA_ACCOUNT issued to register a new Oracle account in the TMSINT_ADM_ORA_ACCOUNTS table. When registering accounts for a new client, both a data-transfer account and the data-processing account are then registered. Valid account type values are “XFER” or “PROC”. When the account has been registered, an AccountID will be assigned and returned.

Unregistering an Oracle Account—The API DELETE_ORA_ACCOUNT is used to delete or un-registered Oracle accounts from the TMSINT_ADM_ORA_ACCOUNTS table.

Suspending an Oracle Account—The API SUSPEND_ORA_ACCOUNT is used to suspend an Oracle account in the TMSINT_ADM_ORA_ACCOUNTS table. This action will update the ActiveFlag from “Y” to “N” which will prevent the applicable integration processing until when time the account is unsuspended.

Unsuspending an Oracle Account—The API UNSUSPEND_ORA_ACCOUNT is used to unsuspend an Oracle account in the TMSINT_ADM_ORA_ACCOUNTS table. This action will update the ActiveFlag from “N” to “Y” which will allow integration processing to resume.

Querying Registered Oracle Accounts—The API QUERY_ORA_ACCOUNT is used to query Oracle accounts in the TMSINTADM_ORA_ACCOUNTS table. The API is a pipelined function based on the TMSINT_ORA_ACCOUNTS table and may therefore be executed as any query from the SQL command line.

### Gathering Client Requirements

TMS Dictionaries
1. What TMS dictionaries are required (MedDRA, WHO Drug)?
2. Can a DBMS Consulting prewritten dictionary packages be used?
3. What vendor format of the dictionary should be used (WHO Drug only: DD, DDE, DDE-HD)?
4. What vendor version should be used for initial loading?
5. What are the required data items that will need to be derived back to the source system (Derivation Path)?
6. Default Integration functionally uses one TMS domain per study? Is this adequate or should all study data be within a client level TMS domain?
7. What version import reports are required? Client specifies custom reporting requirements outside of the custom canned reports provided by default
8. What is the required TMS dictionary version upgrade schedule?
9. Should TMS virtual dictionary domains be used?

TMS External System
1. What data items within the study will identify a unique patient record?
2. Are there more than 8 columns in which an external value will contain multiple concatenated values?
3. Are there any custom requirements for TMS omission statuses?
4. When writing data back to the source system, what order are the external columns required to be in within the HTML file?
5. Is there a “SITE” column (snowbird column)?
6. Ensure all external value will be unique and remain static (excluding “SITE” if applicable)

TMS Drill-Down Views
1. What drill-down views be required?
2. How many drill-down views will be required and what external system column will they be assigned to?
3. What are the datafile/DCM ancillary columns that will be included in the drill-down view (if applicable)?
4. TMS Search Objects
1. Should a custom TMS search object be defined for any of the client dictionaries?
2. Will the global default search object be used or will the client maintain a client-specific search object

TMS VTA Load Utilities
1. Will the client be providing a spreadsheet of VTA data to be pre-loaded in any of the dictionaries?

Clinical Studies/Datafiles
1. How many clinical studies will be processed by the TMS to Medidata Rave Integration application?
2. What is the URL and any applicable credentials for each study to be extracted from the source system and processed in TMS?
3. What is the URL and any applicable credentials for each study to be imported from TMS back into the source system?
4. What is the HTML tag for the study datafile that will mark the beginning of the file <BOF>?
5. What is the HTML tab for the study datafile that will mark the beginning of an individual patient record <BOR>?
6. What is the HTML header value that will be required in the import HTLM file to be updated back in the client source system?

Clinical Study Dictionary Mapping
1. How many distinct DCM-VTs exists within the study datafile?
2. What TMS dictionary is applicable to the DCM-VT?
3. What is the HTML tag within the HTML source system extract file for the DCM-VT? This is HOW the data value will be parsed and accurately specified?
4. What is the HTML prefix within the HTML source system extract file for the DCM-VT? This is HOW the data value will be parsed and accurately specified?
5. What is the HTML tag within the HTML import file will need be specified when returning coding data?
6. What is the HTML prefix shall precede the data value (DT) within the HTML import file will need be specified when returning coding data?
7. What is the HTML suffix transaction-type value (if any) required when returning coding data?
8. What is the HTML tag within the HTML import file will need be specified when returning response/action data?
9. What is the HTML prefix shall precede the data value (action text) within the HTML import file will need be specified when returning response/action data?
10. What is the HTML suffix transaction-type value (if any) required when returning response/action data?
11. What is the HTML value will be required when returning response/action data?

Clinical Study External System Mapping
1. What are the TMS external system values define?
2. Do any external values contain multiple column data values (concatenated)?
3. What is the HTML tag within the HTML source system extract file for each external value? This is HOW the data value will be parsed and accurately specified?
4. What is the HTML prefix within the HTML source system extract file for each external value? This is HOW the data value will be parsed and accurately specified?
5. What is the HTML suffix transaction-type value (if any) required when returning coding data?
6. What is the HTML suffix transaction-type value (if any) required when returning action data?
7. What is the required order of the external column values in the return import HTLM file?

Clinical Study Ancillary Data
1.What DCM specific ancillary columns required (if any)?
2. What is the HTML tag within the HTML source system extract file for the ancillary data value? This is HOW the data value will be parsed and accurately specified?
3. What is the HTML prefix within the HTML source system extract file for the ancillary data value? This is HOW the data value will be parsed and accurately specified?

### TMS to Medidata Rave Integration (TMSINT) Design Specification

Custom TMS to Medidata Rave Integration application (TMSINT)—The TMS to Medidata Rave Integration process will automatically extract the configured clinical data in an HTML format, the HTML data will be transformed into patient records appropriate for processing in the TMS application and then the TMS processing results will be written in a client compatible HTLM format and updated in the client's source system.

Each client utilizing the TMS to Medidata Rave Integration application will have designated TMS dictionaries within the TMS application as required and a designated custom TMS External System definition. Additionally, the client may have enhanced coding capabilities using DBMS Consulting Inc. custom TMS Search Objects and DBMS Consulting Inc. custom VTA loading. Use of the TMS to Medidata Rave Integration application allows the client to perform all TMS omission management activities from within TMS and the ability to customize pre-defined omission actions and statuses as well as the option to utilize DBMS customTMS Drill-Down views for the display of ancillary data.

The objective of this document is to specify the overall design of the DBMS TMS to Medidata Rave Integration (TMSINT) application and its range of functionality. Topic specific to the TMS application such at the defining, loading and upgrading TMS dictionaries, as well as TMS external systems, TMS Search Objects, and TMS Drill-Down views are considered custom TMS application components. The DBMS TMS to Medidata Rave Integration (TMSINT) application interacts directly with client source systems and the TMS application to provide a hosted clinical data coding solution.

TMS to Medidata Rave Integration application Schemas—The TMS to Medidata Rave Integration (TMSINT) application requires one Oracle schema to be defined as the application owner and administrator. All clients configured to use the TMSINT application will be defined and managed by the administrator. Each client setup to use the TMSINT application will require two client specific Oracle schemas. One schema will be the designated data-transfer account and the other account will be the designated data-processing account. Each Oracle schema is described below:

Administrator Schema—The TMSINT_ADM Oracle schema is the owner and administrator of the TMSINT application. It is recommended that the schema name be TMSINT _ADM; however, another Oracle schema name may be used if desired. For the purpose of this document, the administrator account will be referred to as being TMSINT_ADM. The application administrator will own all of the application metadata tables and will be required to setup and configure a given client before the client may use the TMSINT application. All stored procedures for application use are created within the administrative account. As clients are configured for use, the appropriate privileges, synonyms and objects will be created will be created in the client specific Oracle accounts. The data-transfer and data-processing functionality used by each client will be accessed from stored procedures from within the administrative account. The application functionality has been written so that the same APIs will be appropriate for all clients based on the client's individual configuration in the application metadata tables. This allows for future modifications and bug fixed from within a single Oracle account opposed to having to modify multiple client accounts. Table 3 summarizes the objects created for the application administrator schema:

TABLE 3

| | Object Type | Description |
|---|---|---|
| Table | TMSINT_ADM_PROPERTIES | Application properties |
| Table | TMSINT_ADM_CLIENTS | Client definitions |
| Table | TMSINT_ADM_DATAFILES | Client specific datafiles definition |
| Table | TMSINT_ADM_DICT_MAPPING | Client specific DCM/dictionary |
| | | definition/mapping |
| Table | TMSINT_ADM_EXT_MAPPING | Client specific external system |
| | | definition/mapping |
| Table | TMSINT_ADM_ADDON_COLS | Client specific ancillary data |
| Table | TMSINT_ADM_ORA_ACCOUNTS | Client specific Oracle accounts |
| Sequence | TMSINT_ADM_PROPERTIES_{—} | Unique identifier for |
| | SEQ | TMSINT_ADM_PROPERTIES |
| Sequence | TMSINT_ADM_CLIENTS_SEQ | Unique identifier for |
| | | TMSINT_ADM_CLIENTS |
| Sequence | TMSINT_ADM_DATAFILES_SEQ | Unique identifier for |
| | | TMSINT_ADM_DATAFILES |
| Sequence | TMSINT_ADM_DICT_MAPPING_{—} | Unique identifier for |
| | SEQ | TMSINT_ADM_DICT_MAPPING |
| Sequence | TMSINT_ADM_EXT_MAPPING_{—} | Unique identifier for |
| | SEQ | TMSINT_ADM_EXT_MAPPING |
| Sequence | TMSINT_ADM_ADDON_COLS_{—} | Unique identifier for |
| | SEQ | TMSINT_ADM_ADDON_COLS |
| Sequence | TMSINT_ADM_ORA_ACCOUNTS_{—} | Unique identifier for |
| | SEQ | TMSINT_ADM_ORA_ACCOUNTS |
| Sequence | TMSINT_ADM_CUSTOM_SRC_{—} | Unique identifier for Client |
| | TERM_SEQ | SOURCE_TERM_ID assignment |
| Package | TMSINT_ADM_UTILS | APIS specific to administrator |
| | | (client configuration only) |
| Package | TMSINT_XFER_UTILS | APIs specific to data-transfer |
| | | schemas |
| Package | TMSINT_PROC_UTILS | APIs specific to data-processing |
| | | schemas |
| View | TMSINT_ADM_DICT_VERSIONS | TMS dictionary, dictionary types |
| | | and version |
| View | TMSINT_ADM_DERV_PATH_{—} | TMS dictionary levels of the |
| | LEVELS | derivation path (by dictionary) |
| View | TMSINT_ADM_DERV_PATH_{—} | TMS dictionary columns for each |
| | COLUMNS | level of the derivation path |
| View | TMSINT_ADM_DICT_ING_LISTS | UMC provided PT/INGList based |
| | | on “INGLIST” informative note |
| Object Type | TMSINT_ADM_CLIENT_OBJR/ | Global Object Type for |
| | OBJT | TMSINT_ADM_CLIENTS |
| Object Type | TMSINT_ADM_DATAFILE_OBJR/ | Global Object Type for |
| | OBJT | TMSINT_ADM_DATAFILES |
| Object Type | TMSINT_ADM_DICT_MAPPING_{—} | Global Object Type for |
| | OBJR/OBJT | TMSINT_ADM_DICT_MAPPING |
| Object Type | TMSINT_ADM_EXT_MAPPING_{—} | Global Object Type for |
| | OBJR/OBJT | TMSINT_ADM_EXT_MAPPING |
| Object Type | TMSINT_ADM_ADDON_COL_{—} | Global Object Type for |
| | OBJR/OBJT | TMSINT_ADM_ADDON_COLS |
| Object Type | TMSINT_ADM_ORA_ACCOUNT_{—} | Global Object Type for |
| | OBJR/OBJT | TMSINT_ADM_ORA_ACCOUNTS |
| Object Type | TMSINT_XFER_HTML_EXTRACT_{—} | Global Object Type for |
| | OBJR/OBJT | TMSINT_XFER_HTML_EXTRACT |
| Object Type | TMSINT_XFER_HTML_IMPORT_{—} | Global Type for |
| | OBJR/OBJT | TMSINT_XFER_HTML_IMPORT |
| Object Type | TMSINT_PROC_INBOUND_OBJR/ | Global Type for |
| | OBJT | TMSINT_PROC_INBOUND |
| Object Type | TMSINT_PROC_INBOUND_DTLS_{—} | Global Type for |
| | OBJR/OBJT | TMSINT_PROC_INBOUND_DTLS |
| Object Type | TMSINT_PROC_INBOUND_{—} | Global Type for |
| | DERV_OBJR/OBJT | TMSINT_PROC_INBOUND_DERV |
| Object Type | TMSINT_PROC_CODING_OBJR/ | Global Type for |
| | OBJT | TMSINT_PROC_CODING |
| Object Type | TMSINT_PROC_CODING_DTLS_{—} | Global Type for |
| | OBJR/OBJT | TMSINT_PROC_CODING_DTLS |
| Object Type | TMSINT_PROC_CODING_DERV_{—} | Global Type for |
| | OBJR/OBJT | TMSINT_PROC_CODING_DERV |
| Object Type | TMSINT_PROC_CDING_JN_{—} | Global Type for |
| | OBJR/OBJT | TMSINT_PROC_CODING_JN |
| Object Type | TMSINT_PROC_CDING_DTLS_{—} | Global Type for |
| | JN_OBJR/OBJT | TMSINT_PROC_CODING_DTLS_{—} |
| | | JN |
| Object Type | TMSINT_PROC_CDING_DERV_{—} | Global Type for |
| | JN_OBJR/OBJT | TMSINT_PROC_CODING_DERV_{—} |
| | | JN |
| Object Type | TMSINT_PROC_LOGGING_{—} | Global Type for |
| | OBJR/OBJT | TMSINT_PROC_LOGGING |

Data-Transfer Schema (TMSINT_XFER_<client>)—Each client configured to use the TMSINT application will be required to have one designated Oracle data-transfer schema. The Oracle schema name is named TMSINT_XFER_<client> where the <client> value is the alias code defined for the client during the configuration process. For example, if the client “ABC Company” has a defined client alias code of “ABC”, the data-transfer schema for “ABC Company” will be TMSINT_XFER_ABC. The purpose of the data-transfer schema is to “transfer” data to and from the client's clinical data source system. Installation scripts have been written to automate the creation of the client specific data-transfer schemas which will include the creation of all Oracle objects to be created directly within the data-transfer schema. As the data-transfer schema is created, the appropriate grants will be issued and the appropriate private synonyms will be created to ensure access to all administrator owned objects. The data-transfer schema is not a privileged Oracle account and is granted only the Oracle CONNECT and RESOURCE system roles. The data-transfer is a “staging” schema and as such, the data will not persist in the database. Table 4 summarizes the objects created for each client specific data-transfer schema:

TABLE 4

| Object Type | Object Name | ObjectOwner | Privilege | Description |
|---|---|---|---|---|
| Table | TMSINT_XFER_{—} | | | Extract staging |
| | HTML_EXTRACT | | | table applicable |
| | | | | to extracting |
| | | | | client data |
| Table | TMSINT_XFER_{—} | | | Import staging |
| | HTML_IMPORT | | | table applicable |
| | | | | to updating |
| | | | | client data |
| Sequence | TMSINT_XFER_{—} | | | Unique |
| | HTML_EXTRACT_{—} | | | identifier for |
| | SEQ | | | EXTRACT |
| | | | | table |
| Sequence | TMSINT_XFER_{—} | | | Unique |
| | HTML_IMPORT_{—} | | | identifier for |
| | SEQ | | | IMPORT table |
| Synonym | TMSINT_XFER_{—} | Administrator | Execute | Application |
| | UTILS | | | APIs applicable |
| | | | | to data-transfer |
| Synonym | TMSINT_ADM_{—} | Administrator | Select | Object Type for |
| | CLIENT_OBJR/ | | | TMSINT_ADM_{—} |
| | OBJT | | | CLIENTS |
| Synonym | TMSINT_ADM_{—} | Administrator | Select | Object Type for |
| | DATAFILE_{—} | | | TMSINT_ADM_{—} |
| | OBJR/OBJT | | | DATAFILES |
| Synonym | TMSINT_ADM_{—} | Administrator | Select | Object Type for |
| | DICT_MAPPING_{—} | | | TMSINT_ADM_{—} |
| | OBJR/OBJT | | | DICT_MAPPING |
| Synonym | TMSINT_ADM_{—} | Administrator | Select | Object Type for |
| | TEX_MAPPING_{—} | | | TMSINT_ADM_{—} |
| | OBJR/OBJT | | | EXT_MAPPING |
| Synonym | TMSINT_ADM_{—} | Administrator | Select | Object Type for |
| | ADDON_COL_{—} | | | TMSINT_ADM_{—} |
| | OBJR/OBJT | | | ADDON_COLS |
| Synonym | TMSINT_ADM_{—} | Administrator | Select | Object Type for |
| | ORA_ACCOUNT_{—} | | | TMSINT_ADM_{—} |
| | OBJR/OBJT | | | ORA_ACCOUNTS |
| Synonym | TMSINT_XFER_{—} | Administrator | Select | Object Type for |
| | HTML_EXTRACT_{—} | | | TMSINT_XFER_{—} |
| | OBJR/OBJT | | | HTML_EXTRACT |
| Synonym | TMSINT_XFER_{—} | Administrator | Select | Object Type for |
| | HTML_IMPORT_{—} | | | TMSINT_XFER_{—} |
| | OBJR/OBJT | | | HTML_IMPORT |
| Synonym | TMSINT_PROC_{—} | Administrator | Select | Object Type for |
| | INBOUND_OBJR/ | | | TMSINT_PROC_{—} |
| | OBJT | | | INBOUND |
| Synonym | TMSINT_PROC_{—} | Administrator | Select | Object Type for |
| | INBOUND_DTLS_{—} | | | TMSINT_PROC_{—} |
| | OBJR/OBJT | | | INBOUND_{—} |
| | | | | DTLS |
| Synonym | TMSINT_PROC_{—} | Administrator | Select | Object Type for |
| | INBOUND_DERV_{—} | | | TMSINT_PROC_{—} |
| | OBJR/OBJT | | | INBOUND_{—} |
| | | | | DERV |
| Synonym | TMSINT_PROC_{—} | Administrator | Select | Object Type for |
| | CODING_OBJR/ | | | TMSINT_PROC_{—} |
| | OBJT | | | CODING |
| Synonym | TMSINT_PROC_{—} | Administrator | Select | Object Type for |
| | CODING_DTLS_{—} | | | TMSINT_PROC_{—} |
| | OBJR/OBJT | | | CODING_DTLS |
| Synonym | TMSINT_PROC_{—} | Administrator | Select | Object Type for |
| | CODING_DERV_{—} | | | TMSINT_PROC_{—} |
| | OBJR/OBJT | | | CODING_DERV |
| Synonym | TMSINT_PROC_{—} | Administrator | Select | Object Type for |
| | CDING_JN_OBJR/ | | | TMSINT_PROC_{—} |
| | OBJT | | | CODING_JN |
| Synonym | TMSINT_PROC_{—} | Administrator | Select | Object Type for |
| | CDING_DTLS_JN_{—} | | | TMSINT_PROC_{—} |
| | OBJR/OBJT | | | CODING_DTLS_{—} |
| | | | | JN |
| Synonym | TMSINT_PROC_{—} | Administrator | Select | Object Type for |
| | CDING_DERV_JN_{—} | | | TMSINT_PROC_{—} |
| | OBJR/OBJT | | | CODING_DERV_{—} |
| | | | | JN |
| Synonym | TMSINT_PROC_{—} | Administrator | Select | Object Type for |
| | LOGGING_OBJR/ | | | TMSINT_PROC_{—} |
| | OBJT | | | LOGGING |

Data-Processing Schema (TMSINT_PROC_<client>)—Each client configured to use the TMSINT application will be required to have one designated Oracle data-processing schema. The Oracle schema name is named TMSINT_PROC_<client> where the <client> value is the alias code defined for the client during the configuration process. For example, if the client “ABC Company” has a defined client alias code of “ABC”, the data-processing schema for “ABC Company” will be TMSINT_PROC_ABC. The purpose of the data-processing schema is to process all client data in TMS as well as return the TMS processing results to the data-transfer schema to be updated in the client's clinical source system. Installation scripts have been written to automate the creation of the client specific data-processing schemas which will include the creation of all Oracle objects to be created directly within the data-processing schema. As the data-processing schema is created, the appropriate grants will be issued and the appropriate private synonyms will be created to ensure access to all administrator owned objects. The data-processing schema is a privilege Oracle account and is defined as a TMS super-user. Table 5 summarizes the objects created for each client specific data-processing schema.

TABLE 5

| Object | | Object | | |
|---|---|---|---|---|
| Type | Object Name | Owner | Privilege | Description |
| Table | TMSINT_PROC_INBOUND | | | TMS processing |
| | | | | staging table |
| Table | TMSINT_PROC_INBOUND_{—} | | | TMS processing |
| | DTLS | | | staging table |
| | | | | (ancillary data) |
| Table | TMSINT_PROC_INBOUND_{—} | | | TMS processing |
| | DERV | | | staging table |
| | | | | (derivation path |
| | | | | data) |
| Table | TMSINT_PROC_CODING | | | TMS client data |
| | | | | table |
| Table | TMSINT_PROC_CODING_{—} | | | TMS client data |
| | DTLS | | | table (ancillary |
| | | | | data) |
| Table | TMSINT_PROC_CODING_{—} | | | TMS client data |
| | DERV | | | table (derivation |
| | | | | path data) |
| Table | TMSINT_PROC_CODING_{—} | | | TMS client JN |
| | JN | | | data table |
| Table | TMSINT_PROC_CODING_{—} | | | TMS client JN |
| | DTLS_JN | | | data table |
| | | | | (ancillary data) |
| Table | TMSINT_PROC_CODING_{—} | | | TMS client JN |
| | DERV_JN | | | data table |
| | | | | (derivation path |
| | | | | data) |
| Table | TMSINT_PROC_LOGGING | | | Application |
| | | | | execution results |
| | | | | tables (i.e. email) |
| Sequence | TMSINT_PROC_INBOUND_{—} | | | Unique identifier |
| | SEQ | | | for |
| | | | | TMSINT_PROC_{—} |
| | | | | INBOUND |
| Sequence | TMSINT_PROC_INBOUND_{—} | | | Unique identifier |
| | DTLS_SEQ | | | for TMSINT_PROC_{—} |
| | | | | INBOUND_DTLS |
| Sequence | TMSINT_PROC_INBOUND_{—} | | | Unique identifier |
| | DERV_SEQ | | | for TMSINT_PROC_{—} |
| | | | | INBOUND_DERV |
| Sequence | TMSINT_PROC_CODING_{—} | | | Unique identifier |
| | SEQ | | | for TMSINT_PROC_{—} |
| | | | | CODING |
| Sequence | TMSINT_PROC_CODING_{—} | | | Unique identifier |
| | DTLS_SEQ | | | for TMSINT_PROC_{—} |
| | | | | CODING_DTLS |
| Sequence | TMSINT_PROC_CODING_{—} | | | Unique identifier |
| | DERV_SEQ | | | for TMSINT_PROC_{—} |
| | | | | CODING_DERV |
| Sequence | TMSINT_PROC_LOGGING_{—} | | | Unique identifier |
| | SEQ | | | for TMSINT_PROC_{—} |
| | | | | LOGGING |
| Synonym | TMSINT_XFER_HTML_{—} | Data- | All | Extract staging |
| | EXTRACT | Transfer | | table applicable to |
| | | | | extracting client |
| | | | | data |
| Synonym | TMSINT_XFER_HTML_{—} | Data- | All | Import staging |
| | IMPORT | Transfer | | table applicable to |
| | | | | updating client |
| | | | | data |
| Synonym | TMSINT_XFER_HTML_{—} | Data- | Select | Unique identifier |
| | IMPORT_SEQ | Transfer | | for |
| | | | | TMSINT_XFER_{—} |
| | | | | HTML_IMPORT |
| Synonym | TMSINT_PROC_UTILS | Administrator | Execute | Application APIs |
| | | | | applicable to |
| | | | | data-processing |
| Synonym | TMSINT_ADM_CLIENT_{—} | Administrator | Select | Object Type for |
| | OBJR/OBJT | | | TMSINT_ADM_{—} |
| | | | | CLIENTS |
| Synonym | TMSINT_ADM_DATAFILE_{—} | Administrator | Select | Object Type for |
| | OBJR/OBJT | | | TMSINT_ADM_{—} |
| | | | | DATAFILES |
| Synonym | TMSINT_ADM_DICT_{—} | Administrator | Select | Object Type for |
| | MAPPING_OBJR/OBJT | | | TMSINT_ADM_{—} |
| | | | | DICT_MAPPING |
| Synonym | TMSINT_ADM_EXT_{—} | Administrator | Select | Object Type for |
| | MAPPING_OBJR/OBJT | | | TMSINT_ADM_{—} |
| | | | | EXT_MAPPING |
| Synonym | TMSINT_ADM_ADDON_{—} | Administrator | Select | Object Type for |
| | COL_OBJR/OBJT | | | TMSINT_ADM_{—} |
| | | | | ADDON_COLS |
| Synonym | TMSINT_ADM_ORA_{—} | Administrator | Select | Object Type for |
| | ACCOUNT_OBJR/OBJT | | | TMSINT_ADM_{—} |
| | | | | ORA_ACCOUNTS |
| Synonym | TMSINT_ADM_DICT_{—} | Administrator | Select | View of TMS |
| | VERSIONS | | | dictionary, |
| | | | | dictionary types |
| | | | | and version |
| Synonym | TMSINT_ADM_DERV_{—} | Administrator | Select | View of TMS |
| | PATH_LEVELS | | | dictionary levels |
| | | | | of the derivation |
| | | | | path (by |
| | | | | dictionary) |
| Synonym | TMSINT_ADM_DERV_{—} | Administrator | Select | View of TMS |
| | PATH_COLUMNS | | | dictionary |
| | | | | columns for each |
| | | | | level of the |
| | | | | derivation path |
| Synonym | TMSINT_ADM_DICT_ING_{—} | Administrator | Select | View of UMC |
| | LISTS | | | provided |
| | | | | PT/INGList based |
| | | | | on “INGLIST” |
| | | | | informative note |
| Synonym | TMSINT_XFER_HTML_{—} | Administrator | Select | Object Type for |
| | EXTRACT_OBJR/OBJT | | | TMSINT_XFER_{—} |
| | | | | HTML_EXTRACT |
| Synonym | TMSINT_XFER_HTML_{—} | Administrator | Select | Object Type for |
| | IMPORT_OBJR/OBJT | | | TMSINT_XFER_{—} |
| | | | | HTML_IMPORT |
| Synonym | TMSINT_PROC_INBOUND_{—} | Administrator | Select | Object Type for |
| | OBJR/OBJT | | | TMSINT_PROC_{—} |
| | | | | INBOUND |
| Synonym | TMSINT_PROC_INBOUND_{—} | Administrator | Select | Object Type for |
| | DTLS_OBJR/OBJT | | | TMSINT_PROC_{—} |
| | | | | INBOUND_DTLS |
| Synonym | TMSINT_PROC_INBOUND_{—} | Administrator | Select | Object Type for |
| | DERV_OBJR/OBJT | | | TMSINT_PROC_{—} |
| | | | | INBOUND_DERV |
| Synonym | TMSINT_PROC_CODING_{—} | Administrator | Select | Object Type for |
| | OBJR/OBJT | | | TMSINT_PROC_{—} |
| | | | | CODING |
| Synonym | TMSINT_PROC_CODING_{—} | Administrator | Select | Object Type for |
| | DTLS_OBJR/OBJT | | | TMSINT_PROC_{—} |
| | | | | CODING_DTLS |
| Synonym | TMSINT_PROC_CODING_{—} | Administrator | Select | Object Type for |
| | DERV_OBJR/OBJT | | | TMSINT_PROC_{—} |
| | | | | CODING_DERV |
| Synonym | TMSINT_PROC_CDING_{—} | Administrator | Select | Object Type for |
| | JN_OBJR/OBJT | | | TMSINT_PROC_{—} |
| | | | | CODING_JN |
| Synonym | TMSINT_PROC_CDING_{—} | Administrator | Select | Object Type for |
| | DTLS_JN_OBJR/OBJT | | | TMSINT_PROC_{—} |
| | | | | CODING_DTLS_{—} |
| | | | | JN |
| Synonym | TMSINT_PROC_CDING_{—} | Administrator | Select | Object Type for |
| | DERV_JN_OBJR/OBJT | | | TMSINT_PROC_{—} |
| | | | | CODING_DERV_{—} |
| | | | | JN |
| Synonym | TMSINT_PROC_LOGGING_{—} | Administrator | Select | Object Type for |
| | OBJR/OBJT | | | TMSINT_PROC_{—} |
| | | | | LOGGING |

TMS to Medidata Rave Integration Application Administrator Tables

TMSINT_ADM_PROPERTIES—The property table allows defining various properties within the TMSINT application. The only required entry within the properties table during the installation process is the name of the Oracle account that is the TMINT application owner. For the application owner, the PropertyCategory is “APPLICATION”, the PropName is “OWNER” and the PropValue is the Oracle schema owning all of the application objects which is expected to be “TMSINT_ADM”. The properties table can optionally be used to specify other miscellaneous properties as needed. A SQL script is executed during the installation process as the application owner and will automatically create the required entry in the TMSINT_ADM_PROPERTIES table. Additional SQL scripts are provided to insert, update, and delete properties as needed.

TMSINT_ADM_CLIENTS—The clients table allows for the definition of a client within the TMSINT application. Each client is assigned a unique numeric identifier and alias code. The numeric identifier, Client-ID will be used as a foreign key in other metadata tables for referential integrity. The value of the client alias code selected dictates the names of the Data-Transfer and Data-Processing schemas TMSINT_XFER_<client-alias> and TMSINT_PROC_<client-alias>, respectively. SQL scripts are provided to easily allow for the insert, update, and delete of clients data.

TMSINT_ADM_DATAFILES—The datafiles table allows for the definition of datafiles within the TMSINT application for a specific client in TMSINT_ADM_CLIENTS. A client may have one or more datafiles but a datafile may be assigned to only one client. Each datafile is assigned a unique numeric identifier (DatafileID) that will be used as a foreign key in other metadata tables that have a child relationship to the datafile at hand. A datafile is the URL (e.g. https://pharmanet.mdsol.com/RaveWeb Services) in which to access the client's datafile, which will be an HTML document. In addition to the datafile URL, the user name and password credentials needed to access the client datafile URL are required. Each datafile will correspond to one clinical study name. When data is processed in TMS, the TMS domain name will be the “Study Name” concatenated with the string “_DOMAIN” for all coding records within the given datafile. New datafiles may be added to an existing client at any time. To temporarily or permanently discontinue processing of any datafile, the Active Flag can simply be updated to “N” and likewise to reinstate processing the Active Flag may be reset back to “Y”. All datafiles are initially created as active. SQL scripts are provided to easily allow for the insert, update, and delete of client datafiles.

TMSINT_ADM_DICT_MAPPING—The dictionary mapping table is a child table to the datafiles table TMSINT_ADM_DATAFILES and contains one record for every DCM/VT within a datafile to be coded in TMS. For example, a single datafile may contain a DCM/VT (AE/AETERM) that is applicable to adverse event MedDRA coding and a DCM/VT (CONMEDS/CMTERM) that is applicable to Drug coding or multiples of each. The dictionary mapping table associates the specific DCM/VT to be coded with a specific dictionary in TMS. This information is used during TMS processing by the Data-Processing schema. A new DCM/VT dictionary mapping may be added to an existing datafile at any time by simple adding the new record to the TMSINT_ADM_DICT_MAPPING table. To temporarily or permanently discontinue processing of a DCM/VT within a given datafile, the Active Flag can be set to “N” and likewise to reinstate processing of the DCM/VT within the datafile, the Active Flag can be reset to “Y”. All datafile dictionary mappings will initially be created as active. The TMS Dictionary MUST already exist in the TMS repository prior to adding a datafile dictionary mapping. SQL scripts are provided to easily allow for the insert, update, and delete of datafile to dictionary mapping.

TMSINT_ADM_EXT_MAPPING—The external system mapping table is a child table to the datafiles table. This table creates a relationship between a given client datafile and a defined TMS External System. The table contains one record for every column defined in TMS definition of the External System which may be at most eight values (ExtValue1−ExtValue8). If the TMS External System has 6 defined external column values (Study, Site, Patient, Event, etc.) there may be only one record for each defined external system column. This table is used by the TMSINT application to parse the datafile values that will ultimately be stored in TMS during processing. Additional external system mappings can be added to an existing datafile at any time as long as it corresponds to the TMS definition of the external system. To temporarily or permanently discontinue processing of a given external system column, the Active Flag can be set to “N” and likewise reinstated by setting the Active Flag back to “Y”. All datafile external mappings will initially be created as active. The TMS External System MUST already exist in the TMS repository prior to adding a datafile external system mapping. SQL scripts are provided to easily allow for the insert, update, and delete of datafile to external system mapping.

TMSINT_ADM_ADDON_COLS—The add-on column mapping table is also a child table to the datafiles table. This table provides and optional means to collect and store ancillary data associated to a specific DCM within a given datafile. These column values are not stored within the TMS repository during the coding process; however, they can be used for later omission management via TMS Drill-Down views in which ancillary data may be queried and viewed as additional data to aid in the manual classification process. By default, the ancillary data is stored in the TMSINT application tables but not directly accessible from TMS. Ancillary data is optional and as many columns as needed can be stored which may differ between DCMs. For the Adverse Event (AE) DCM, it may be desired to capture ancillary data such as the onset date (ONSDT) or the severity (ONSER); whereas, for the Concomitant Medication (CM) DCM it may be desired to capture the dose (CMDOSE) and frequency (CMDOSFRQ). To temporarily or permanently discontinue processing of a given external system column, the Active Flag can be set to “N” and likewise to reinstate processing the Active Flag set to “Y”. All datafile add-on column mappings are initially created as active. SQL scripts are provided to easily allow for the insert, update, and delete of datafile ancillary data.

TMSINT_ADM_ORA_ACCOUNTS—The Oracle accounts table is the metadata table that allows an Oracle schema to be programmatically associated to a specific client. Each client has a data-transfer schema (account type=“XFER”) and a data-processing schema (account type=“PROC”). This table is the mechanism that allows a given Oracle schema to ONLY see the data associated to the given client in which the Oracle account is associated. When creating the required accounts for a TMSINT application client, the actual Oracle schema MUST be pre-existing in the Oracle database and will be validated using the Oracle view ALL_USERS based on user name. Creating or deleting entries does NOT actually create or drop the Oracle schema in the database but is more of a “registration” process which creates a relationship between the Oracle schema and a client as well as controls the selection of client data between the Oracle schemas. Additional SQL scripts are provided to create the Oracle schemas in the database which will default the Oracle password for accounts to the user name. For example, the SQL script to create a data transfer schema for client “INV” will create and Oracle user of TMSINT_XFER_INV and the account has an Oracle password of TMSINT_XFER_INV. The Oracle database password may optionally be changed at any time using normal Oracle means (ALTER <username> USER IDENTIFIED BY <psw>;). When passwords are modified within the database, it is strongly recommended that the corresponding password in the Oracle accounts table be updated as well. The Oracle passwords within the Oracle accounts table are used for query only and not used to connect to the database at the time of this document. SQL scripts are provided to easily allow for the registration and un-registration of Oracle accounts as well as suspending and unsuspending of the accounts by modifying the Active flag to “N” and “Y”, respectively. Suspending the Oracle Data-Transfer schema by setting the Active Flag to “N” will “suspend” or prevent the data transfer activity. Unsuspending the Oracle Data-Transfer schema but setting the Active Flag to “Y” allows the data transfer activity to resume. The same actions can occur for the Data-Processing schema.

TMS to Medidata Rave Integration application Administrator Views

The following Oracle views are created within the TMS integration administrator's schema.

TMSINT_ADM_DICT_VERSIONS—The TMSINT_ADM_DICT_VERSIONS is an Oracle view owned by the TMS to Medidata Rave Integration application administrator and contains a list of all TMS base and/or filter dictionaries and their corresponding dictionary version based on the TMS˜DICTVER informative note. The dictionary type value will be derived based on the dictionary level names and will indicate if the dictionary is an “AE” (Adverse Event) dictionary such as MedDRA, a “DRUG” such as WHODrug or a “FILTER” dictionary such as the SMQ or SDG dictionary.

TMSINT_ADM_DERV_PATH_LEVELS—The TMSINT_ADM_DERV_PATH_LEVELS is an Oracle view owned by the TMS to Medidata Rave Integration application administrator containing the TMS “Derivation Path” dictionary levels per TMS dictionary. This view is used is used by the TMS to Medidata Rave Integration application process when calling the TMS API TMS_USER_FULLAUTOCODE. CLASSIFYTERM to populate the TMS object table TMS_USER_AUTOCODE. DeriveValuesTAB with the dictionary derivation path levels in which to derive back.

TMSINT_ADM_DERV_PATH_COLUMNS—The TMSINT_ADM_DERV_PATH_COLUMNS is an Oracle view owned by the TMS to Medidata Rave Integration application administrator containing the TMS dictionary columns that will be derived for each dictionary level of the TMS dictionary derivation path.

TMSINT_ADM_DICT_ING_LISTS—The TMSINT_ADM_DICT_ING_LISTS is an Oracle view owned by the TMS to Medidata Rave Integration application owner and contains the informative note values for any TMS dictionary having a “PT” dictionary level that has an associated informative note named “INGLIST”. The ingredients list is associated to UMC drug dictionaries in which the Ingredients_LongText.txt file has been loaded into the TMS dictionary. TMS does not allow informative notes to be derived at part of the TMS derivation path; therefore, this view was created for ease of access and viewing of the “INGLIST” outside of the TMS application. The UMC provided ingredient list provided by the vendor is up to 4000 characters in length (ING_LIST_LONG). Due to restrictions within most client source systems, the column ING_LIST_SHORT is provided which consist of the first 500 characters of the ingredient list.

TMS to Medidata Rave Integration application Data-Transfer Tables

The following are Oracle tables are created within each client specific data-transfer schema. The tables are the staging tables of data being extracted from the client's source system for TMS integration processing and the TMS processing results being returned to the client's source system.

TMSINT_XFER_HTML_EXTRACT—The TMSINT_XFER_HTML_EXTRACT table is used to stage data extracted directly from the client source system that is to be processed in TMS. Data written to the EXTRACT table is written in an HTML format as directly extracted from the source system. EXTRACT data will be initially created with a PROCESS_FLAG value of “N” indicating the data has not been processed. During integration processing, the data-processing schema will select pending data and mark the data as being processing with a PROCESS_FLAG of “P”. When the pending EXTRACT data has been read, formatted and successfully copied to the data-processing INBOUND staging tables, the data will be marked as having been processed with PROCESS_FLAG of “Y”. Successfully processed data will subsequently be deleted. Data is written to the EXTRACT table by FILE_NAME as defined in TMSINT_ADM_DATAFILES. Each datafile is applicable to one client clinical study. Once study data has been written to the EXTRACT table, it is deleted before data for the same study/file may be extracted and written to the table.

TMSINT_XFER_HTML_IMPORT—The TMSINT_XFER_HTML_IMPORT table is used to stage TMS processing results for patient records that have been either classified in TMS or records that have been assigned an omission action in TMS that requires a response from the source system. The FILE_TYPE column will contain the values of either “CODING” or “ACTION” indicating the type of update in the client system that is needed. Data written to the IMPORT table is written in an HTML format. The IMPORT data is created by the data-processing schema based on integration processing. Records are initially written with a PROCESS_FLAG of “N” indicating that the record has not yet been processed in the client source system. As the data-transfer schema record updates the records within the client's source system, the PROCESS_FLAG will be updated to “Y”. The next execution of the integration process delete any records that have a PROCESS_FLAG of “Y” before writing any new updates needed. Unlike the EXTRACT table which contains a complete HTML file per study, the IMPORT table will contain HTML files per patient update as required by the source system (i.e. Medidata Rave).

TMS to Medidata Rave Integration application Data-Processing Tables. The following Oracle tables are created within each client specific data-processing schema. The INBOUND tables are the staging tables of client data subject to TMS integration processing. The CODING tables are the “production” tables that contain of all client's data that has been processed in TMS. The JN tables are the audit tables. Each series of tables contains the “core” table as well as a “DTLS” table and a “DERV” table. The “DTLS” table is applicable only to any ancillary data defined for the given DCM. The “DERV” table will contain the TMS “Derivation Path” data and will only contain data for TMS patient records that are VTA classifications.

TMSINT_PROC_INBOUND—The TMSINT_PROC_INBOUND table is used to stage client data by study/datafile that has been obtained from the data-transfer owned EXTRACT table. The INBOUND table is populated using the application metadata tables and applicable data parsed from the HTML within the EXTRACT table. The EXTRACT HTML data transformed into a record format applicable to TMS processing. All data processed in TMS via the integration application will be done based on data in the INBOUND tables. As data is processed in TMS, it will be created or updated in the CODING tables and can then be deleted from the INBOUND tables. The INBOUND tables are cleared of all data at the onset of integration Processing.

TMSINT_PROC_INBOUND_DTLS—The TMSINT_PROC_INBOUND_DTLS table is used to stage client ancillary data for the given patient record in the TMSINT_PROC_INBOUND staging table where ancillary data has been defined in the application metadata table TMSINT_ADM_ADDON_COLS for the given study and DCM. One record is created for each applicable ancillary column defined.

TMSINT_PROC_INBOUND_DERV—The TMSINT_PROC_INBOUND_DERV table is used to stage the TMS derivation path records for the given patient record in the TMSINT_PROC_INBOUND staging table where the patient record is a VTA coding record. The TMSINT_PROC_INBOUND_DERV table is populated directly by the integration process during TMS processing and is not populated via EXTRACT data. When records are classified in TMS, the application views TMSINT_ADM_DICT_DERV_PATH_LEVELS and TMSINT_ADM_DICT_DERV_PATH_COLUMNS are used to generate a record in TMSINT_PROC_INBOUND_DERV for every derivation path level and column for the given patient record. Since the TMS derivation path is define in TMS, the TMSINT_PROC_INBOUND_DERV table may contain records with NULL derivation path values. For example, if the full ATC path is applicable (ATC1 . . . ATC5) but the coding term has a primary ATC at the ATC3 level, the derivation path levels for ATC4 and ATC5 will be NULL.

TMSINT_PROC_CODING—The TMSINT_PROC_CODING table is used maintain all TMS related data for a given client. As data from INBOUND is processed in TMS, it will be either created in the CODING table or updated in the CODING table. The CODING table should always be a representation of the client's source data since the last execution of the integration process. All data within the TMSINT_PROC_CODING table should be either a patient record in TMS_SOURCE_TERMS or an omission record in TMS_VT_OMISSIONS. The TMSINT_PROC_CODING can be populated ONLY with data from TMSINT_PROC_INBOUND. With each execution of the integration process, data in the CODING table will be validated against the TMS repository. If the data have become an inaccurate representation of TMS repository data, the CODING record will be copied back to INBOUND to be reprocessed. Also, with each execution of the integration process, data in the CODING table will be validated against the INBOUND table when the study/file exists in INBOUND. If the patient data is referenced in CODING that is no longer in the INBOUND table, the patient record has been deleted from the client source system and will subsequently be written to the JN tables and removed from the CODING tables. TMS repository data will likewise be removed.

TMSINT_PROC_CODING_DTLS—The TMSINT_PROC_CODING_DTLS table will store all ancillary data for the given patient record in the TMSINT_PROC_CODING. Data in the TMSINT_PROC_CODING_DTLS will be created/updated directly from TMSINT_PROC_INBOUND_DTLS during integration processing. Data in the TMSINT_PROC_CODING_DTLS table is only used by the TMS application when applicable TMS drill-down views have been defined for the given TMS external system and DCM.

TMSINT_PROC_CODING_DERV—The TMSINT_PROC_CODING_DERV table stores the complete TMS derivation path for any given patient record in the TMSINT_PROC_CODING that exists as a coding record. Data in the TMSINT_PROC_CODING_DERV is created/updated directly from TMSINT_PROC_INBOUND_DERV during integration processing. Data in the TMSINT_PROC_CODING_DERV table is only used for the purpose of returning one or more components of the TMS derivation path to the client source system.

TMSINT_PROC_CODING_JN—The TMSINT_PROC_CODING_JN table is an audit table that is used to maintain a history of changes made to patient records. Data from TMSINT_PROC_CODING is written to the TMSINT_PROC_CODING_JN table when a patient record is being deleted from the client source system and TMS or when any component of the patient record is being updated including ancillary data and TMS derivation path data. When a JN record is created, the JN_ENTRYTS, JN_ENTRY_BY and JN_REASON are specified. The ENTRY_TS and ENTRY_BY of the JN record created will automatically become the UPDATED_TS and UPDATE_BY records values in the TMSINT_PROC_CODING records that is superseding the JN record except in the case of deleted patient records.

TMSINT_PROC_CODING_DTLS_JN—The TMSINT_PROC_CODING_DTLS_JN table is an audit table that is used to maintain a history of patient ancillary data. Data from TMSINT_PROC_CODING_DTLS is written to the TMSINT_PROC_CODING_DTLS JN table when a patient record is being deleted from the client source system and TMS or when any component of the patient record is being updated including ancillary data and TMS derivation path data. When a JN record is created, the JN_ENTRY_TS, JN_ENTRY_BY and JN_REASON will be the same as the parent JN record in TMSINT_PROC_CODING_JN.

TMSINT_PROC_CODING_DERV_JN—The TMSINT_PROC_CODING_DERV_JN table is an audit table that is used to maintain a history of patient derivation path data (if applicable). Data from TMSINT_PROC_CODING_DERV will be written to the TMSINT_PROC_CODING_DERV JN table when a patient record is being deleted from the client source system and TMS or when any component of the patient record is being updated including ancillary data and TMS derivation path data. When a JN record is created, the JN_ENTRY_TS, JN_ENTRY_BY and JN_REASON will be the same as the parent JN record in TMSINT_PROC_CODING_JN.

TMSINT_PROC_LOGGING—The TMSINT_PROC_LOGGING table is a logging table that will be populated with TMS integration processing runtime results. The logging table is truncated and repopulated with each execution of the integration. Data from the logging table can be queried or emailed for integration processing results and execution times. The logging table is currently being used to specify how many records were processed, how many were new patient records, how many were patient update record as well as how many resulting in classifications or omissions, etc.

TMSINT Application Administrator Database Packages—All TMS integration processing is executed via APIs within Oracle database packages. For ease of maintenance, all database packages are owned by the application administrator. All integration activity performed by the data-transfer schema and the data-processing schema is accomplished so via APIs are owned by the administrator. The individual data-transfer and data-processing schemas are granted execute privileges on the applicable APIs and have the appropriate Oracle synonyms. The application administrator owns three database packages. The TMSINT_ADM_UTILS is designed exclusively for use by the application administrator. The TMSINT_XFER_UTILS is designed for use by the data-transfer schemas and the TMSINT_PROC_UTILS is designed for use by the data-processing schemas. These database packages are described below.

TMSINT_ADM_UTILS Package—The TMSINT_ADM_UTILS database package is owned by the application administrator TMSINT_ADM. The administrator is the overseer of the application metadata and configures new clients for application use, makes modifications, and/or makes additions to existing clients. The APIs available to the application administrator for client setup and management are listed below from the TMSINT_ADM_UTILS database package. Additionally a SQL “wrapper” script has been written to call each of the specified APIs below in which the user will be prompted for the API inputs and the modification can be captured in a LOG file with a before and after image where applicable. The “wrapper” is an alternative means to execute some of the client configuration APIs with scripting allowing the user to be “prompted” for required input.

TMSINT_XFER_UTILS Package—The TMSINT_XFER_UTILS database package is owned by the application administrator TMSINT_ADM but is designed for execution exclusively by the client specific data-transfer schemas (TMSINT_XFER_ <client>). All query related functions are “wrappers” around the corresponding TMSINT_ADM_UTILS query functions but are additionally constrained for the <client> at hand based on Oracle USER and the corresponding ClientID as indicated in the TMSINT_ORA_ACCOUNTS table for the Oracle USER. This means that data-transfer account TMSINT_XFER_ABC can only see data for company “ABC” and the data-transfer account TMSINT_XFER_XYZ can only see data for company “XYZ” even though both are executing the same database package within the same APIs. All non-query related procedures and functions are applicable and operate on the local tables owned by the Oracle data-transfer USER. A private synonym of TMSINT_XFER_UTILS that “points” to the application owner (TMSINT_ADM) package TMSINT_XFER_UTILS is created in the data-transfer schema automatically when the data-transfer schema is created.

TMSINT_PROC_UTILS Package—The TMSINT_PROC_UTILS database package is owned by the application administrator TMSINT_ADM but has been designed for execution exclusively by the client specific data-processing schemas (TMSINT_PROC_<client>). All query related functions are “wrappers” around the corresponding TMSINT_ADM_UTILS query functions but are additionally constrained for the <client> at hand based on Oracle USER and the corresponding ClientID as indicated in the TMSINT_ORA_ACCOUNTS table for the Oracle USER. This means that data-processing account TMSINT_PROC_ABC can only see data for company “ABC” and the data-processing account TMSINT_PROC_XYZ can only see data for company “XYZ” even though both are executing the same API within the same database package. All non-query related procedures and functions are applicable and operate on the local tables owned by the Oracle USER or the corresponding Data-Transfer schema (TMSINT_XFER_<client>) associated with the same client. A private synonym of TMSINT_PROC_UTILS that “points” to the application owner (TMSINT_ADM) package TMSINT_PROC_UTILS will be created in the data-processing schema automatically when the data-processing schema is created.

TMS to Medidata Rave Integration application Bi-Directional Data-Transfer Design—The TMS to Medidata Rave Integration (TMSINT) application process design contains a data-transfer schema and a data-processing schema. The data-transfer schema is responsible for obtaining clinical data from within the client's source system and writing the data to an Oracle staging table for additional processing. The data-transfer schema is also is responsible for updating the client's source system with the TMS processing results and for all direct interfacing with the client's source system using web-services.

The synchronous TMS to Medidata Rave Integration (TMSINT) application performs direct data transfer from RAVE via Rave Web Services (RWS) technology. The TMSINT processes are exposed as web services and are also scheduled via an Oracle DBMS_SCHEDULER at a frequency specified by the client. The TMSINT also exchanges standard clinical data and auxiliary data synchronously and with immediate confirmation.

RWS uses the Representational State Transfer (RESTful) architecture. Data is posted to or retrieved from Rave using HTTP protocol messages posted to specific URLs. Each message receives an immediate success or failure response. In the event of a failure, any pending changes are rolled back. Since RWS uses “RESTful” web services, it does not mandate the use of either Simple Object Access Protocol (SOAP) or Web Services Description Language (WSDL).The Medical Coding Solution supplied by DBMS allows the loading of HTML and text files as data sources.
Extract from Rave
Integrate to TMS
Import Classification and Coding Queries (actions) to Rave

TMS to Medidata Rave Integration Application Data-Transfer Process—Data is entered into the Medidata Rave system. The TMS to Medidata Rave Integration (TMSINT) application is a Webservice that can run on a scheduler or manually.

For example, running the TMS to Medidata Rave Integration (TMSINT) application Extract from Rave for Verbatim Terms extracts auxiliary data into the TMS Integration inbound tables.

Running the TMS to Medidata Rave Integration (TMSINT) application TMS Integration to process all verbatim terms that are marked for processing by TMS sends to TMS and inserts into the TMS SOURCE_TERMS TABLE all their associated key data. The TMS to Medidata Rave Integration (TMSINT) application triggers TMS Synchronization and Autoclassification. In particular:
The TMS to Medidata Rave Integration (TMSINT) application allows the loading of previously coded terms, preserving original coding.
During Autoclassification, TMS searches for an exact match to a dictionary term or an existing VTA in the Domain and links the TMS verbatim term to a dictionary term.
TMS first searches all terms in the Dictionary at the Classification Level, including dictionary terms plus Verbatim Terms that have been mapped to Dictionary Terms in the Domain.
TMS uses a built-in matching algorithm which makes all mixed case terms match and reduces multiple spaces to one space.
For each term that is automatically matched/classified in TMS the verbatim term is associated with a VTA linking it to a dictionary term. During the TMS to Medidata Rave Integration (TMSINT) application, all the derived data is then written to the Outbound Views for processing to the source EDC system; a propagation feature provides enabling coding of identical previously coded verbatim terms to their VTAs.
If the search does not produce a match, TMS can use any custom-defined Autocoder Search Objects to find a match which automatically matches non-equivalent terms. If a match is still not found, manual intervention is required.
The TMS to Medidata Rave Integration (TMSINT) application creates an omission in TMS and record in the source terms table. An omission is being handled in TMS by either coding the term or by applying an Action.
The TMS to Medidata Rave Integration (TMSINT) application is then able to re-submit terms to be re-coded if a verbatim, route or indication field is modified.
The TMS to Medidata Rave Integration (TMSINT) application is written so that extracting data subsequent times will process source data/metadata extract where the verbatim term, route or indication field is modified.

During the system data processing into TMS, the data in the INBOUND table is reprocessed and synchronized with the TMS data to ensure the modified data is updated and omissions are either coded or a TMS Action (Query) is Raised in TMS.

When the TMS to Medidata Rave Integration (TMSINT) application is run for TMS Integration and Import the TMS to Medidata Rave Integration (TMSINT) application imports into the Medidata Rave EDC system all coded data from each individual study/job/domain including dictionary version information and WHODrug ingredients. The TMS to Medidata Rave Integration (TMSINT) application also creates open queries in the Medidata Rave EDC system for the Sites to respond to the Coders coding queries.

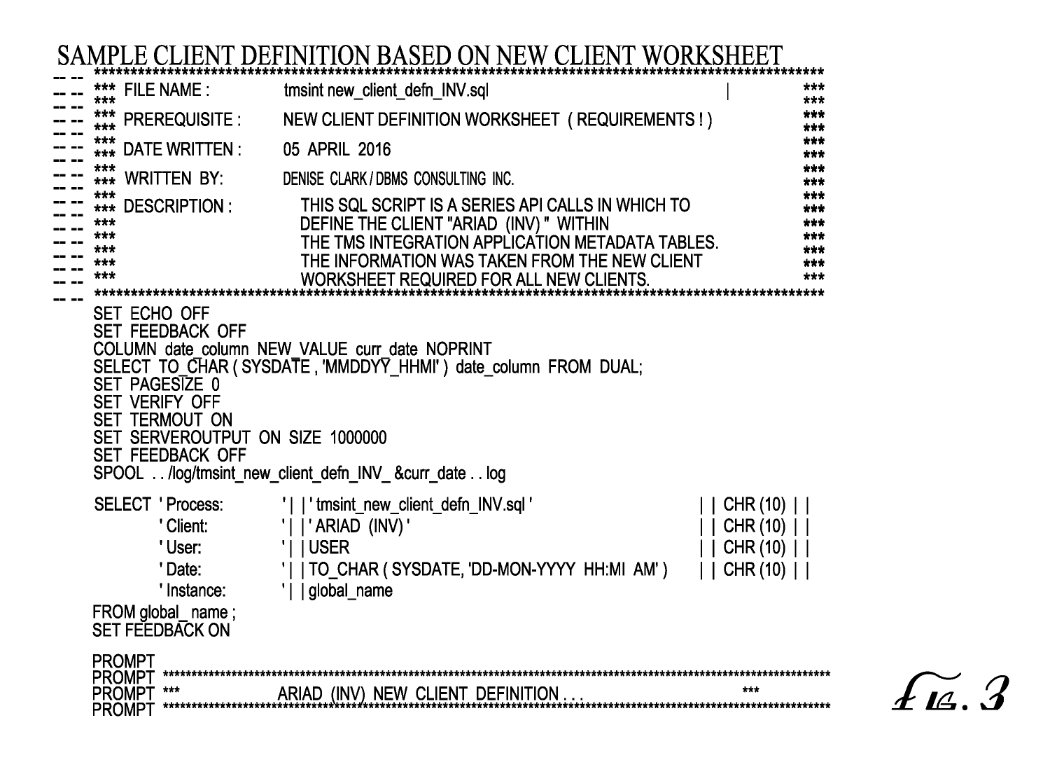

The TMS to Medidata Rave Integration application Bi-Directional Detailed Design provides for extracting Client Source Data via Web-Services by extracting the study dataset from the source Medidata Rave EDC system using the Rave Web Services (RWS) defined as https://{host}/RaveWebServices/studies/{study-id}/datasets/{regular-or-raw}. Alternatively, Client Source Data can also be updated via Web-Services by Updating/Creating the coding assignment and related dictionary hierarchy for each such identified item on the source Medidata Rave EDC system using the Rave Web Services (RWS). The Update/Open query for each such identified item on the source Medidata Rave EDC system using the Rave Web Services comprising continuously (see FIG. 2).
Extracting datasets from Medidata
Validating against TMS and identifying the updates/queries, and
Importing the updates /open queries to Medidata.

TMS Integration TMS Data-Processing Design—The TMS to Medidata Rave Integration (TMSINT) application process design contains a data-transfer schema and a data-processing schema. The data-processing schema is responsible for obtaining clinical data that has been staged by the data-transfer schema, processing the data in TMS, and staging the TMS processing results in the data-transfer schema to be written back to the client's source system by the data-transfer schema. Each of the processing steps performed by the data-processing schema is described below.

Obtaining Client Data for TMS Processing from EXTRACT—The following describes how the data-processing schema will obtain client data from the data-transfer schema that has been extracted and staged for TMS processing.

1. Determine if there is Pending Data to be Processed in TMS—Upon execution of the integration process, the data-processing schema determines if there is pending client data that has been staged by the data-transfer schema. Client data is staged by the data-transfer schema in a raw HTML format within the staging table TMSINT_XFER_HTML_EXTRACT. Data that is pending processing in TMS will have a PROCESS _FLAG value of “N”. If no pending data exists, processing will continue as described in the TMS Processing section below. If pending data exists, processing will continue with performing the steps.

2. Validate Datafiles—Prior to processing, each distinct datafile in the EXTRACT staging table is validated to ensure that the datafile has been written in its entirety. This will be done by verifying that the datafile contains both a beginning of file (BOF) marker and an end of file (EOF) marker.

The BOF/EOF marker for all client datafiles is stored in the NEW_FILE_HTML_TAG column of the application metadata table TMSINT_ADM_DATAFILES. The NEW_FILE_HTML_TAG (i.e. <ODM>) will be used to derive the BOF and EOF file markers. The BOF marker will consist of the NEW_FILE_HTML TAG less the trailing “>” (i.e. <ODM). The EOF marker will consist of the NEW_FILE_HTML_TAG with the “<” replaced with “</” (i.e. </ODM>).

Each EXTRACT datafile will be checked to ensure the BOF/EOF markers are present. If the EOF marker is not found, the file is incomplete. This may occur if the file is actively being written to the EXTRACT table by the data-transfer schema in which case, the datafile will simply be processed with the next execution of the integration process. If the datafile does not have both the BOF marker and the EOF marker, the file will be omitted from current processing. If the datafile contains both the BOF and EOF markers, processing will continue with the step below.

3. Format HTML Records into TMS Records—Data in the EXTRACT staging table exists in a raw HTML format. Before TMS processing may occur, the HTML records are grouped into logical “patient” records. This will be done using the beginning of record (BOR) marker, the end of record (EOR) marker and applicable client metadata.

The BOR/EOR marker for all client datafiles is stored in the NEW_REC_HTML_TAG column of the application metadata table TMSINT_ADM_DATAFILES. The NEW_REC_HTML_TAG (i.e. <ClinicalData>) will be used to derive the BOR and EOR file markers. The BOR marker will consist of the NEW_REC_HTML_TAG less the trailing “>” (i.e. <ClinicalData). The EOR marker will consist of the NEW_REC_HTML_TAG with the “<” replaced with “</” (i.e. </ClinicalData>). Each EXTRACT datafile record will be checked to ensure the BOR/EOR markers are present.

Each HTML record written to the EXTRACT table is assigned a unique identifier (RECORD_SEQNO). The sequential order of the RECORD_SEQNO is the order in which the HTML record was inserted. While the RECORD_SEQNO identifies individual records, the PROCESS_RECNO column will be used during this process to assign a logical record numbers based on the BOR/EOR record markers. Datafile records will be read in the order of insert. The logical record number (PROCESS_RECNO) will be updated to a 1-up number each time the BOR marker is read. All records prior to the first occurrence of the BOR marker will be assigned a PROCEES_RECNO of 0 since these records are HTML header records. As records are sequentially read, each time the BOR marker is found, the PROCESS_RECNO will be incremented and it will be confirmed that the previous record read contained the EOR marker. If the datafile is found to have any unmatched BOR/EOR markers, the file will deemed invalid and will be omitted from further processing. If the datafile was found to be valid, the PROCESS_FLAG will be updated from “N” to “P”, the PROCESS_TS will be updated to the current SYSDATE and the PROCESS_RECNO will be updated to reflect the logical patient numbers.

4. Clear the Data-Processing INBOUND Staging Tables—The INBOUND tables exist within the data-processing schema and are the staging tables for ALL data to be processed in TMS. The INBOUND tables include the tables TMSINT_PROC_INBOUND, TMSINT_PROC_INBOUND_DTLS, and TMSINT_PROC_INBOUND_DERV. The TMSINT_PROC_INBOUND table will contain all information about a patient record. The TMSINT_PROC_INBOUND_DTLS table will contain all of the ancillary data for the corresponding TMSINT_PROC_INBOUND patient record. The TMSINT_PROC_INBOUND_DERV table will contain the TMS derivation path for the corresponding patient record in TMSINT_PROC_INBOUND (if applicable). The INBOUND tables, which are staging tables, will be cleared of any data at the onset of each process. As data is processed successfully in TMS from the INBOUND tables, the data will be moved to the corresponding CODING tables. The only time data will be left in the INBOUND tables from previous processing is if an error occurred. Since all client data obtained from EXTRACT is cumulative, the previous data in INBOUND may safely be removed at the onset of each process.

5. Stage HTML EXTRACT Data in INBOUND Staging Tables—Data from the EXTRACT staging table having a PROCESS_FLAG of “P” are copied from EXTRACT staging table in the data-transfer schema to the INBOUND staging tables in the data-processing schema. The application metadata tables are used in conjunction with the EXTRACT data to successfully populate the INBOUND tables. The metadata tables specify not only core TMS information about a given datafile such as the TMS dictionary, TMS domain and TMS external system but also contains the directive on HOW individual data items such as the VT and the patient “key” values are to be parsed from the HTML data.
The TMSINT_ADM_DATAFILES metadata table will be used to obtain the DatafileID, ClientID, TMS dictionary information, TMS domain information, and the TMS External System name for the given client datafile staged in EXTRACT.
The TMSINT_ADM_DICT_MAPPING metadata table will used to determine what DCMs and VTs are contained within the HTML data and HOW to parse the data values from the HTML using the HTML_TAG and HTML_PREFIX values for the given client datafile staged in EXTRACT.
The TMSINT_ADM_DICT_MAPPING metadata table will also be used to determine HOW to parse the RESPONSE value from the HTML using the RESPONSE_HTML_TAG and RESPONSE_HTML_PREFIX values for the given client datafile staged in EXTRACT. Responses are applicable only to previously processed data in which the specified VT is an omission in TMS, the VT has an open action and the site (client source system) is responding to the action.
The TMSINT_ADM_EXT_MAPPING metadata table will used to determine what patient related “key” values are contained within the HTML data based on the TMS External System and HOW to parse each of the data values from the HTML using the HTML_TAG and HTML_PREFIX values for the given client datafile staged in EXTRACT.

Using the application metadata tables referenced above in conjunction with the staged EXTRACT data and the logical record indicators (PROCESS_RECNO), data are selected, formatted and written to the data-processing INBOUND staging table TMSINT_PROC_INBOUND table based on the mappings below. Certain data items will be obtained from the application metadata tables based on the give client datafile while other data will be parsed directly from the HTML data in the EXTRACT staging table for the given patient record.

6. Stage HTML EXTRACT Ancillary Data in INBOUND Staging Tables—After the TMSINT_PROC_INBOUND table has been successfully populated, the TMSINT_PROC_INBOUND_DTLS table is repopulated with any required ancillary data for the datafile DCM based on defined metadata. Ancillary data is defined for a given datafile at the DCM level and is contained in the metadata table TMSINT_ADM_ADDON_COLS. Ancillary data is applicable to TMS drill-down views only; therefore, not all datafile DCMs will have defined ancillary data.

The TMSINT_ADM_ADDON_COLS metadata table is used to determine what patient related ancillary values are contained within the HTML data and HOW to parse each of the ancillary data values from the HTML using the HTML_TAG and HTML_PREFIX values for the given EXTRACT datafile and DCM. Using the TMSINT_PROC_INBOUND table in conjunction with the application metadata table referenced above and the EXTRACT table, the TMSINT_PROC_INBOUND_DTLS table is populated based on the following mappings below. Note that the logical record number in the EXTRACT table is temporarily stored in the TMS_ERROR_MSG column of the TMSINT_PROC_INBOUND table to enable a direct link between the INBOUND record and the HTML EXTRACT logical patient record.

7. Maintaining the HTML File Header Key Values—For each EXTRACT datafile that was processed and successfully copied to the INBOUND tables, the HTML file header is obtained and written to the LAST_FILE_HEADER column value in the application metadata table TMSINT_ADM_DATAFILES. The HTML header in the EXTRACT table will be updated to reflect a PROCESS_RECNO of 0 during the formatting process. This HTML file header contains key information that is specified in the HTML file data generated that will be written back to the data-transfer IMPORT staging tables. This key information is required by the client source system for the subsequent updates based on TMS processing results.

The following is an example HTML file header containing key information generated by the client source system:
<ODM CreationDateTime=“2016-05-20T09:25:27.026-00:00” FileOID=“f053546e-8445-4d5d-aa70-e21c6c28adcc” FileType=“Snapshot” ODMVersion=“1.3”xmlns=http://www.cdisc.org/ns/odm/v1.3 xmlns:mdsol=“http://www.mdsol.com/ns/odm/metadata” xmlns:xlink=“http://www.w3.org/1999/xlink”>

8. Checking for Duplicated INBOUND Records—The TMSINT_PROC_INBOUND table will be checked for exact duplicate records. Any record that is determined to be a duplicate is removed from the INBOUND tables. It is not likely this situation will occur. However, a check has been put in place to ensure patient records are not duplicated. Duplicated TMSINT_PROC_INBOUND records are denoted as records in which the following column values have more than one occurrence:
TMS_HASH_KEY
CLIENT_ID
DATAFILE_ID
DEF_DICTIONARY_ID
DEF_DOMAIN_ID
VT_UPPER
EXT_VALUE_1 . . . EXT_VALUE_8

9. Checking for Multiple Patient INBOUND Records—The TMSINT_PROC_INBOUND table is checked for patient records having more than one occurrence of a patient record where the record is not an exact duplicate but a subsequent update to the same patient record. The application does not currently support processing multiple versions of the same datafile within the EXTRACT staging table. However, this functionality has been pre-added to handle multiple versions of a patient record if added in future releases.

Records are selected from TMSINT_PROC_INBOUND in which the TMS_SOURCE_TERM ID and TMS_OCCURRENCE_ID occur multiple times. For each of these records, either the VT, the external value representing the “SITE” or the action/response values differ. Each record with the same TMS_SOURCE_TERM_ID will selected and ordered based on the order of insert. The second and subsequent records are updated to reflect a 1-up TMS_OCCURRENCE_ID value.

10. Delete Processed Data from EXTRACT—Once data selected for processing from the EXTRACT staging table has successfully been copied to the INBOUND tables for TMS processing, the data is removed from the EXTRACT staging table which will allow new data to be written to the EXTRACT table during the next execution.

TMS Integration Processing—The following describes how the data-processing schema processes client data in TMS. At the time of TMS processing, any pending client data from the data-transfer EXTRACT staging table will have been written to the data-processing schema INBOUND staging tables. The following processes are then executed during TMS processing:

1. TMS Synchronization—At the onset of every execution of the TMS integration process, the TMS API synchronization with the TMS repository is executed (TMS_USER_SYNCHRONIZATION.SYNCHRONIZE). This ensures that any activity that has occurred via the TMS front-end or any dictionary versioning activity is propagated to the TMS patient data in the TMS_SOURCE_TERMS and TMS_VT_OMISSIONS tables.

2. Analyze Data-Processing Tables—At the onset of every execution of the TMS integration processing, the data-processing schema tables and indexing is analyzed for performance.

3. Remove Obsolete Client Patient Data from TMS—The patient data extracted from the client's source system for a given datafile (i.e. Study) is cumulative and always represents the study's current patient data. If a patient record for the study exists in TMS either as a coding record in TMS_SOURCE_TERMS or an omission record in TMS_VT_OMISSIONS but no longer appears in INBOUND data when the datafile is being processed, then the patient has been deleted within the client's source system and will likewise need to be delete from the client CODING tables and the TMS repository.

For each datafile currently being processed in INBOUND, a determination is mad as to what patient records based on TMS_HASH_KEY exist in the TMSINT_PROC_CODING table that are no longer represented in TMSINT_PROC_INBOUND. These are patient records that have been deleted from the client source system and will be deleted from TMS. For each of these records, the action in Table 6 is taken:

TABLE 6
If the Deleted Patient Record is an Omission in TMS

| Create Audit | Copy the CODING data for the patient record to the JN | |
|---|---|---|
| Records | tables | |
| | TMSINT_PROC_CODING | → |
| | TMSINT_PROC_CODING_JN | |
| | TMSINT_PROC_CODING_DTLS | → |

| | |
|---|---|
| | TMSINT_PROC_CODING_DTLS_JN |
| Delete the TMS | TMS_CONFLICT_RES.VT_OMISSION_DEL |
| Omission | |
| Delete the TMS | TMS_USER_ACTION.DELETEVTACTION (if applicable) |
| Action | |
| Delete TMS THI | Delete corresponding records from TMS_THI_STATUS and |
| Terms | TMS_THI_TERMS |
| Delete the | Delete corresponding records from |
| CODING Records | TMSINT_PROC_CODING and |
| | TMSINT_PROC_CODING_DTLS |

If the Deleted Patient Record is an VTA in TMS

| Create Audit | Copy the CODING data for the patient record to the JN | |
|---|---|---|
| Records | tables | |
| | TMSINT_PROC_CODING | → |
| | TMSINT_PROC_CODING_JN | |
| | TMSINT_PROC_CODING_DTLS | → |
| | TMSINT_PROC_CODING_DTLS_JN | |
| | TMSINT_PROC_CODING_DERV | → |

| | |
|---|---|
| | TMSINT_PROC_CODING_DERV_JN |
| Delete the Patient | TMS_USER_SOURCE_DATA.DELETESOURCETERM |
| Coding Record | |
| Delete TMS THI | Delete corresponding records from TMS_THI_STATUS and |
| Terms | TMS_THI_TERMS |
| Delete the | Delete corresponding records from |
| CODING Records | TMSINT_PROC_CODING, |
| | TMSINT_PROC_CODING_DTLS and |
| | TMSINT_PROC_CODING_DERV |

4. Remove Obsolete Client VTAs from the TMS Repository—The VTAs within the TMS repository are kept synchronized for a given study. Each datafile being processed in INBOUND represents a single study in the client's source system. Under the current application design, each study has its own designated study specific TMS domain. As datafiles are processed in INBOUND, any active VTA that exists in the TMS repository that is no longer represented as a VT in the INBOUND table is declassified in TMS using the API TMS_USER_RECLASSIFICATION.UNDOVTA. This will handle the removal of VTAs in TMS for deleted patients as well as updates made to VTs within the client source system. Active VTAs in TMS always represent the current coding for the given study based on the last integration execution.

5. Flag Previously Processed Client Data for Reprocessing in TMS Each execution of the integration process ensures the previously processed client data that exists in the TMSINT_PROC_CODING table is still “synchronized” with the TMS repository. Client patient data in the application tables may no longer accurately reflect the TMS repository data when a dictionary version upgrade is applied to the dictionary or transactions are completed via the TMS front-end such as reclassifications or any TMS omission management functions.

All patient data that exists in the application CODING tables that does not already exist in the INBOUND tables is checked to ensure accuracy with the TMS repository. If any of the TMS related columns are found to be inaccurate, the data from the TMSINT_PROC_CODING and TMSINT_PROC_CODING_DTLS are copied back to the TMSINT_PROC_INBOUND and TMSINT_PROC_INBOUND_DTLS tables to be reprocessed with the current EXTRACT data that already exists in INBOUND (if any). It is possible to run the TMS integration process even when no EXTRACT data exists to force the client's data to be “synchronized” with current TMS repository data.

6. Processing INBOUND_Data in TMS—All data that exists in the TMSINT_PROC_INBOUND table is processed in TMS via the TMS API TMS USER_FULLAUTOCODE.CLASSIFYTERM. All TMS processing results are captured in the TMSINT_PROC_INBOUND table within the TMS related columns depending on whether the patient record resulted in being a classification record or an omission record in TMS:

7. Obtaining the INBOUND_Derivation Path Data—After all data in the TMSINT_PROC_INBOUND data has been processed in TMS, the TMSINT_PROC_INBOUND_DERV table is populated with the TMS “Derivation Path” for each patient record in TMSINT_PROC_INBOUND where the TMS_VTAID is non-null. The TMS API TMS_USER_AUTOCODE.Try Classifying will be called in conjunction with custom code to retrieve all TMS columns as defined in the views TMSINT_ADM_DERV_PATH_LEVELS and TMSINT_ADM_DERV_PATH_COLUMS. Once the entire TMS derivation path has been obtained the data is inserted into the TMSINT_PROC_INBOUND_DERV tables. One record is created in the TMSINT_PROC_INBOUND_DERV table for every dictionary level/column combination for the given patient record identified by the assigned INBOUND_ID. Since ALL level/column combinations are created, it is possible that some derivation path data values will be NULL. An example is the Drug dictionary which can have a full ATC hierarchical derivation path consisting of ATC level 1 through 5. If the VTA classification term has a “Primary Link” ATC that is an ATC3, then the corresponding ATC4 and ATC5 derivation path values will be NULL.

8. Inserting CODING Data from New Patient INBOUND_Data—After all of the patient data in the TMSINT_PROC_INBOUND table has been processed in TMS, the INBOUND data for new patients are initially created in the CODING tables. New patient data in INBOUND that has not previously been processed will have both a TMS_HASH_KEY value and a TMS_SOURCE_TERM_ID that does not yet exist in the CODING table. These records are new patient records and can simply be inserted into the CODING tables. In this case, all data in the TMSINT_PROC_INBOUND, TMSINT_PROC_INBOUND_DTLS and TMSINT_PROC_INBOUND_DERV tables for the given patient will be inserted into the TMSINT_PROC_CODING, TMSINT_PROC_CODING_DTLS and TMSINT_PROC_CODING_DERV tables, respectively. After the new patient records have been successfully created in the CODING tables, the corresponding patient records will be deleted from the INBOUND tables.

Data for new patients is processed collectively as one Oracle database transaction using Oracle object type arrays. All CODING inserts and all INBOUND deletes are successful for the changes to be committed to the database. In the event of an Oracle error, no databased changes will be committed and the TMS integration process will fail with the appropriate error message.
TMSINT_PROC_INBOUND→TMSINT_PROC_CODING
TMSINT_PROC_INBOUND_DTLS→TMSINT_PROC_CODING_DTLS
TMSINT_PROC_INBOUND_DERV→TMSINT_PROC_CODING_DERV
TMSINT_PROC_INBOUND→Delete
TMSINT_PROC_INBOUND_DTLS→Delete
TMSINT_PROC_INBOUND_DERV→Delete

9. Updating CODING Data from Update Patient INBOUND_Data—After all of the patient data in the TMSINT_PROC_INBOUND table has been processed in TMS, the INBOUND data for previously processed patients is processed. Previously processed patient records have both a TMS_HASH_KEY and a TMS_SOURCE_TERM_ID value that is pre-existing in TMSINT_PROC_CODING. Once the previously processed patient records are identified, the INBOUND data for each patient is compared to the CODING data. If no data values differ, the INBOUND patient record may simply be deleted from INBOUND since no additional action is required.

If one or more data value differences are detected, the current CODING records for the patient are copied as-is to the JN tables to preserve a pre-update copy of the patient record. The TMSINT_PROC_CODING record, all corresponding TMSINT_PROC_CODING_DTLS records and all corresponding TMSINT_PROC_CODING_DERV records will be copied to the JN tables TMSINT_PROC_CODING_JN, TMSINT_PROC_CODING_DTLS_JN and TMSINT CODING_DERV_JN, respectively. The reason for the change is annotated in all JN tables in the JN_REASON column and wells the date of the change in JN_ENTRY_TS and the user making the change in JN_ENTRY_BY. The JN_REASON, JN_ENTRY_TS and JN_ENTRY_BY will be the same value on all of the JN tables. Additionally, the JN_ENTRY_TS will become the UPDATED_TS for all related CODING tables applicable to the new updated values. The UPDATED_TS and UPDATED_BY values of the most record patient CODING record will always point to the JN records in which is superseded. After the current CODING records have been inserted in the JN tables, the CODING tables are then updated to reflect the values of the INBOUND tables. After the CODING tables have been updated, the INBOUND record can be deleted.

Data for patient updates are processed collectively as one Oracle database transaction using Oracle object type arrays. All JN inserts, CODING inserts/updates/deletes and all INBOUND deletes must be successful for the changes to be committed to the database. In the event of an Oracle error, no databased changes are committed and the TMS integration process will fail with the appropriate error message.
TMSINT_PROC_CODING→TMSINT_PROC_CODING_JN
TMSINT_PROC_CODING_DTLS→TMSINT_PROC_CODING_DTLS_JN
TMSINT_PROC_CODING_DERV→TMSINT_PROC_CODING_DERV_JN
TMSINT_PROC_INBOUND→TMSINT_PROC_CODING
TMSINT_PROC_INBOUND_DTLS→TMSINT_PROC_CODING_DTLS
TMSINT_PROC_INBOUND_DERV→TMSINT_PROC_CODING_DERV
TMSINT_PROC_INBOUND→Delete
TMSINT_PROC_INBOUND_DTLS→Delete
TMSINT_PROC_INBOUND_DERV→Delete
When deleting data from INBOUND, all remaining patient records will be deleted and will include those patient records that did not have data changes. The INBOUND tables should have no remaining data after successful processing.

Returning TMS Processing Results (Import)—The following section describes how client TMS processing results are created in the data-transfer staging table TMSINT_PROC_HTML_IMPORT table to be updated in the client source system by the data-transfer schema.

1. Delete Previously Generated IMPORT Data—Prior to generating data in the TMSINT_XFER_HTML_IMPORT table, all previously generated data will be deleted from table where the PROCESS_FLAG is “Y” indicating that the data processing schema has successfully updated the client source system.

2. Generating Coding Data for Import—Any patient data that was initially classified in TMS per the current integration process or any patient classification that was modified in TMS per the current integration process is written to the data-transfer staging table TMSINTXFER_HTML_IMPORT so that client's source system may be updated with the current TMS processing results.

At the onset of integration processing, the execution timestamp is captured. This processing timestamp is then used to select all patient coding data from the TMSINT_PROC_CODING where either the CREATION_TS or the UPDATE_TS is greater than or equal to the execution timestamp. This then selects not only new patient records that were classified but also patient records that were updated by the current process.

As with data from the TMSINT_XFER_HTML_EXTRACT table that has been extracted from the client source system, data written to the TMSINT_XFER_HTML_IMPORT table is also in an HTML format. Unlike the extract data; however, that is one single HTML file per study with multiple embedded records, the import data will be constructed as one HTML file per patient record to be updated.
The import HTML file header is constructed from the metadata table TMSINT_ADM_DATAFILES columns LAST_FILE_HEADER and POST_FILE_HEADER_SUFFIX. The value “Snapshot” is replaced with “Transactional” within the LAST_FILE_HEADER value. Additionally the NEW_REC_HTML TAG is used to derive the BOR/EOR markers.
The patient “key” values as specified in the TMS external system are constructed in an HTML format using the TMSINT_PROC_EXT_MAPPING values of HTML_TAG, HTML_PREFIX and CODING_HTML_SUFFIX in conjunction with the EXT_VALUE_# in TMSINT_PROC_CODING for the given patient in the order specified by POST_COLUM_ID.
Although any TMS related values can be returned to include the full TMS derivation path, by default the application will return the VTA classification term, the dictionary version and in the case of the drug dictionary the list of ingredients. These values are constructed in an HTML format using the TMSINT_PROC_DICT_MAPPING values of HTML_TAG, HTML_PREFIX and CODING_HTML_SUFFIX in conjunction with the corresponding data values from TMSINT_PROC_CODING and TMSINT_ADM_DICT_ING_LIST for the given patient.
The appropriate HTML tags are added for the EOR and EOF markers and the record is created in the TMSINT_XFER_HTML_IMPORT table with a FILE_TYPE of “CODING” and a PROCESS_FLAG of “N”.

Generating Action Data for Import—Any patient omission data that has had an action either initially created or updated in TMS that was created or updated in the CODING table per the current integration process is written to the data-transfer staging table TMSINT_XFER_HTML_IMPORT so that client's source system can be updated with the current TMS response results.
At the onset of integration processing, the execution timestamp is captured. This processing timestamp is then used to select all patient omission data from the TMSINT_PROC_CODING where UPDATE_TS is greater than or equal to the execution timestamp, the TMS_ACTION_TEXT is not null and the TMSINT_PROC_CODING_JN table indicates the creation or update of an action.
Data written to the TMSINT_XFER_HTML_IMPORT table are also in an HTML format. Unlike the extract data; however, that is one single HTML file per study with multiple embedded records, the import data will be constructed as one HTML file per patient record to be updated.
The import HTML file headers are constructed from the metadata table TMSINT_ADM_DATAFILES columns LAST_FILE_HEADER and POST_FILE_HEADER_SUFFIX. The value “Snapshot” is replaced with “Transactional” within the LAST_FILE_HEADER value. Additionally the NEW_REC_HTML_TAG is used to derive the BOR/EOR markers.
The patient “key” values as specified in the TMS external system are constructed in an HTML format using the TMSINT_PROC_EXT_MAPPING values of HTML_TAG, HTML_PREFIX and ACTION_HTML_SUFFIX in conjunction with the EXT_VALUE_# in TMSINT_PROC_CODING for the given patient in the order specified by POST_COLUM_ID.
The VT is returned constructed in an HTML format using the TMSINT_PROC_DICT_MAPPING values of HTML_TAG, HTML_PREFIX and ACTION_HTML_SUFFIX in conjunction with the corresponding VT value from TMSINT_PROC_CODING.
Although any TMS related values can be returned, by default the application returns the TMS omission status and the TMS omission action. These values are constructed in an HTML format using the TMSINT_PROC_DICT_MAPPING values of RETURN_ACTION_HTML in which the values <OMISSION_STATUS> and <OMISSION_ACTION> are replaced with the corresponding data values from TMSINT_PROC_CODING and TMS.
The appropriate HTML tags are added for the EOR and EOF markers and the record is created in the TMSINT_XFER_HTML_IMPORT table with a FILE_TYPE of “CODING” and a PROCESS_FLAG of “N”.

The following example demonstrates integration of the Medidata Clinical Trial System with the Oracle Coding System

### Client Coding Configuration—Setting Up Terms for Coding.

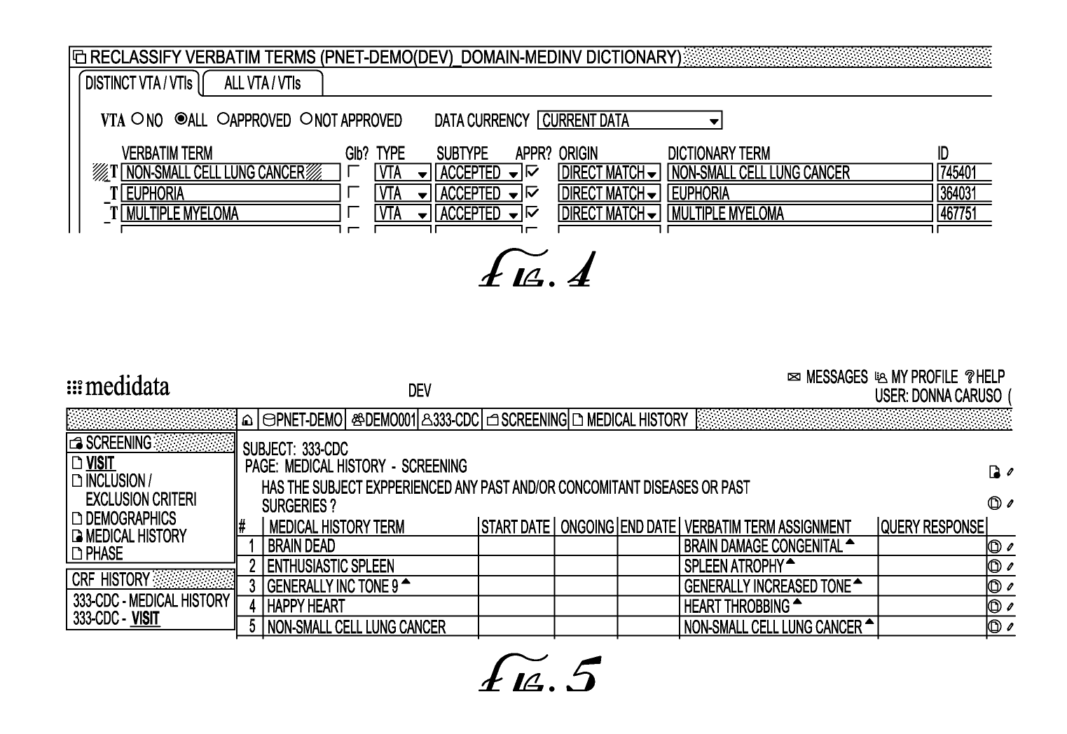

The DBMS TMS to Medidata Rave Integration (TMSINT) application Sample Client TMS Integration Definition Worksheet shown in FIG. 3 is used by the Administrator to configure the verbatim, route and indication fields and all other definitions and configurations for the client.

The DBMS TMS to Medidata Rave Integration (TMSINT) application has the ability to reuse study field configurations (e.g. copying the configuration for an AE Verbatim between studies). A template SQL script is provided that can be cloned and modified for the given client being defined similar to that of the SQL script below. The SQL script has been designed to accommodate subsequent executions and will initially delete the client and all related data prior to executing the SQL script. Synonym (VTA) Load

The DBMS TMS to Medidata Rave Integration (TMSINT) application TMS VTA Batch Load Utility allows the user to preserve previous coding assignments in dsNavigator and is a means to facilitate the creation of approved VTA's in TMS for a given dictionary by which the Verbatim Term (VT), Dictionary Coding Term and optional TMS Domain Name are specified in ASCII TAB delimited file(s). The contents of the ASCII VTA data file(s) is loaded into a staging table called STG_VTA_LOAD. A SQL process creates the distinct TMS Dictionary Domain VTA's using the TMS API TMS_USER_CLASSIFICATION.CreateAcceptedVTA. (See Table 7)

The ASCII VTA data file used by TMS VTA Batch Load Utility is a TAB delimited file less any headings or embedded special characters except for the TAB character used to separate the column values. All efforts should be made to ensure that there are no embedded horizontal tabs characters or new line characters within the text values.

TABLE 7

| Column | | |
|---|---|---|
| No | Column Value | Description |
| 1 | VT | Verbatim Term text |
| 2 | Dictionary Coding | This value corresponds to a dictionary term currently |
| | TERM | active in the dictionary with the dictionary coding level |
| | | and/or coding group. |
| 3 | IMS Domain Name | This value specifies the TMS Domain in which the |
| | <Optional - Default | VTA is to be created. If the value is NULL then the |
| | is “Global” | VTA will be created as a TMS Global VTA. |

Table 8 is an example of a Sample File

TABLE 8

| VT | Dictionary Coding TERM |
|---|---|
| INCREASED CPK | CPK increased |
| ELEVATED CPK | CPK increased |
| ELEVATION OF CPK | CPK increased |
| GAMMA-GTP ELEVATION | GGTP increase |
| DIFFUSE GOITER | Goiter diffuse |
| HOT FLASH | Hot flashes |
| HALLUCINOSIS | Hallucination |
| HALLUZINATION | Hallucination |
| HALLUZINATIONS | Hallucination |
| FORGETFULLNESS | Forgetfulness |
| HEPATIC CYSTS | Hepatic cyst |
| DIFFICULTY IN | Muscular incoordination |
| COORDINATING MOVEMENTS | |
| DIFFICULTY WALKING | Walking difficulty |
| HEPATIC COLIC | Colic biliary |
| ELEVATED GAMMA GT | Gamma GT increased |
| GAMMA GT ELEVATION | Gamma GT increased |
| GAMMA GT INCREASE | Gamma GT increased |
| INCREASE OF GAMMA GT | Gamma GT increased |
| FEELING OF NUMBNESS | Body numbness |
| ALL OVER THE BODY | |
| DIFFICULTY URINATING | Urination difficulty |
| EAR INFECTIONS | Ear infection |
| FRACTURE LEFT LEG | Leg fracture |
| FRACTURE LEG | Leg fracture |
| FRACTURE OF RIGHT LEG | Leg fracture |
| FRACTURE RIGHT LEG | Leg fracture |
| FRACTURE RIGHT LOWER LEG | Leg fracture |
| FRACTURED LEFT LEG | Leg fracture |
| FRACTURED LEG | Leg fracture |

The DBMS TMS to Medidata Rave Integration (TMSINT) application allows for direct data transfer from EDC and Safety Database systems via WebServices and similar technology. The application also allows the loading of HTML and text files as data sources, for example provide Extract from Rave, Integrate data into TMS and Import Classification and Coding Queries (actions) to Rave

### Getting Started

Enter data into Medidata Rave system—The TMSINT application uses a Webservice that can run on a scheduler or manually. This example, illustrates running manually.

Verbatim Terms are loaded into the TMS Integration inbound tables. When the TMS Integration (TI) load utility is run, all verbatim terms that are marked for processing by TMS are sent to TMS and inserted into the TMS SOURCE_TERMS TABLE with all their associated key data. TMS Integration (TI) triggers TMS Synchronization and Autoclassification. The TMSINT application allows the load of previously coded terms while preserving original coding including extracting clinical data from a URL and full TMS integration

### Auto Match

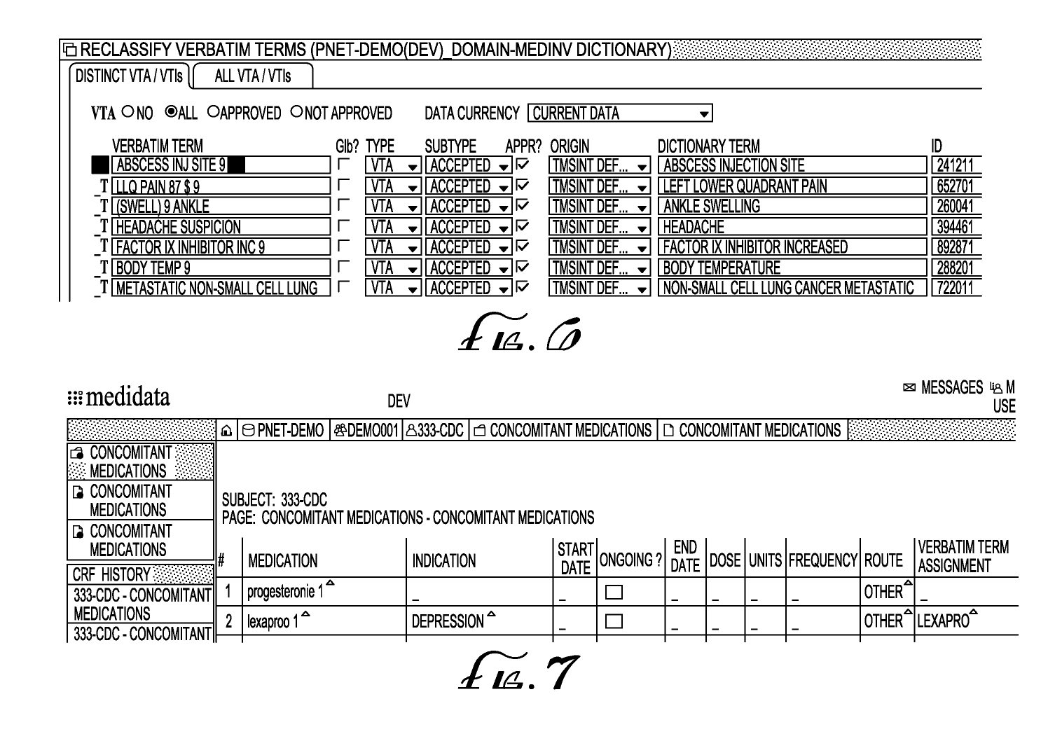

During Autoclassification, TMS searches for an exact match to a dictionary term or an existing VTA in the Domain linking the TMS verbatim term to a dictionary term. TMS first searches all terms in the Dictionary at the Classification Level, including dictionary terms plus Verbatim Terms that have been mapped to Dictionary Terms in the Domain. TMS uses a built-in matching algorithm which makes all mixed case terms match and reduces multiple spaces to one space. (See FIG. 4)

### Auto Match Equivalent Terms

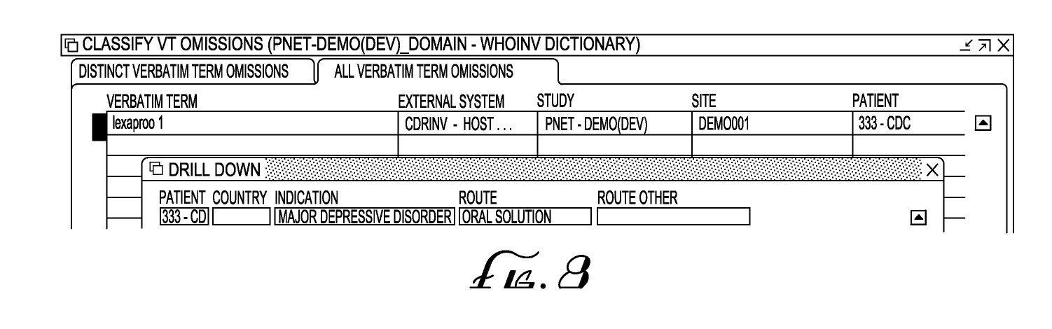

For each term that is automatically matched/classified: the verbatim term is associated with a VTA linking it to a dictionary term in TMS. During the Oracle TMS to Medidata Rave Integration, all the derived data is written to the Outbound Views for processing to the source EDC system. This provides a propagation feature enabling coding of identical previously coded verbatim terms to their VTAs. (See FIG. 5)

### Non-Match

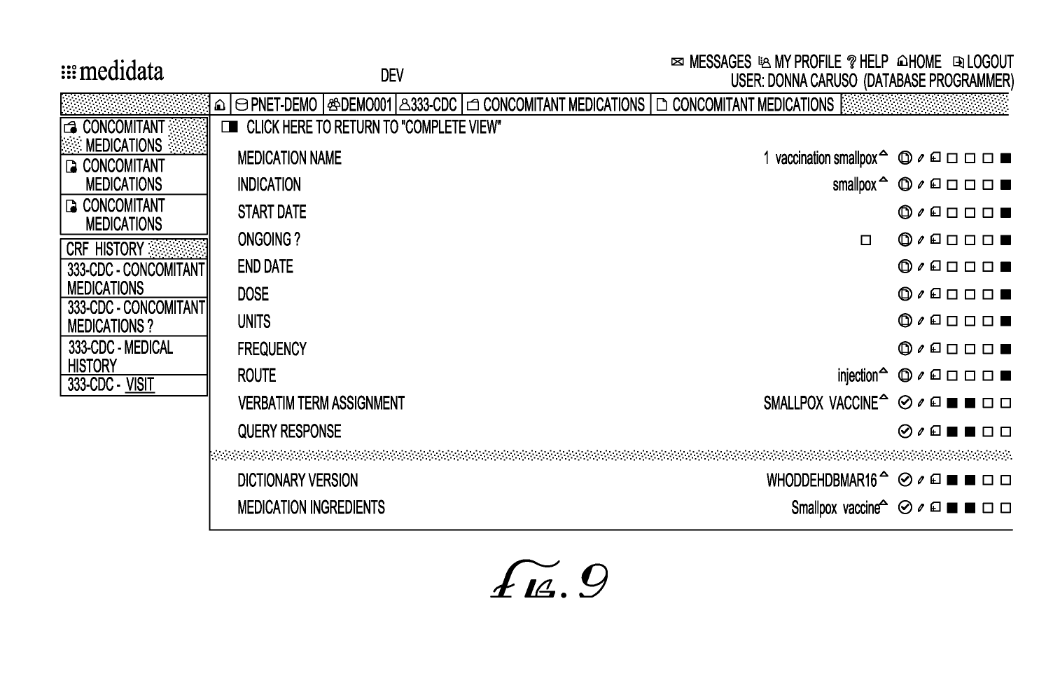

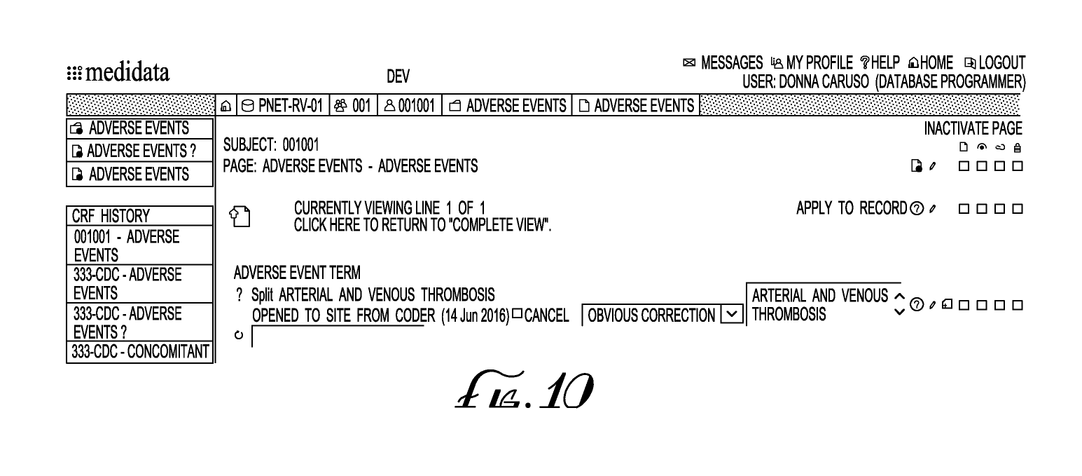

If the search does not produce a match, TMS can use any custom-defined Autocoder Search Objects to find a match which automatically matches non-equivalent terms. (See FIG. 6) If a match is still not found, manual intervention is required. The TMSINT application creates an omission in TMS and a record in the source terms table. An omission is then handled in TMS by either coding the term or by applying an Action.

### Re-Submit Terms to be Re-Coded

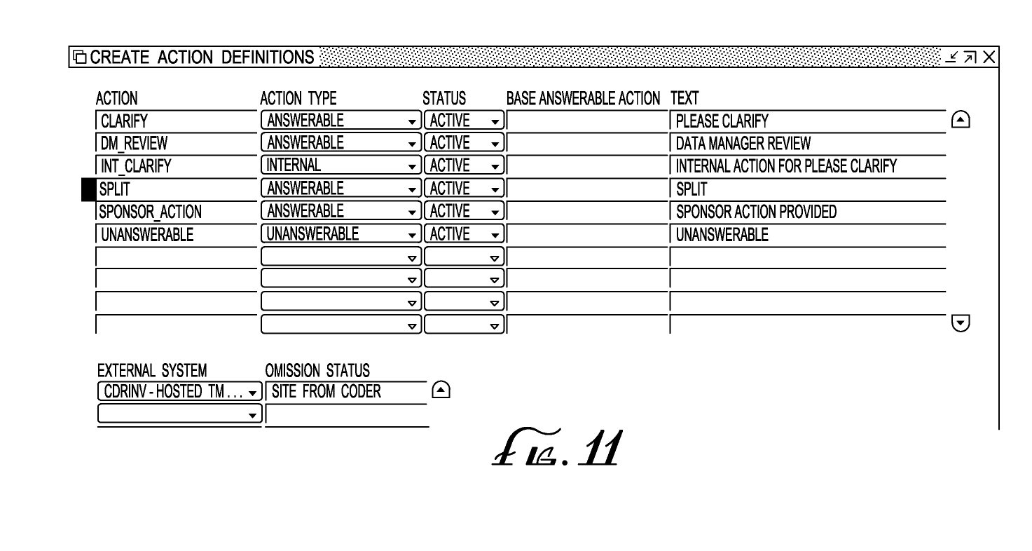

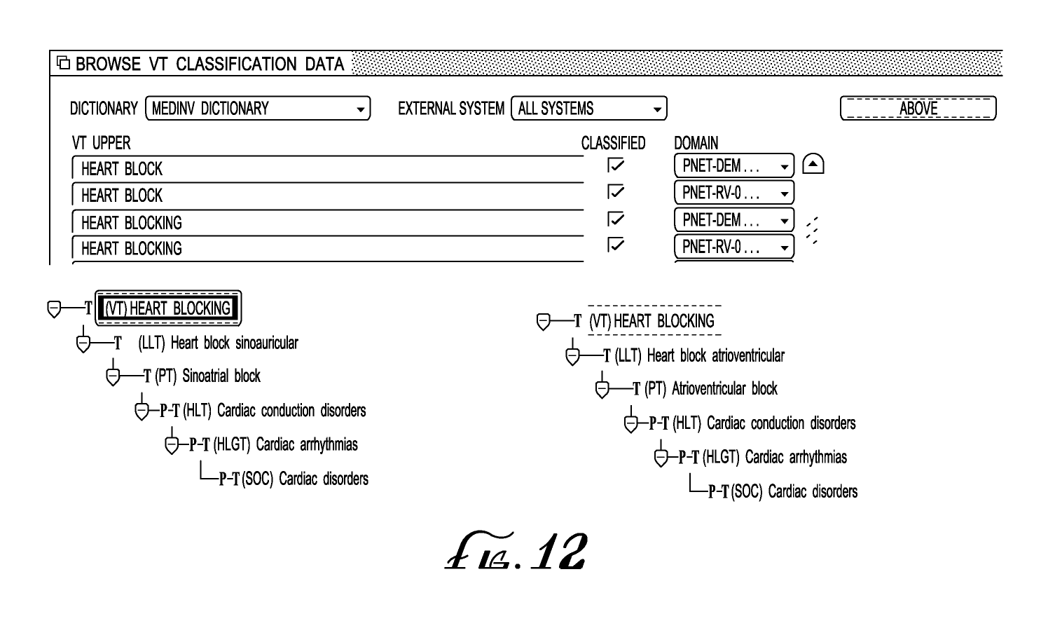

The TMSINT application is able to re-submit terms to be re-coded if a verbatim, route or indication field is modified. The Oracle TMS to Medidata Rave Integration has been written so that extracting data subsequent times will process source data/metadata extracted where the verbatim term, route or indication field is modified. During the system data processing into TMS, the data in the INBOUND table is reprocessed and synchronized with the TMS data to ensure the modified data is updated. (See FIG. 7 and FIG. 8)

### Export Coding Data and Queries From TMS

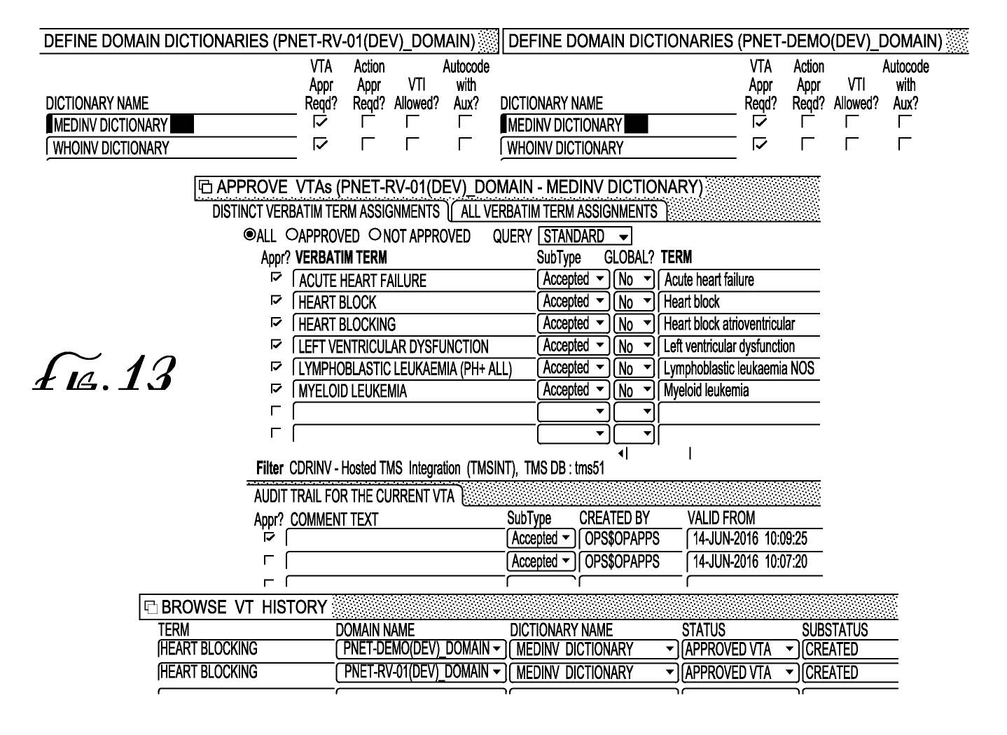

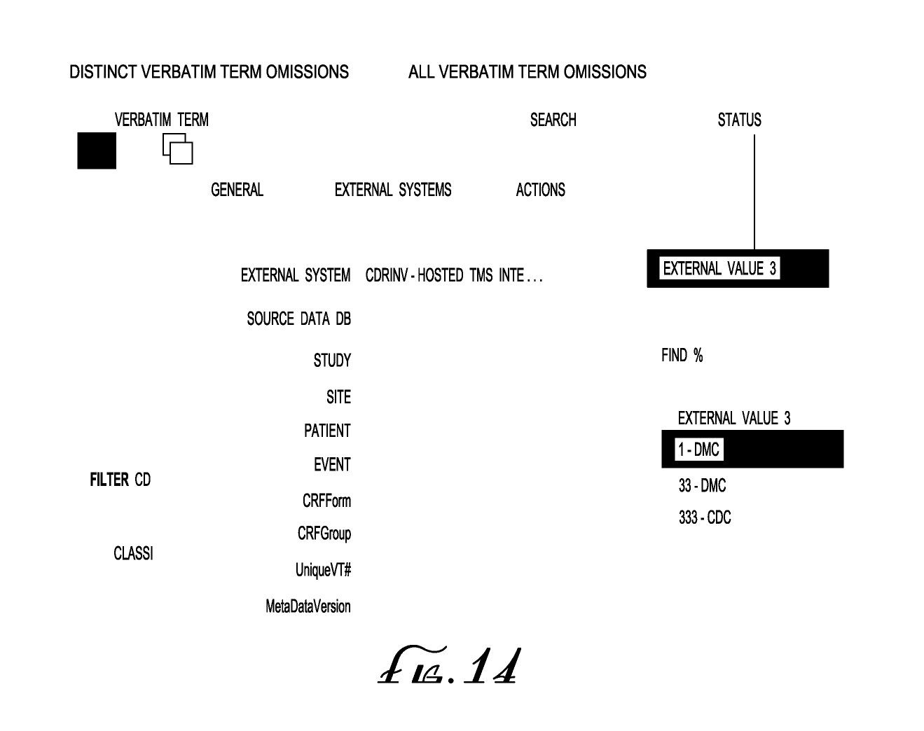

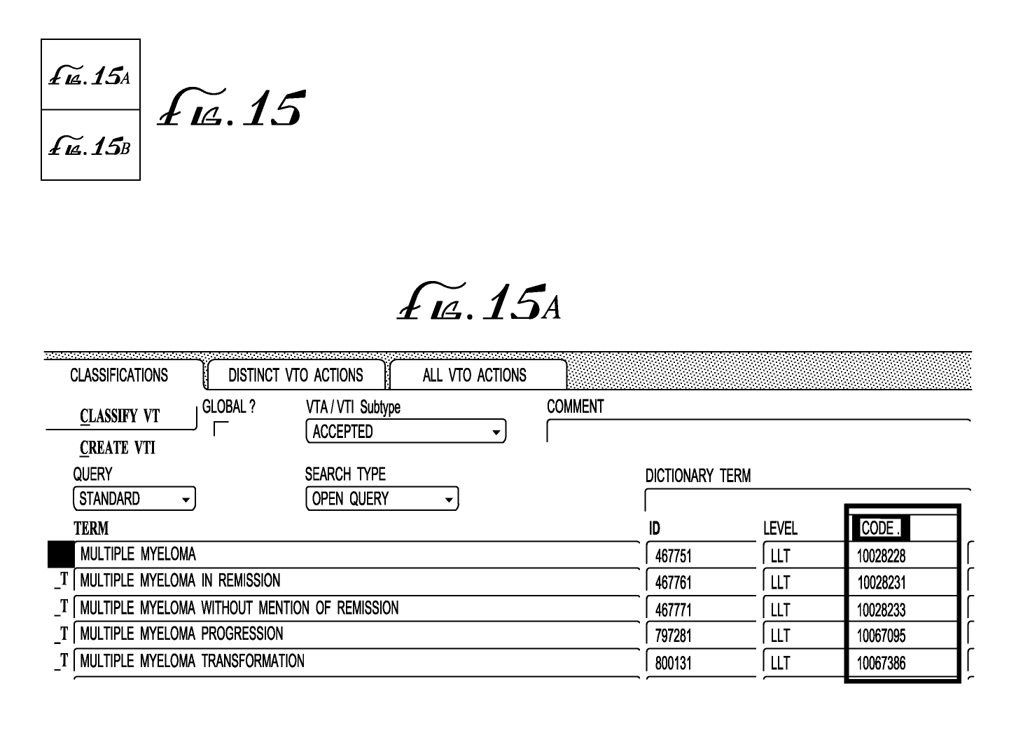

Code omission raises a query in TMS. When the TMS Integration and Import is run the TMSINT application is able to export all coded data from each individual study/job/domain including dictionary version information and WHODrug ingredients. (See FIG. 9). In addition, the export can include the associated source data and actions / queries created in TMS (See FIGS. 10 and 11).

### TMS Domain/Dictionary

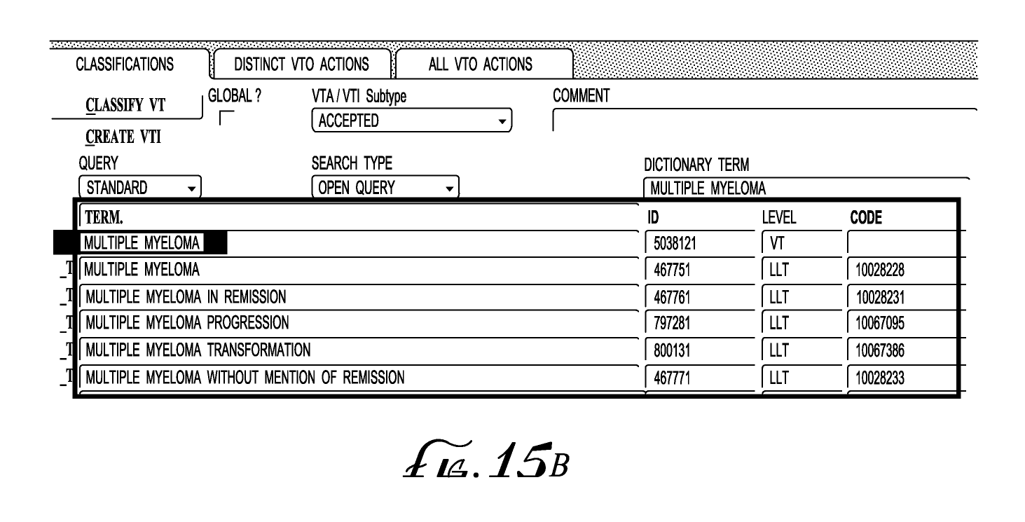

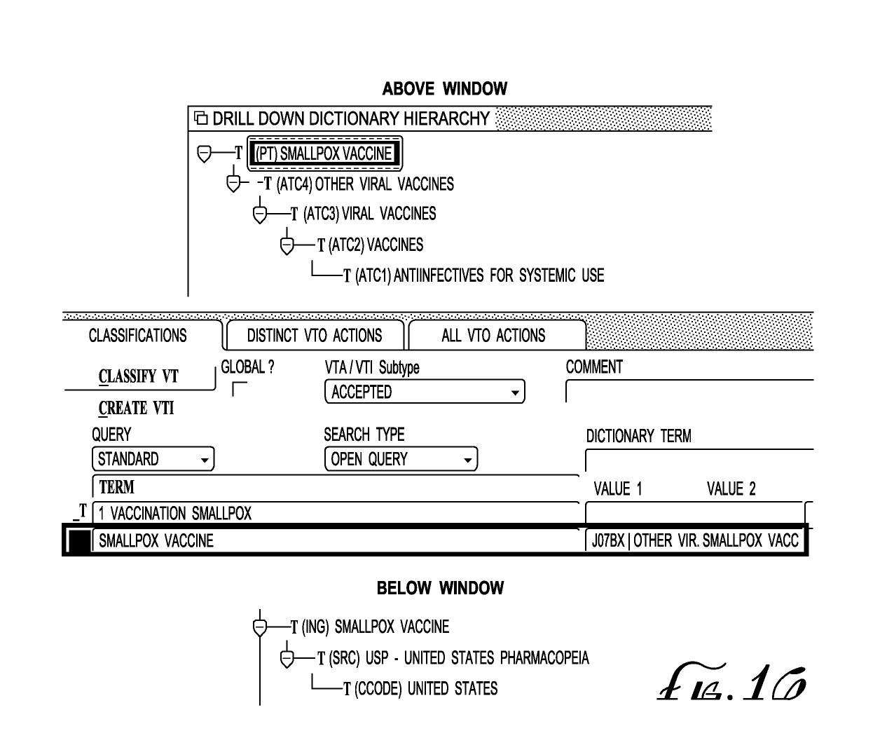

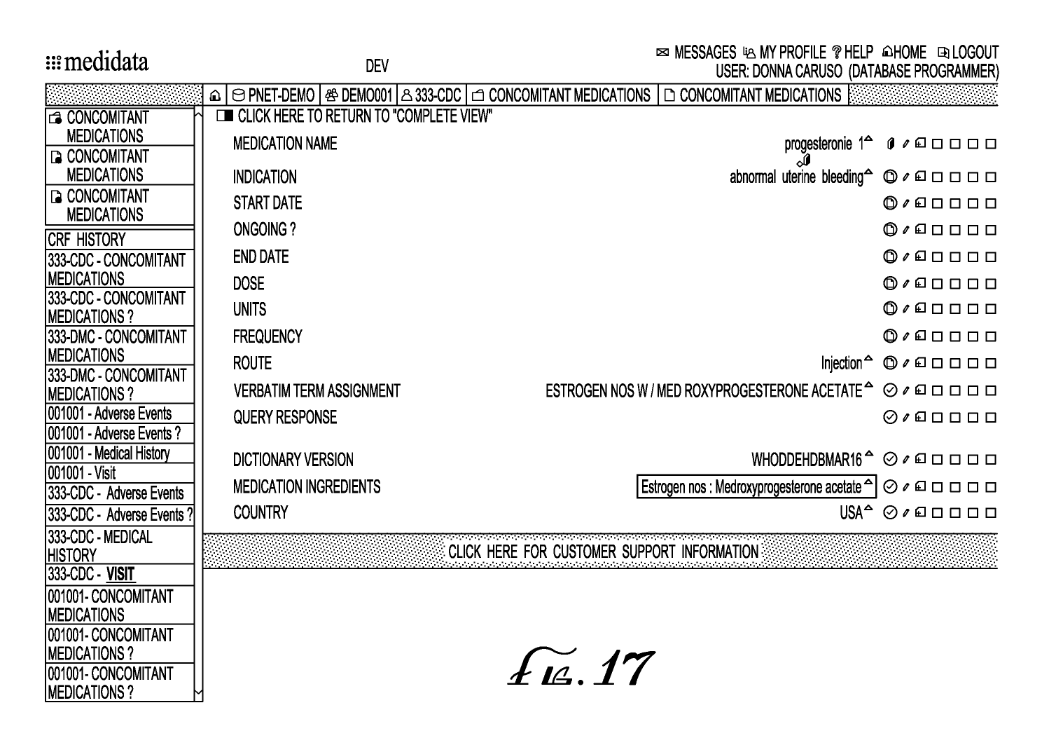

Multiple synonym lists are created enabling different synonym lists to be linked to different studies with the TMS Domain/Dictionary functionality (See FIG. 12). TMS also enables different approval workflow by domain; one study/program can automatically approve a VTA when it is classified while the other study can enforce the manual approval process after classification (See FIG. 13).

### Coding in Oracle TMS

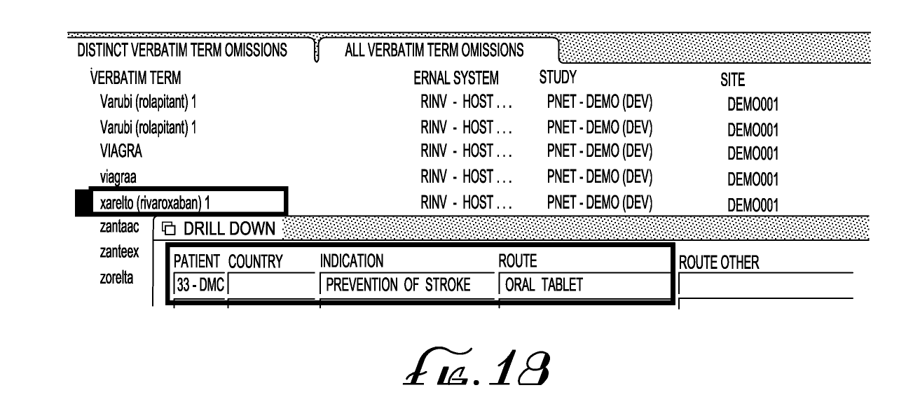

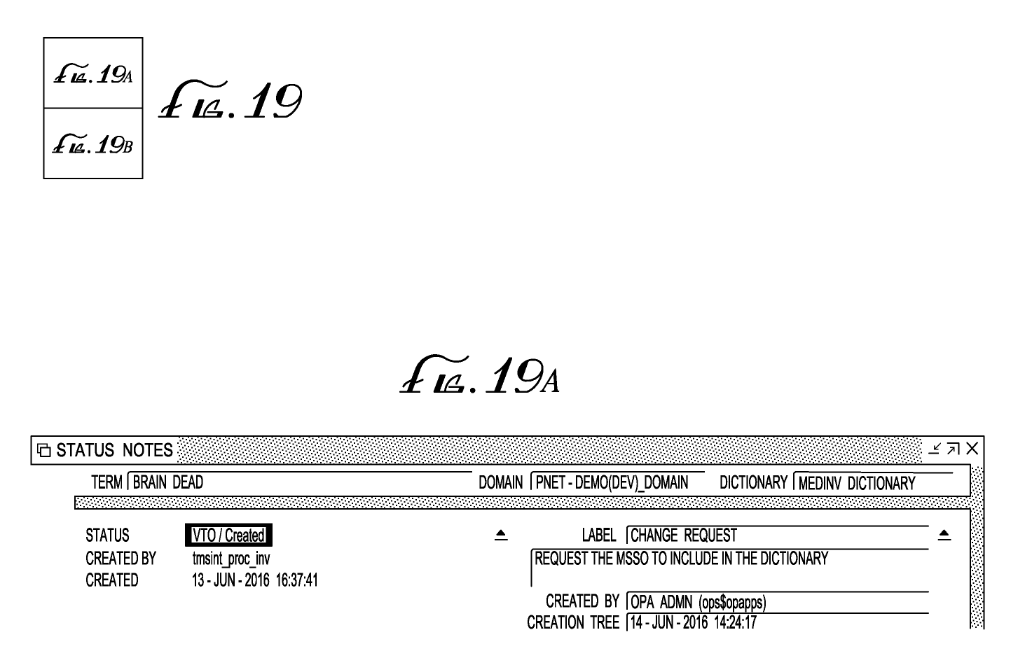

TMS can be accessed by multiple users at the same time and the coder is able to filter using the TMS Omission Filter (See FIG. 14) and while coding, the user can sort coded data within the TMS Classify VT Omissions (See FIG. 15). TMSINT application maintains a unique record ID from the source data.

Source System Unique Record ID Key

| | |
|---|---|
| TMSINT_PROC_INBOUND | INBOUND_ID |
| TMSINT_PROC_INBOUND | EXT_VALUE_1 . . . |
| | EXT_VALUE_8 |
| TMSINT_PROC_CODING | CODING_ID |
| TMSINT_PROC_CODING | EXT_VALUE_1 . . . |
| | EXT_VALUE_8 |

TMS Unique Record ID Key

| | |
|---|---|
| TMS_SOURCE_TERMS | SOURCE_TERM_ID, |
| OCCURRENCE_ID | |
| TMS_VT_OMISSIONS | SOURCE_TERM_ID, |
| OCCURRENCE_ID | |

### Browse Ingredients & ATC

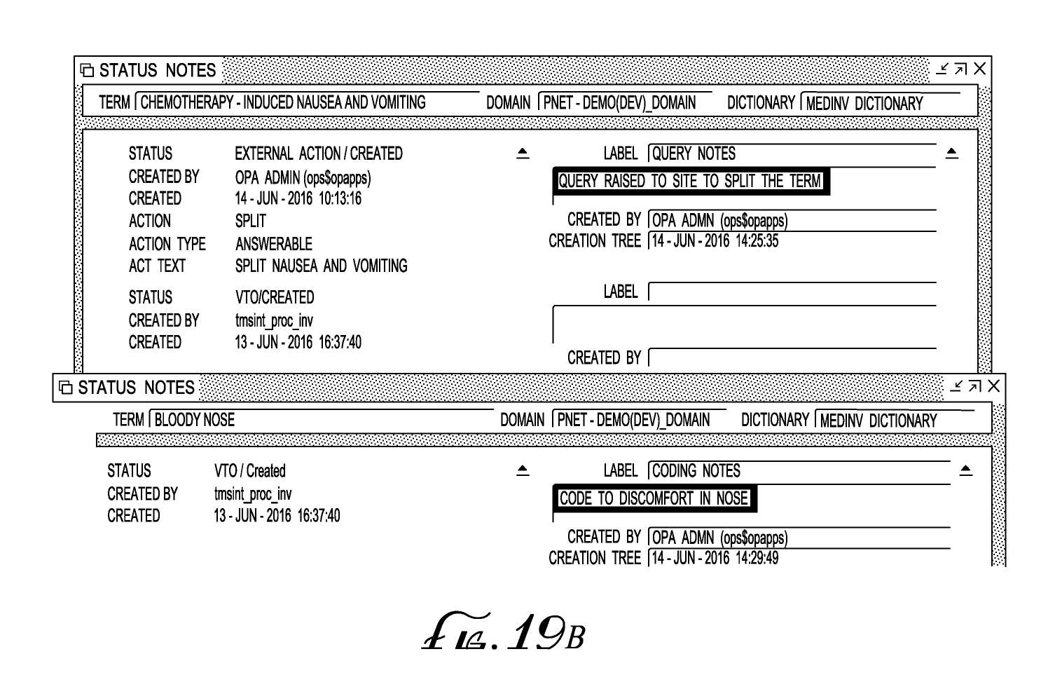

TMS browsing capabilities make ingredients visible when coding in WHO DDE and all multi-axial relationships are able to be seen including the ability to see all ATC levels. While coding in the Oracle TMS coding system, the coder is able to view ingredients, all ATC levels, and all multi-axial relationships for the dictionary classification terms on the Above and Below window.(See FIG. 16).

### Ingredients & Dictionary Version Propagates to Rave

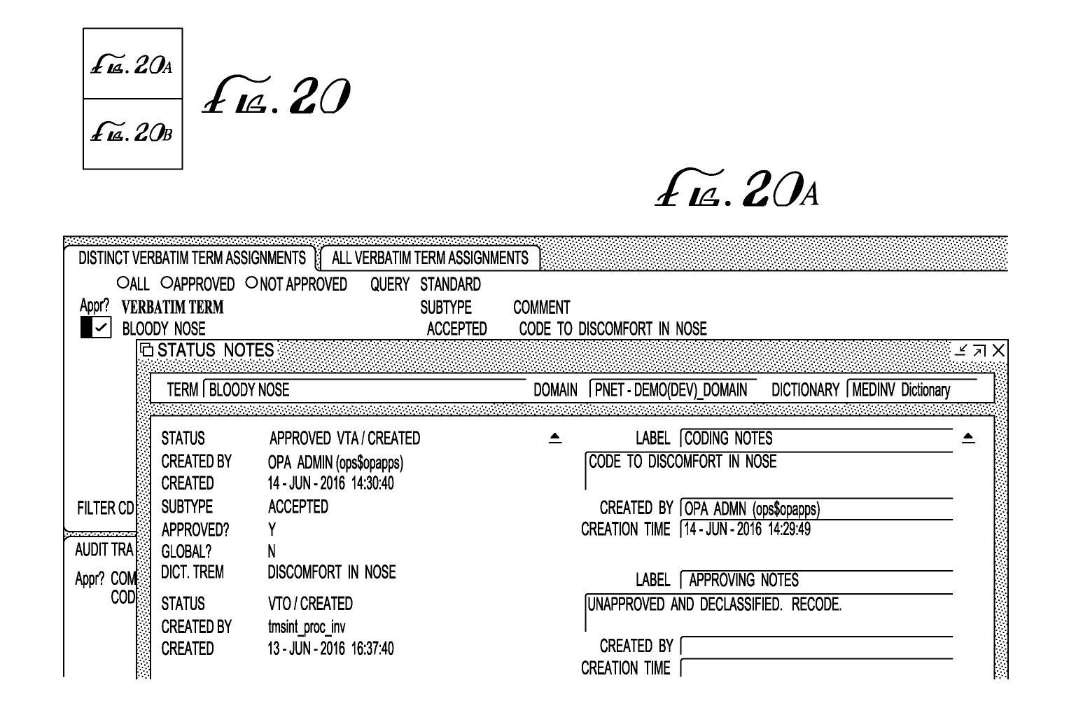

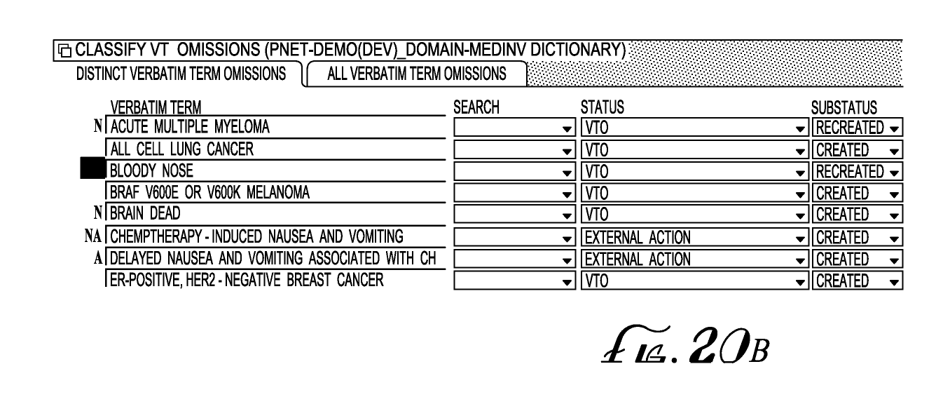

The TMSINT application then propagates the Ingredients and Dictionary Version to Medidata Rave. Additional hierarchy, including the ATC can be propagate if the Rave study is setup to receive the data (See FIG. 17).

### Drill Down Views

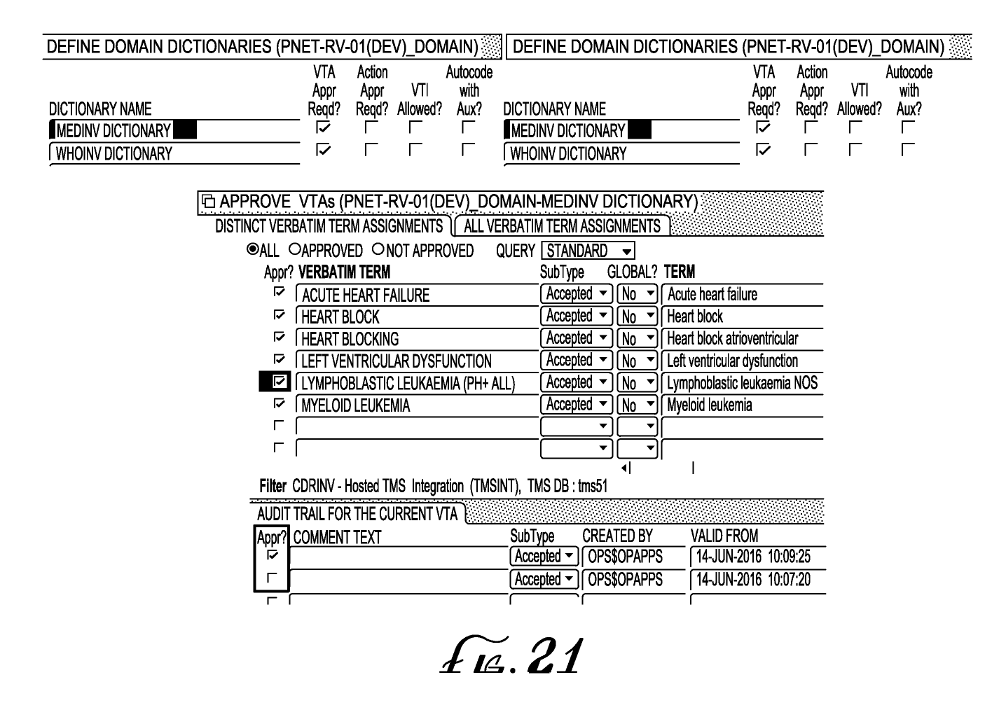

The TMSINT application allows the user to “Drill Down” for auxiliary information (e.g., CM Country, Indication, Route, Route Other) and displays differentiators while coding, allows the ability to use these differentiators for code assignment without automatically adding terms to a synonym list (e.g. allow the ability to use country specific information in the coding of non-distinct trade medications). These Drill Down Views can be customized based on user's need (See FIG. 18).

### TMS Status/Notes

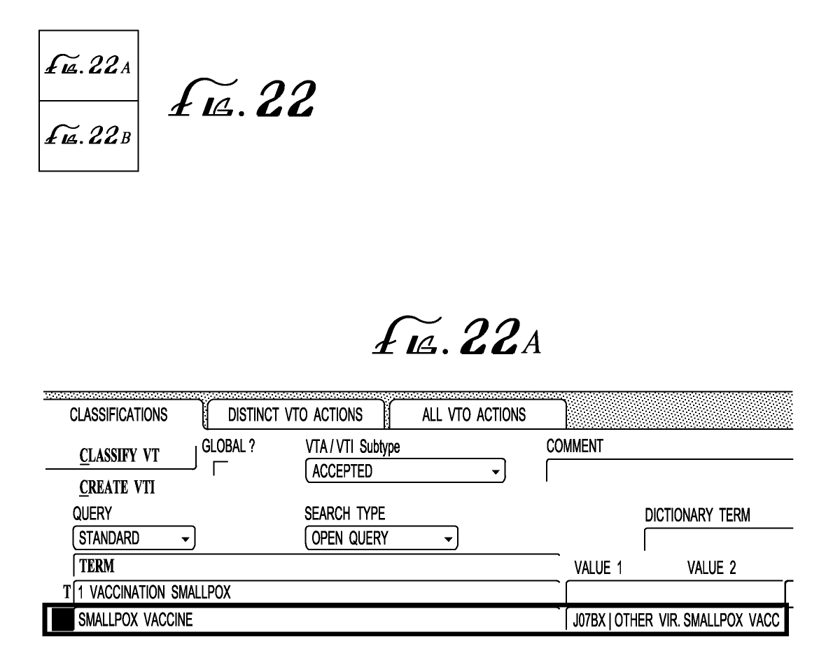

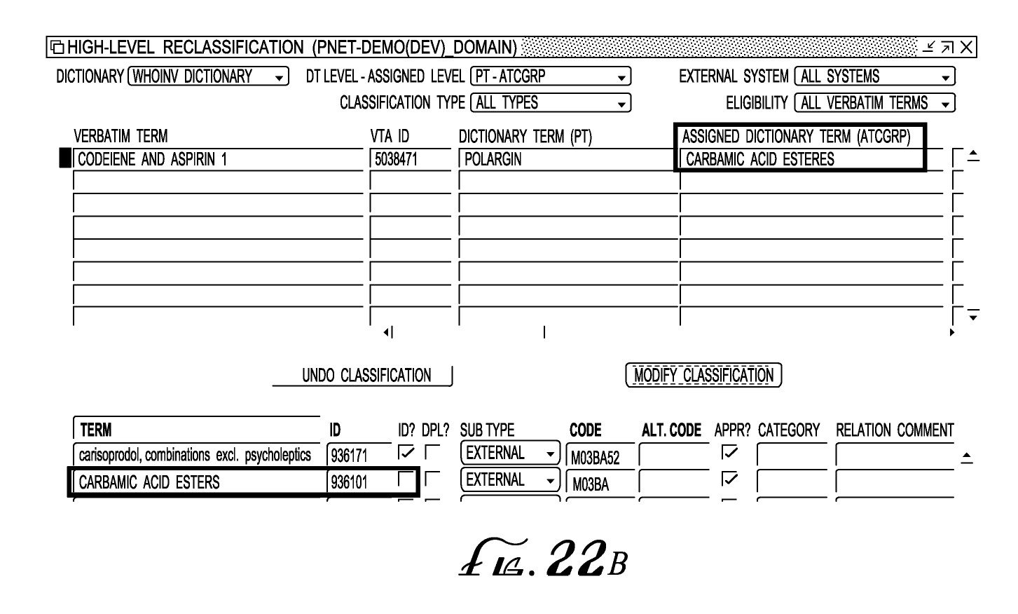

TMS provides the ability to attach/view status codes or notes to coded and uncoded terms (e.g. to indicate terms with outstanding queries or those which have had a change request sent to the MSSO) using the TMS Status/Notes Pop-up Window from the Classify VT Omissions (under Omission Management). Status/Notes can also be propagated to Medidata Rave once an Item is created in the study to receive the Note. (See FIG. 19) and to approve VTAs (under Omission Management (See FIG. 20)

### Coding Approval

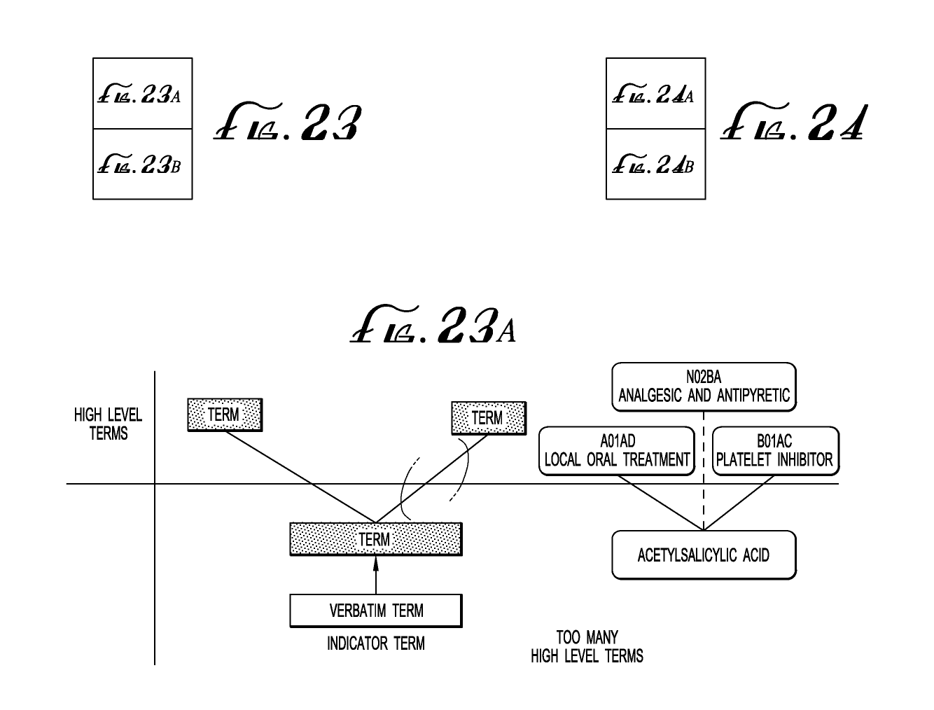

The user has the option, if ever needed, to use a two-step coding process where a second coder must approve the code (VTA Classification).To do this, TMS provides configurable workflows within the coding/approval process (e.g. provide the ability to allow a secondary coding approval work-flow but not mandate it). The workflow is configured in the Domain/Dictionary definition See FIG. 21.

### High Level Classification

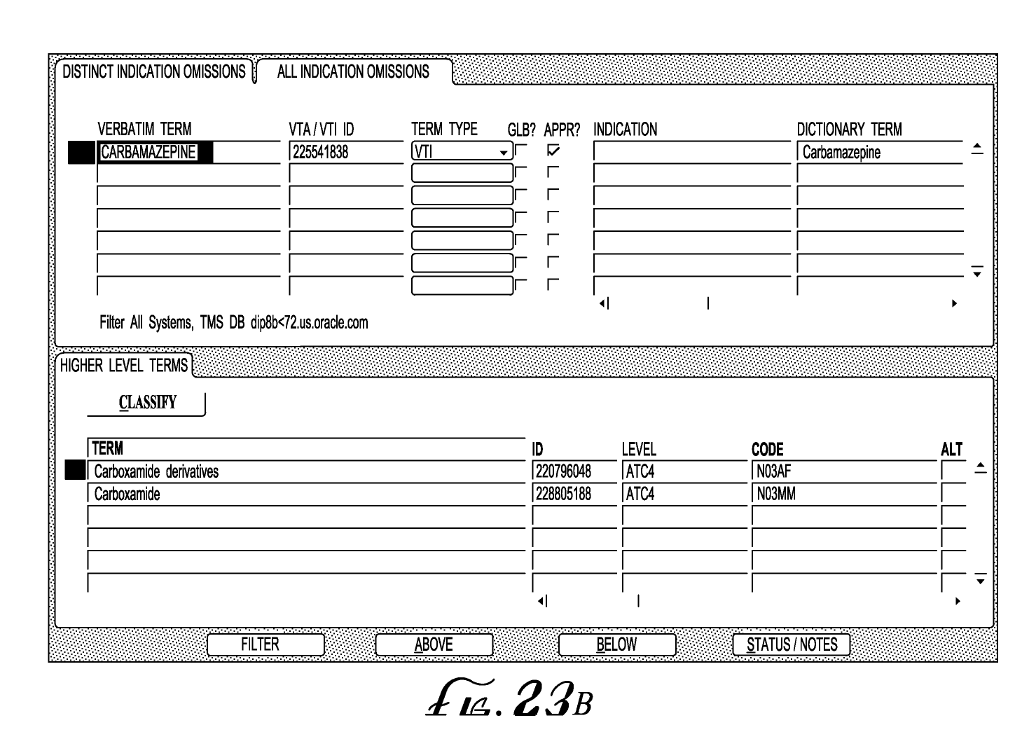

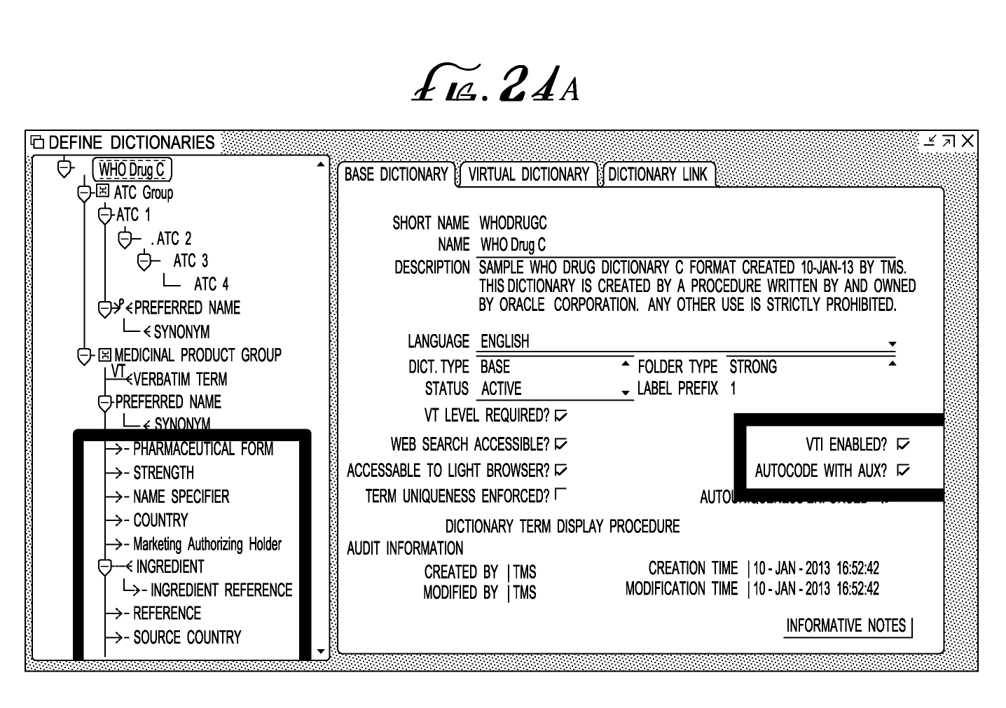

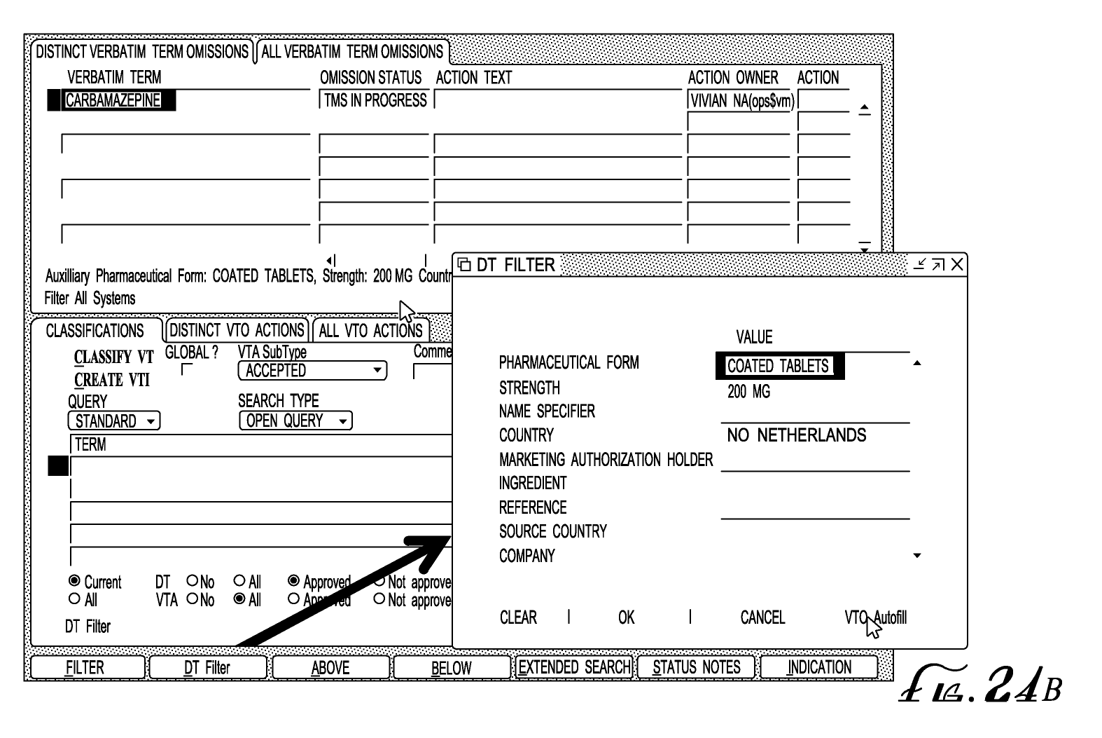

TMS is able to perform ATC coding for medications in a single step and ATC Classification: Terms are automatically classified based on the primary link. For High Level Classification with Primary Link, the Primary link can be reclassified at the Preferred Term level or the source verbatim term level. The ATC can be exported to the Medidata Rave System when the study is setup to receive the ATC Values. (See FIG. 22)

### High Level Term Indicator Classification

For Drug Dictionaries without Primary Links or Paths on the ATC Levels, the Indication Omissions window is available. The coder is able to code/classify to the specific ATC in a single step. This is available when the WHODrug C version is installed.

### TMS Search Object

TMS out-of-the box search object autoencoding capabilities include Auto-coding to previously coded verbatim term assignments (VTAs) within the same domain (this is available when the WHODrug C version is installed), Auto-coding to previously coded verbatim code individual (VTIs), (e.g., the verbatim term plus the auxiliary information of the source term) and Auto-coding of a source term to a non-unique dictionary term using additional drug information of the source term. As well as Automatic ATC classification of a drug based on previous ATC classification of the same drug having the same indication

### Autocode VT+Auxiliary

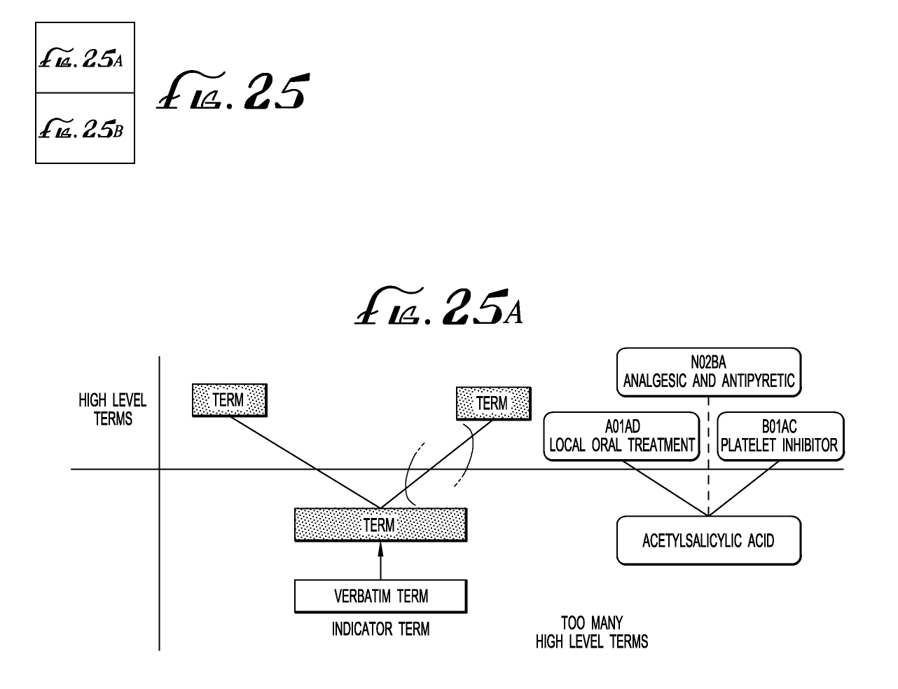

Auto-coding to previously coded verbatim code individual (VTIs), e.g., the verbatim term plus the auxiliary information of the source term (See FIG. 24). TMS Autocode -Indication Classification

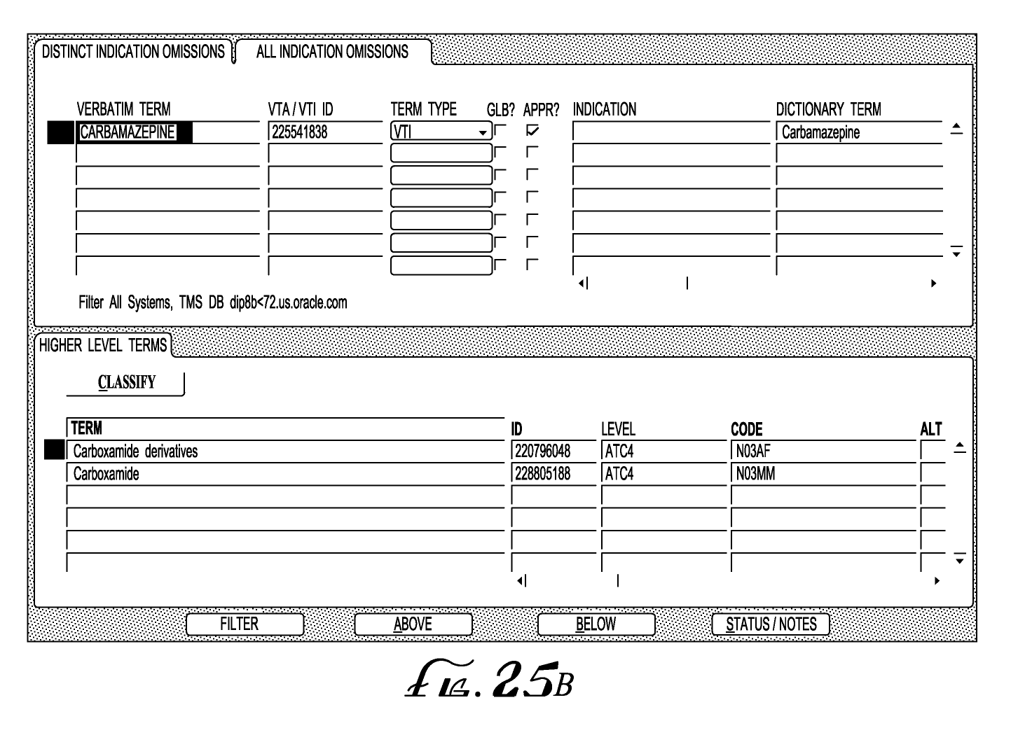

Automatic ATC classification of a drug based on previous ATC classification of the same drug having the same indication (See FIG. 25)

### Custom Autocoder Search Objects

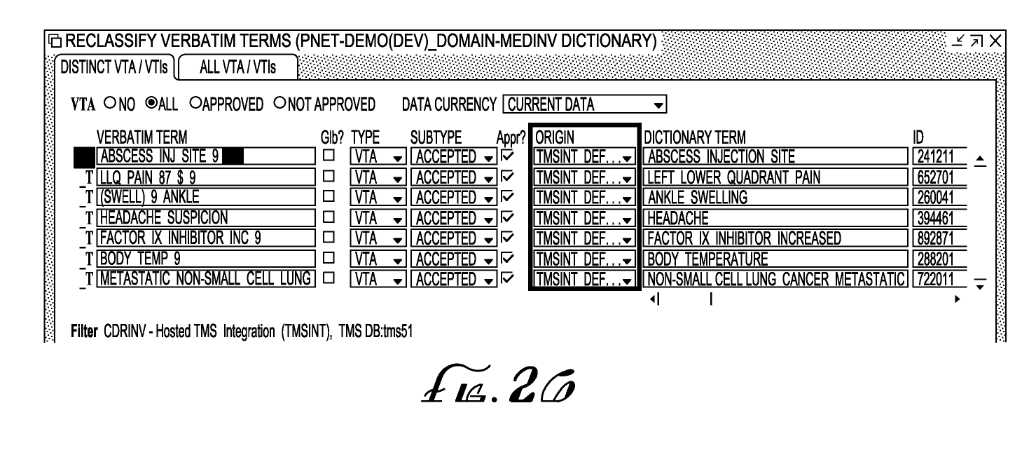

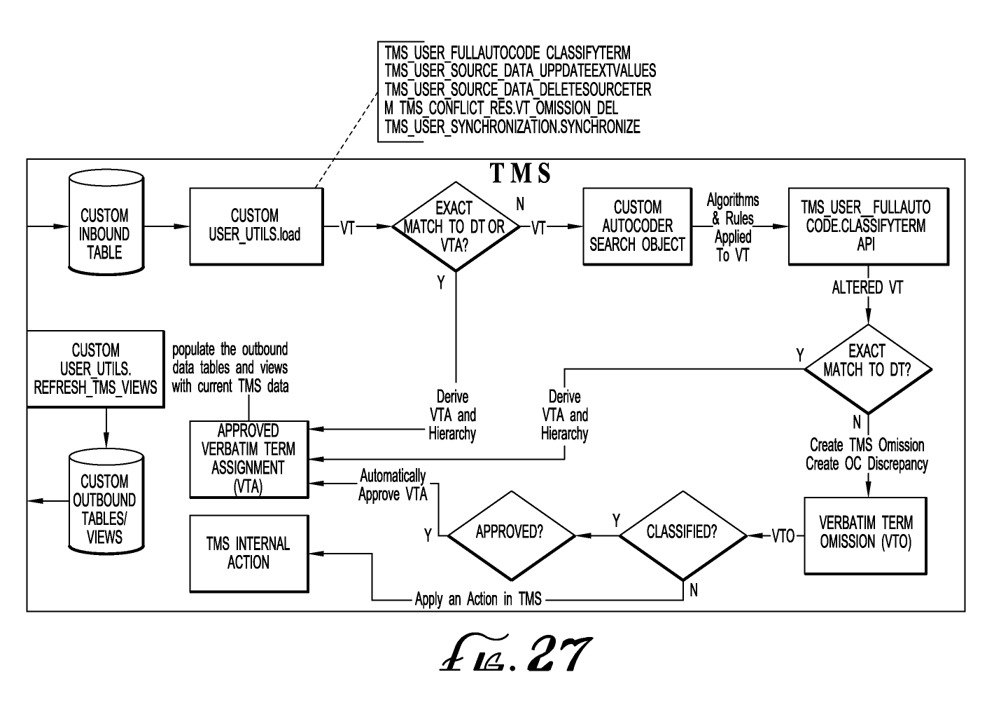

The TMSINT application Custom auto-coding search object algorithms automatically code verbatim terms to the Medical and Drug Dictionaries. The objective is to use the Autocoder during the TMS Integration to increase auto classification efficiency gains, ensure consistency, and avoid delays in processing clinical data in TMS. The TMSINT application Custom Autocoder searches the appropriate dictionaries in TMS and attempts to find automatic matches for a VT based on the algorithm logic. The logic includes word swapping, substitution logic for punctuation, stop words, insignificant word removal, and abbreviation expansion/contraction. Where matches are found, TMS posts the approved VT assignment to TMS and will flag the assignment as being Autocoded. This will enable the user to develop metrics reports for Autocoding performance. The auto coded terms can then be automatically approved by the system. TMSINT application Custom Candidate list auto-coding solution can also be available to propose matches (candidate terms), rate and prioritize the proposed matches, and list the proposed matched for the coder to make the decision on coding to the best match. (See FIG. 26). A flow diagram illustrating the Oracle TMS to Medidata Rave Integration (TMSINT) application with Autocoder Is shown in FIG. 27.

### Custom Autocoder Design

The TMSINT application custom auto-coding search object algorithms are executed during the TMS_USER_FULLAUTOCODE.CLASSIFYTERM API based on the order identified in the Autocode Module Codelist. The logic is as follows:
Verify a direct match cannot be made before starting,
Break up a multi-word term into individual words from left to right and from first word to the last word,
Reorder individual words with all possible permutations of a multi-word term (with limits). Search the dictionary at the classification levels for a direct match, and
Executes procedures against individual words in the order defined in the Autocode Module local reference codelist.

### Custom Autocoder Partial Word Substitution Design

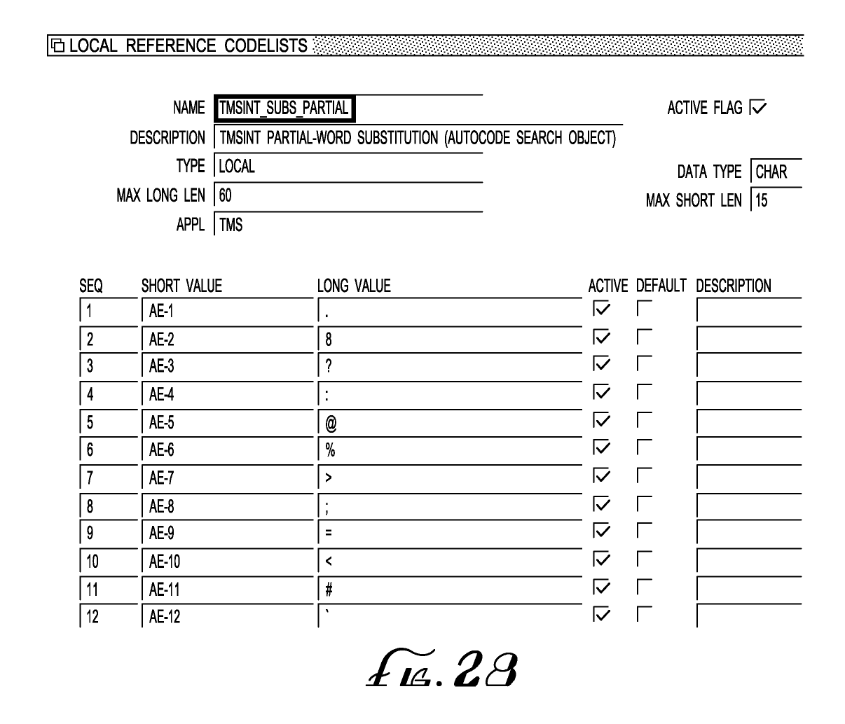

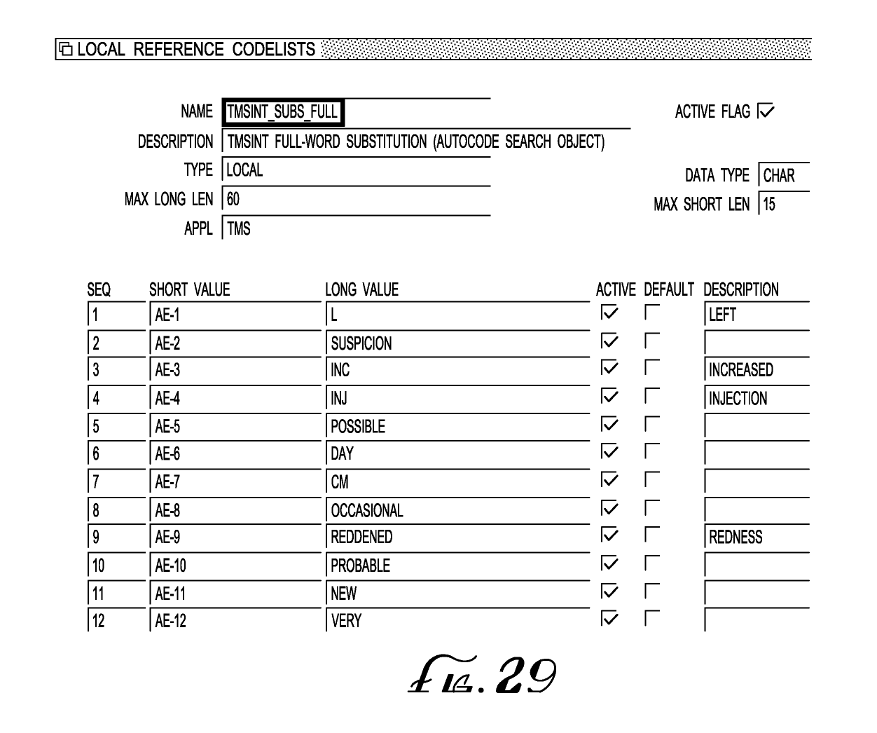

Processes PART_SUBS and WORD_SUBS where the description value is null. For example: When the following characters or words are included in the PART_SUBS and WORD_SUBS codelists, the system removes punctuation & symbols (“; *” to blank), removes numeric values (“0-9” to blank), removes stop words, and removes frequent or insignificant terms (“an, and, is, of” to blank). Once the words in the VT Array are substituted, the VT Term is reconstructed and the dictionary is searched at the classification levels for a direct match for each substitution. If no match is found, continue substitution of same word is continues until there are no more available substitutions. If no match is found, individual words are reordered with all possible permutations of a multi-word term (with limits). The dictionary is then searched at the classification levels for a direct match. The Custom Autocoder Partial Word Substitution Design is illustrated in FIG. 28.

### Custom Autocoder Full Word Substitution Design

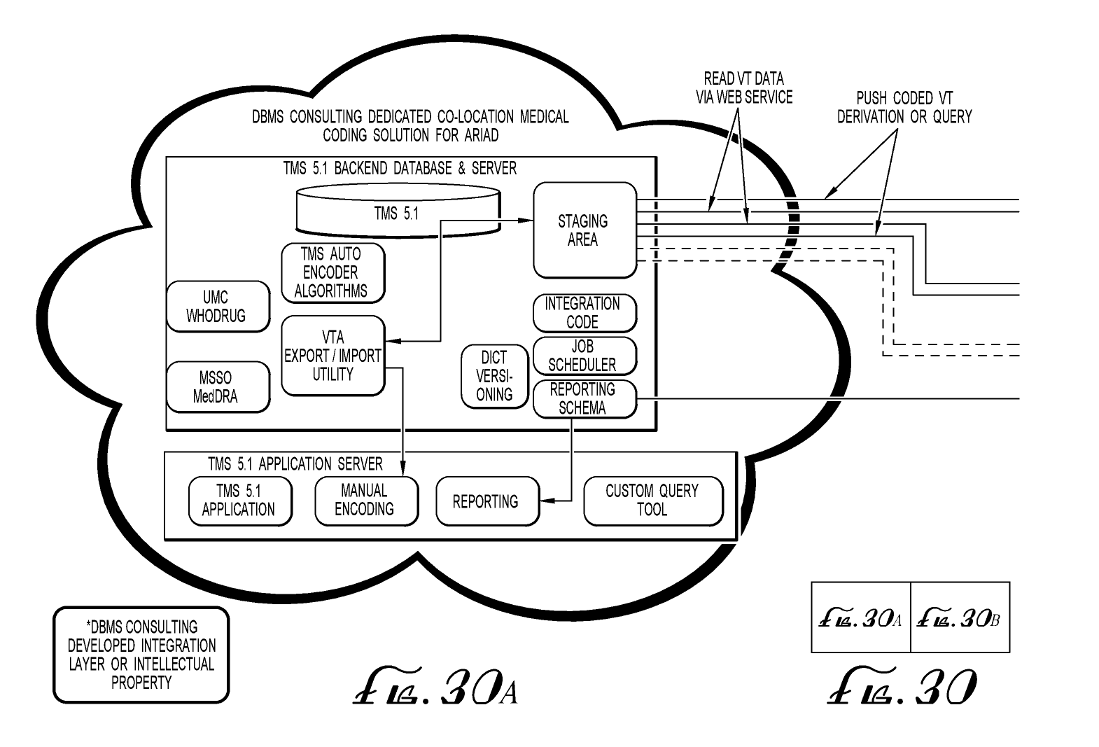

Process WORD _SUBS where the description value is not null. For example: creating a substitution synonym list (TYLENOL to ACETAMINOPHEN), creates a substitution abbreviation expansion/contraction list (OD to right eye, both eyes to OU). Once the words in the VT Array are substituted, the VT Term is reconstruct and the dictionary is searched at the classification levels for a direct match for each substitution. If no match is found individual words are reordered with all possible permutations of a multi-word term (with limits). The dictionary is searched at the classification levels for direct matches for each substitution. If no match is found, after a substitution, the array is refreshed back to its original content before checking the next substitution. If no match is found after performing one substitution at a time and it is know there is at least one substitution, then all substitutions are made and re-checked for a direct match. If no match is found, a check for a direct match is made by re-ordering the words in the Array (See FIG. 29). Table 9 is an example of a custom autocoding procedure

TABLE 9
Custom Autocoding Example
VERBATIM TERM: TRISOMY 185

| | |
|---|---|
| 1 | *** No coding match found for original VT TRISOMY 185 |
| 2 | Parse the current VT into an array of words. |
| | Word #1: TRISTOMY |
| | Word #2: 185 |
| 3 | Reconstruct the VT by moving the last word of the word array to |
| | the first word of the array and checking for a coding match in |
| | TMS by using the |
| | TMS_USER_FULLAUTOCODE.CLASSIFYTERM API. |
| | Repeat the above step until either a match is found or until the |
| | reconstructed VT is the same as the original VT (i.e. original |
| | last word becomes the last word again). |
| | *** No coding match found for re-constructed VT 185 TRISOMY |
| 4 | Reference the VT word array from above which the order of words |
| | is the same as the original VT. |
| | Does the 1^{st} word of the VT have any applicable substitution |
| | values from the TMS Code list PART_SUBS? |
| | Word #1: TRISOMY |
| | <no Substitutions found> |
| | Does the 2^{nd} word of the VT have any applicable substitution |
| | values from the TMS Code list PART_SUBS? |
| | Word #2: 185 |
| | Substitution found for “8”> |
| | Reconstruct VT after the 1^{st} substitution of the 2^{nd} word of |
| | the VT TRISOMY 15 |
| | *** Coding match found for VT TRISOMY 15 |

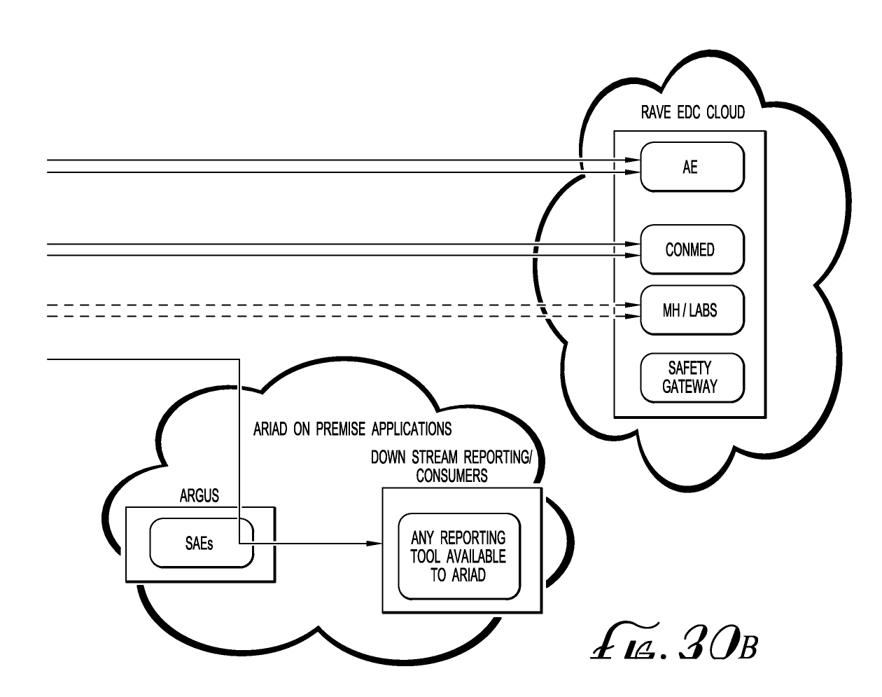

The Oracle TMS to Medidata Rave Integration (TMSINT): Architecture incorporating features of the invention is schematically shown in FIG. 30. The OPA Domain includes the WebLogic Server Administration Console, WebLogic Server Java, and OpaServer1, which are required to run RDC Onsite and, if the user has the Oracle Thesaurus Management System (TMS) installed, it includes the TMS Browser and TMS reports and the database connections. When the Oracle Enterprise Manager is installed in the FR Domain, it also functions to monitoring the OPA Domain.

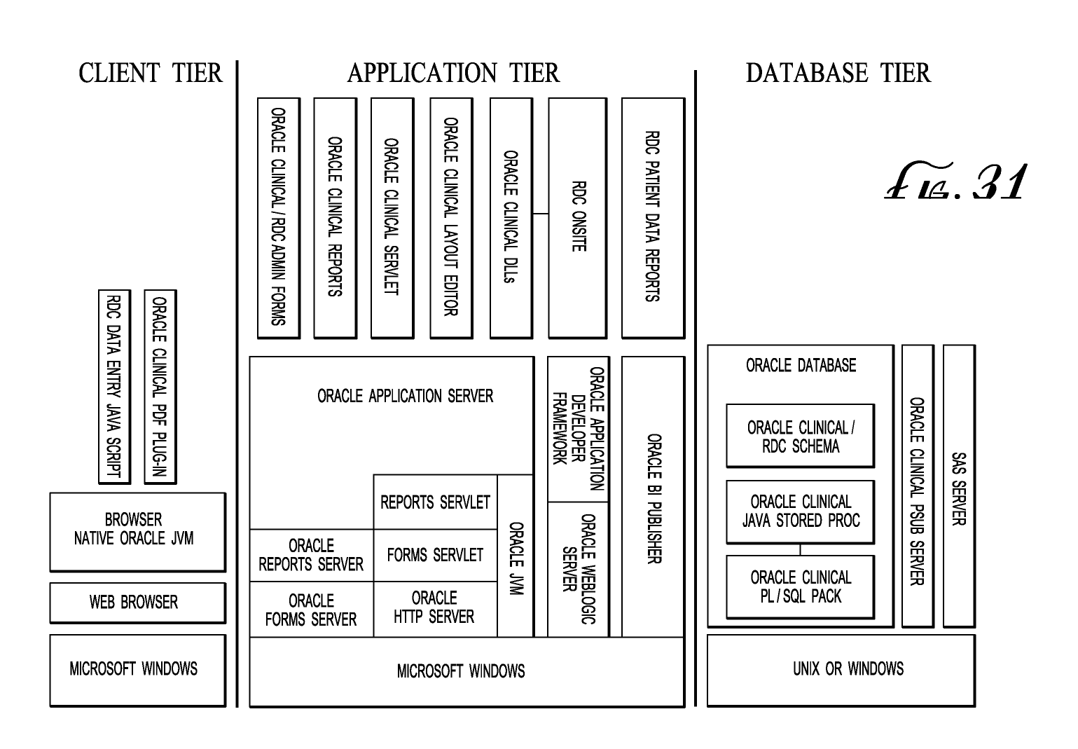

The OHS 5.1.x Logical Architecture is schematically shown in FIG. 31.

### Recommended Hardware

The recommended hardware to properly run the Oracle TMS to Medidata Rave Integration (TMSINT) includes:
A Database Server: with
   Oracle RDBMS 11 g (11.2.0.x) on Windows 2008/2012 64 bit Enterprise Edition
   Dedicated: 12 CPU with RESERVE of 3000 Ghz each (locked in VMware configuration)
   Memory Allocation: 32 GB Memory RESERVED memory allocation
1 Application Tier server with:
   Oracle WebLogic and 11 g App, on Windows 2008 64 bit Enterprise Edition. Note.
   Dedicated: 4 CPU with RESERVE of 3000 Ghz each (locked in VMware configuration), and
   Memory Allocation: 32 GB Memory RESERVED memory allocation
   Windows 2008/2012 R2 Enterprise Edition is required for memory allocation above 16GB.
Client:
   Windows 2008 R2/Windows 9/10/11, Windows 7 (or later compatible versions) with Internet Explorer 9/10/11(or later compatible versions).
   All desktop/iOS/Android clients supported via RDP or Citrix
   To reduce costing, internal RAID-5 disk configuration is suggested on the ESXi host. This configuration of DL 380 G9 has excellent performance overall for INTERNAL RAID-5 disk configuration, where production performance is NOT expected to be impacted.
   Development and Validation can be scaled at 50% of the production capacity for Memory and CPU, and left as UNRESERVED. This will allow a fall-over capability from the Production ESXi to the Development/Validation ESXi servers.
   There will be 2 VMs each provisioned for Development, Validation and Production across each ESXi server. This will allow maximum SRM failover capability.

One skilled in the art will recognize that later compatible versions of the software and operating systems listed above can be used with RAVE software specifically upgrade or adapted to run on or be compatible with those versions of the software and operating systems.

### Server Specifications

The preferred server specifications are set forth in Table 10.

TABLE 10
SERVER SPECIFICATIONS

| Item | Specification |
|---|---|
| Windows Physical Servers | 2 HP ProLiant DL380p Gen9 Server (1 for Development/UAT and 1 for Production) |
| | HP DL380p Gen9 Intel Xeon E5-2690v2 (3.0 GHz/10-core/25 MB/130 W) FIO Processor Kit HP 128 GB |
| | (8 × 16 GB) Dual Rank x4 PC3L-12800R (DDR3-1600) Registered CAS-11 Low Voltage Memory Kit |
| | Servers are under 3 year warranty, but covered 24 × 7 on-site hardware support |
| Dedicated Rack: | Cyrus One State-of-the-Art Data Center, Totowa NJ |
| | 50,000 sf. data center space (36″ raised Floor) |
| | 16 MW of power (two feeds) |
| | Designed to Deliver 99.999% Availability |
| | Two Separate Feeds from the Utility Company |
| | 2N Uninterruptible Power Supply (UPS: 24 × 750 KVA Units) |
| | N + 2 Generator Sets & Feeds (10 × 2 MW Units) |
| | 24 × 365 NOC, Tech Support, Env. Monitoring |
| | Network monitoring |
| | All technical personnel on-call 24 hours per day |
| | ISP Carrier neutral, high scalability bandwidth |
| | 24 × 365 security monitoring and patrol |
| | CCTV security with digital video backup |
| | Biometric access readers |
| | People-trap on data center entry |
| | SAS 70 Level II Compliant Annual Audit |
| Dedicated Power | Cabinet Power 30 a/110 v (Configured as 2N) |
| Monitoring | 2 application specific monitored services per VM |
| | CPU utilization |
| | Memory utilization |
| | Performance data |
| | Disk utilization and performance Custom reports |
| | Network performance |
| | Event log monitoring |
| | Best practice checks |
| | Hardware failure |
| | Baseline performance checks |
| | Cafe O/S services |
| | HTTP Port 80/443 Web Site Availability |
| Network | 1 Catalyst 2960G 24 Ethernet 10/100/1000 ports, 4 of which are dual-purpose |
| VMWare ESXi processor | 2 CyrusOne VMWare support monthly hours |
| licenses | |
| MS Software and MS | Microsoft Windows Server 2008/2012 R2 SP1 Standard Edition Processor based licenses |
| Software Support | with SPLA program (Service Provider License Agreement). |
| | This includes a monthly fee for licensing, as well as any and all tools needed to support, support |
| | numbers with direct MS reps, access to any and all of the most current service packs, patches, etc. |
| | SPLA actually incorporates MS software assurance |
| Connectivity | 10 Mpbs Up to 15 Burstable Mbps of Network Connectivity |
| IP Addressing | /28 Public IP Address Block |
| Firewall | 1 Dedicated Firewall - Cisco ASA 5510 Firewall Edition |
| Dedicated Customer Site to | Aggregate Throughput: Cleartext up to 300 Mbps for device |
| Site VPN | VPN Up to 250 IPSEC VPN peers |
| | Up to 250 SSL VPN peers (1 included, additional licensing required) |
| | Encryption: 3DES/AES |
| | Interfaces: 3 Fast Ethernet + 1 management port (Example: DMZ, Inside, Public) |
| | Connections Supports a maximum of 50,000 concurrent sessions (upgradeable to 130,000) |
| Managed Storage Services | 1000 GB Managed Fiber based SAN storage |
| | 4 Gb Fiber Channel HBA's in an Active/Active configuration, max connection rate of up to 8 Gb/s |
| | Raid - 5 + 0 LUN presented to each server through isolated zone on the fiber channel switches |
| | 24 × 7 NOC monitoring and Performance Monitoring |
| SRM VM Replication | Site-to-site replication to copy VM every day to Wappinger Falls |
| | Full backups are performed between Friday (after 9 pm EST) and Sunday at midnight |
| | Daily incremental jobs are perfomed Monday through Thursday (after 9 pm EST) |
| | Daily Incremental backups are retained for 7 days |
| | Weekly Full backups are retained for 3 weeks |
| | Monthly full backups are retained for 3 months |
| | 2 Free Restores per month |
| | 2 Restore tests of the entire PRODUCTION VMs ONLY each year |
| Customer -thirty six(36) | All DEDICATED Windows Servers (ALL VMWARE Deployments, As needed for number of VMs per |
| Hosting Hardware Quote | server) |
| | Hardware Terms: Manage Platform Base Services 24 × 7 |
| | (Support Hours: UNLIMITED per server) |
| | Operating System configuration and administration |
| | Patch Deployment |
| | Hardware Maintenance Base Services 24 × 7 |
| | (Support Hours unlimited per server) |
| | Spare parts onsite |
| | Hardware and OS Troubleshooting |
| | On-Site Parts replacement |
| | SLAs: |
| | 99.999% infrastructure and network availability (not including application failures or application bugs or |
| | application data restores or ARIAD-based human error or Argus application bug data loss) |
| | Hardware Failure Response: 15 mins SLA |
| | Hardware Repair: 2 hours SLA |

### Failover

Acquisition and deployment of HP DL380 Gen9 servers DEDICATED to the users OC/TMS environment running VMWare ESXi 5.5.x or 6.x.
Dedicated rack space and network connectivity and managed servers are required at the user facility, which currently operate other production applications in a hot standby/hot failover mode. Applicant then dedicated servers on-line at both the user and applicant's facilities to perform the development, validation and production target environments running VMWare ESXi with a documented IQ for the hardware installation and ESXi installation.
Network connectivity is established between the provider and the users data center, in cooperation with the users networking team. Dedicated hardware is preferred for several reasons because it provides a secure data isolation level from any other user's environments and allows user to acquire the most current hardware for performance and scalability purposes.

### Synchronous Integration Using Web Services

The Medical Coding Solution supplied by the provider allows for direct data transfer from EDC and Safety Database systems via WebServices and similar technology. The processes are provide according to a fixed schedule an also as required as web services. This synchronous approach uses Rave Web Services. Rave Web Services (RWS) integrates Medidata Rave with third-party systems to exchange CDISC ODM 1.3 standard clinical data or metadata synchronously and with immediate confirmation. RWS uses the Representational State Transfer (RESTful) architecture. Data is posted to or retrieved from Rave using HTTP protocol messages posted to specific URLs. Each message received is programed to provide an immediate success or failure response. In the event of a failure, any pending changes are rolled back. Since RWS uses “RESTful” web services, it does not mandate the use of either Simple Object Access Protocol (SOAP) or Web Services Description Language (WSDL).

### Synchronous Integration High-Level Architecture

The study dataset is extracted from the source Medidata system using the RWS. https://{host}/RaveWebServices/studies/{study-id}/datasets/{regular-or-raw}. The extracted information is pushed to staging tables in the providers Custom TMS integration system. The DBMS Custom APIs processes the data and identifies the items that require coding, a coding classification or opening a query. Each Open query of each such identified item on the source system is updated using the RWS and validated against TMS and other related identied updates/queries. Updated/open queries are imported to Medidata and updated/current datasets are extracted from Medidata.

### Asynchronous Integration Using Text File

The system described herein saves the study datasets information in a file in standard ODM format and processes the information to validate against TMS using a DBMS Custom integration system. This asynchronous integration high-level architecture extracts the study dataset from a text file placed on an accessible location and pushes the extracted information to staging tables of the DBMS Custom TMS integration system. The DBMS Custom APIs processes this data and identifies the items that require coding, a coding classification or opening a query. A text file is then generated for each item that requires an Update/Open query and this text file which contains the xml request body that a RWS can accept. Demonstration of User administration in TMS includes validation against TMS and identifying the updates/queries, generating text file for each identified update/open query action and reading datasets from a text file.

### User Administration in TMS

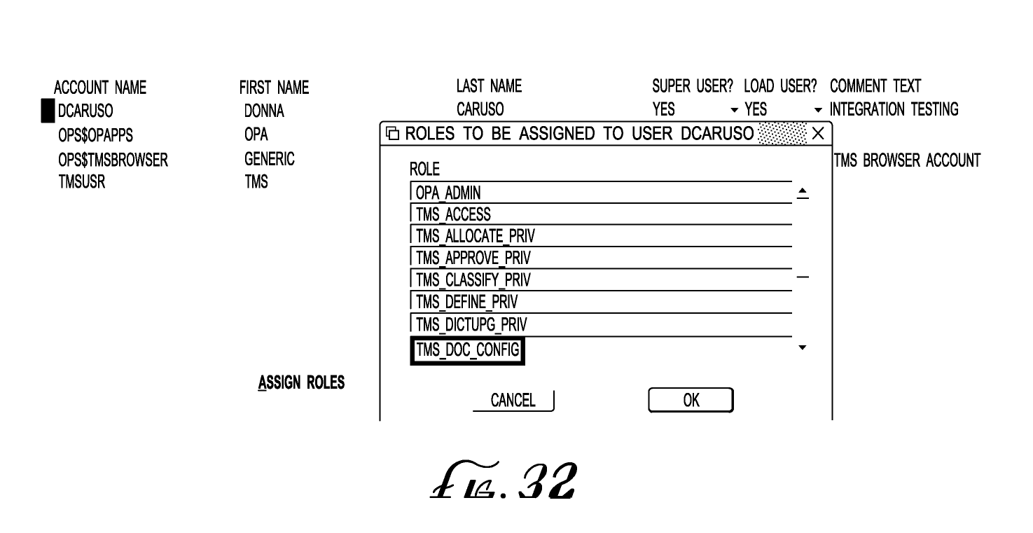

User administration overview comprises creating, configuring, modifying, and inactivating portions of the stored records. The TMS Security module is used to create users, assign roles and deactivate users and to define access rights to different users. TMS allows workflow assignments based on role (e.g. those responsible for coding and those responsible for approval). The predefined roles are: opa_admin, rxclin_read, tms_access, tms_allocate_priv, tms_approve_priv, tms_classify_priv, tms_define_priv, tms_dictupg_priv, tms_dsi_priv, tms_integrate_priv, tms_maintain_priv, and ms_reclassify_priv, tms_research_priv. (See FIG. 32)

### Synchronous Integration Using Web Services

The Medical Coding Solution described herein allows for direct data transfer from EDC and Safety Database systems via WebServices and similar technology. The processes are exposed as web services and are scheduled as required. The synchronous approach uses Rave Web Services (RWS) to integrate Medidata Rave with third-party systems and to exchange CDISC ODM 1.3 standard clinical data or metadata synchronously and with immediate confirmation. RWS uses the Representational State Transfer (RESTful) architecture. Data is posted to or retrieved from Rave using HTTP protocol messages posted to specific URLs. Each message receives an immediate success or failure response. In the event of a failure, any pending changes are rolled back. Since RWS uses “RESTful” web services, it does not mandate the use of either Simple Object Access Protocol (SOAP) or Web Services Description Language (WSDL).

### Synchronous Integration High-Level Architecture

The study dataset is extracted from the source Medidata system using the RWS (https://{host}/RaveWebServices/studies/{study-id}/datasets/{regular-or-raw}) and the extracted information is moved to staging tables of the TMS integration system. The DBMS Custom APIs processes this data and identifies the items that require coding, a coding classification or open a query. Each identified Update/Open query item on the source system using the RWS is validate against TMS and the updates/queries are imported to Medidata and data sets are extracted from Medidata. Asynchronous integration using text file

In the system the study datasets information is saved in a file in standard ODM format and this information is processed to validate against TMS using the Custom Asynchronous integration high-level architecture: The study dataset is extracted from a text file placed on an accessible location, the extracted information is pushed to staging tables of the Custom TMS integration system., the Custom APIs process this data and identify the items that require coding, a coding classification or opening a query, and a text file is generated for each item that requires an Update/Open, this text file containing the xml request body acceptable to a RWS. User administration in TMS is validated against TMS, the updates/queries are identified, a text file is generated for each identified update/open query action and datasets are read from a text file.

### Coding Configuration

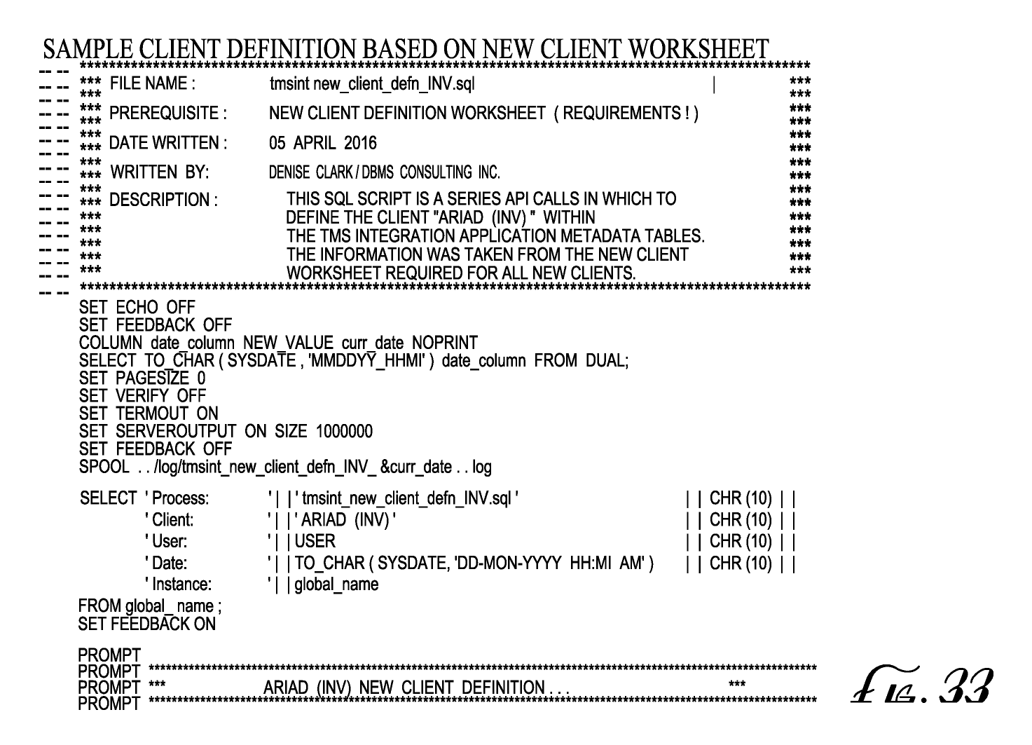

The TMSINT application Definition Worksheet is used by the Administrator to configure the verbatim, route and indication fields and all other definitions and configurations for the client for coding the TMS Reference Codelists and the TMS External Systems. FIG. 33 is a sample of a Client definition based on a new client worksheet. The TMSINT application has the ability to reuse study field configurations (e.g. copying the configuration for an AE Verbatim between studies). A template SQL script is provided that may be cloned and modified for the given client being defined similar to the SQL script that has been designed to accommodate subsequent executions and will initially delete the client and all related data prior to executing the SQL script.

### High Level Process

Client Clinical Trial System Source System Configuration Setup—A new client is setup for use with the TMSINT application. This includes determining the client's TMS dictionary requirements, external system requirements and detailed information on the format of the client's source data subject to processing.

Client Clinical Trial System Source System Data Extract—During the configuration setup of a client within the TMSINT application, a client specific Oracle schema is created that is responsible for extracting data from the clients Clinical Trial System Source system for TMS processing as well as re-importing data back into the client's source CDR system. The Oracle schema is referred to as the “data-transfer” schema and is only responsible for the transfer of data from the client system and back into the client system. The APIs within the package TMSINT_XFER_UTILS are written exclusively for the data-transfer functionality. Data extracted from the client's source system is written to a staging table (TMSINT_XFER_HTML_EXTRACT) in a raw HTML format by the data-transfer schema. Data to be re-imported into the clients' source system is written to staging tables by the data-processing schema

Resetting HTML Extract Records to Process in TMS—The application has been written so that processing data subsequent times will not have an impact when no changes are detected. In order to re-process data in the TMSINT_XFER_HTML_EXTRACT table, the PROCESS_FLAG value is updated from “Y” back to “N” using the API TMSINT_XFER_UTILS.RESET_XFER_FOR_PROCESSING to perform this update.

Deleting/Purging Previously Processed HTML Extract Data—Data within the data-transfer staging table TMSINT_XFER_HTML_EXTRACT remains in the staging table until purged. User's discretion determines how long to maintain previously processed data within the staging table.

Deleting/Purging All HTML Data Records—The API TMSINT_XFER_UTIL.CLEAR_ALL_EXTRACT_DATA can be used to hard-delete all data in the staging table regardless of the PROCESS_FLAG. This API is intended for testing and development or to prevent all subsequent data processing.

Client Clinical Trial System Source System Data Formatting—During the configuration setup of a client within the TMSINT application, a client specific Oracle schema, referred to as the data-processing schema, is created that is responsible for processing data from the clients Clinical Trial System Source system within TMS. The data-processing schema is responsible for obtaining the client data pending processing from the data-transfer owned staging tables, processing the data in TMS, and subsequently writing the applicable TMS processed data back to data-transfer staging tables to be re-imported back into the client's source system. The APIs within the package TMSINT_PROC_UTILS are written exclusively for the data-processing functionality. The API process TMSINT_PROC_UTILS.PROCESS_INBOUND_FROM_XFER performs this action. As data is read and formatted from the TMSINT_XFER_HTML_EXTRACT table, it is written to the data-processing staging tables TMSINT_PROC_INBOUND and TMSINT_PROC_INBOUND_DTLS (ancillary data). Data is marked as processed in the data-transfer table once the record(s) have been successfully formatted and written to the data-processing schema INBOUND staging tables.

Creating TMS INBOUND Processing Records—Once the PROCESS_RECNO column has been populated, multiple HTLM data records can be selected for insertion into the data processing staging table TMSINT_PROC_INBOUND. If the client has defined ancillary data, the corresponding data is created in the TMSINT_PROC_INBOUND_DTLS tables. If a client does not have ancillary data as defined in the configuration table TMSINT_ADM_ADDON_COMUMNS then no data will be written to TMSINT_PROC_INBOUND_DATA. As each record is successfully formatted and written from the data-transfer staging table (TMSINT_XFER_HTML_EXTRACT) to the data-processing staging tables (TMSINT_PROC_INBOUND/TMSINT_PROC_INBOUND_DTLS), the data in the TMSINT_XFER_HTML_EXTRACT table is marked as processed by updating the PROCESS_FLAG from “N” to “Y” which will prevent the data from being re-processed.

Re-processed HTML Records—It may be desired at some point to re-process data in the data-transfer table TMSINT_XFER_HTML_EXTRACT a subsequent time. The application is written such that processing data subsequent times will not have an impact when no changes are detected. In order to re-process data in the TMSINT_XFER_HTML_EXTRACT table, the PROCESS_FLAG value is updated from “Y” back to “N” using The API TMSINT_PROC_UTILS.RESET_XFER_FOR_PROCESSING to perform this update. The next execution of TMSINT_PROC_UTILS.PROCESS_INBOUND_FROM_XFER re-processes the extract data.

Client Clinical Trial System Source System Data Processing—After the HTML extract data has been read from the data-transfer schema, formatted and created in the data-processing schema INBOUND staging tables via the API TMSINT_PROC_UTILS.PROCESS_INBOUND_FROM_XFER, the data can then be processed in TMS. The API to process the INBOUND data in TMS is TMSINT_PROC_UTILS.PROCESS_INBOUND_IN_TMS. This process creates VTAs in the TMS repository, creates patient coding records in TMS_SOURCE_TERMS and creates patient omission records in TMS_VT_OMISSIONS. At the onset of processing, each record in TMSINT_PROC_INBOUND in which the TMS_PROCESS_FLAG is “N” will be set to a TMS_PROCESS _FLAG value of “P” (“in progress”). For each of the “in progress” records, the TMS related columns are populated based on attempts of coding the given record in TMS.

Keeping Client Data “Synchronized” with the TMS Repository—With EVERY execution of the API TMSINT_PROC_UTILS.PROCESS_INBOUND_IN_TMS, the procedure CODING_DATA_SYNC_RECHECK is executed PRIOR to processing the pending data in the INBOUND tables. This procedure reviews all pre-existing client data in the CODING tables to detect if any of the conditions listed below have occurred. If so, a “copy” of the CODING record will be created in the INBOUND tables for re-processing if it does not already exist in the INBOUND tables.
Has the VTA been declassified? (patient coding is now a patient omission)
Has the VTA been classified (patient omission is now a patient coding record)
Has the VTA been re-classified? (manual reclassification or direct-match reclassification during versioning)
Has the VTA's parent DT been updated? (dictionary version upgrade)
Has the VTA's parent DT been made inactive? (dictionary version upgrade)
Has the VTA's parent DT been promoted? (dictionary version upgrade)
Has the VTA's parent DT been demoted? (dictionary version upgrade)
Has one or more components of the “Derviation Path” changed? (dictionary version upgrade)

Processing INBOUND data in the TMS Repository—Moving INBOUND_Data to the CODING Tables—After each TMSINT_PROC_{—} INBOUND record is processed and the TMS related columns have been populated, the records are moved from the INBOUND staging tables to the CODING tables. The CODING table data is persistent and will always represent the current client data in TMS at the time of the last execution of TMSINT_PROC_UTILS.PROCESS_INBOUND_IN_TMS. If the INBOUND VT term and the External Values 1 . . . 8 do not exist in the CODING table, then this is a new patient record being processed. If the INBOUND VT and the External Values 1 . . . 8 already exist in the CODING table, and all TMS values and all client data values are the same, then the record has been previously processed and nothing has changed since the time the record was last processed. If the INBOUND VT and the External Values 1 . . . 8 already exist in the CODING table, but one or more TMS values and/or client data values are the different, then the record has been previously processed but something has changed within the client data or within the TMS repository since the time the record was last processed.

### Administrator Owned Tables (TMSINT_ADM)

The TMSINT_ADM administrator schema owns all of the application metadata tables. The metadata tables allow for the definition and configuration of a client for use with the TMSINT application. The metadata data tables facilitate “generic” applications and stored procedures that can be useable by all client configurations eliminating the need for client custom specific source code. The application owner can view all data within metadata tables while the client specific data-transfer and data-processing Oracle schemas can see only data applicable to the client in which the Oracle schema is associated. The application metadata tables require that accurate requirements be collected for a given client and properly defined within the metadata tables at the onset of processing.

TMSINT_ADM_PROPERTIES table allows for the definition of various properties within the TMSINT application. The only required entry within the properties table during the installation process is the name of the Oracle account that is the TMINT application owner. For the application owner, the PropertyCategory is “APPLICATION”, the PropName is “OWNER” and the PropValue is the Oracle schema owning all of the application objects which is “TMSINT_ADM”. The properties table may optionally be used to specify other miscellaneous properties as needed. A SQL script is executed during the installation process as the application owner that will automatically create the required entry in the TMSINT_ADM_PROPERTIES table. Additional SQL scripts are provided to insert, update, and delete properties as needed.

TMSINT_ADM_CLIENTS table allows for the definition of a client within the TMSINT application. Each client is assigned a unique numeric identifier and alias code. The numeric identifier, Client-ID is used as a foreign key in other metadata tables for referential integrity. The value of the client alias code selected dictates the names of the Data-Transfer and Data-Processing schemas TMSINT_XFER_<client-alias> and TMSINT_PROC_<client-alias>, respectively. SQL scripts are provided to easily allow for the insert, update, and delete of clients data.

TMSINT_ADM_DATAFILES table allows for the definition of datafiles within the TMSINT application for a specific client in TMSINT_ADM_CLIENTS. A client may have one or more datafiles, but a datafile can be assigned to only one client. Each datafile is assigned a unique numeric identifier (DatafileID) that is used as a foreign key in other metadata tables that have a child relationship to the datafile at hand. A datafile is the URL (e.g. https://pharmanet.mdsol.com/RaveWebServices) in which to access the client's datafile, which is an HTML document. In addition to the datafile URL, the user name and password credentials needed to access the client datafile URL are required. Each datafile corresponds to one clinical study name. When data is processed in TMS, the TMS domain name will be the “Study Name” concatenated with the string “_DOMAIN” for all coding records within the given datafile. New datafiles can be added to an existing client at any time. To temporarily or permanently discontinue processing of any datafile, the Active Flag can be updated to “N” and to reinstate processing the Active Flag is reset back to “Y”. All datafiles are initially created as active. SQL scripts are provided to easily allow for the insert, update, and delete of client datafiles.

TMSINT_ADM_DICT_MAPPING (dictionary mapping) table is a child table to the datafiles table TMSINT_ADM_DATAFILES and will contain one record for every DCM/VT within a datafile to be coded in TMS. For example, a single datafile can contain a DCM/VT (AE/AETERM) that is applicable to adverse event MedDRA coding and a DCM/VT (CONMEDS/CMTERM) that is applicable to Drug coding or multiples of each. The dictionary mapping table associates the specific DCM/VT to be coded with a specific dictionary in TMS. This information is used during TMS processing by the Data-Processing schema. A new DCM/VT dictionary mapping can be added to an existing datafile at any time by adding the new record to the TMSINT_ADM_DICT_MAPPING table. To temporarily or permanently discontinue processing of a DCM/VT within a given datafile, the Active Flag is set to “N”; to reinstate processing of the DCM/VT within the datafile, the Active Flag is reset to “Y”. All datafile dictionary mappings are initially created as active. The TMS Dictionary must already exist in the TMS repository prior to adding a datafile dictionary mapping. SQL scripts have been provided to easily allow for the insert, update, and delete of datafile to dictionary mapping.

TMSINT_ADM_EXT_MAPPING (external system mapping) table is a child table to the datafiles table. This table creates a relationship between a given client datafile and a defined TMS External System. The table contains one record for every column defined in TMS definition of the External System which can be at most eight values (ExtValue1-ExtValue8). If the TMS External System has 6 defined external column values (Study, Site, Patient, Event, etc.) there can be only one record for each defined external system column. This table is used by the TMSINT application to parse the datafile values that will ultimately be stored in TMS during processing. New external system mappings may be added to an existing datafile at any time as long as it corresponds to the TMS definition of the external system. To temporarily or permanently discontinue processing of a given external system column, the Active Flag is set to “N”: to reinstate the Active Flag is set back to “Y”. All datafile external mappings are initially created as active. The TMS External System must already exist in the TMS repository prior to adding a datafile external system mapping. SQL scripts are provided to allow for the insert, update, and delete of datafile to external system mapping.

TMSINT_ADM_ADDON_COLS (add-on column mapping) table is a child table to the datafiles table. This table provides and optional means to collect and store ancillary data associated to a specific DCM within a given datafile. The column values will not be stored within the TMS repository during the coding process. However, they may optionally be used for later omission management via TMS Drill-Down views in which ancillary data can be queried and viewed as additional data to aid in the manual classification process. By default, the ancillary data is stored in the TMSINT application tables but not directly accessible from TMS. Ancillary data is optional and as many columns as needed may be stored which may differ between DCMs. For the Adverse Event (AE) DCM, it may be desirable to capture ancillary data such as the onset date (ONSDT) or the severity (ONSER). For the Concomitant Medication (CM) DCM it may be desired to capture the dose (CMDOSE) and frequency (CMDOSFRQ). To temporarily or permanently discontinue processing of a given external system column, the Active Flag can be set to “N” and to reinstate processing the Active Flag is set to “Y”. All datafile add-on column mappings are initially created as active. SQL scripts have been provided to easily allow for the insert, update, and delete of datafile ancillary data.

TMSINT_ADM_ORA_ACCOUNTS (Oracle accounts) table is the metadata table that allows the Oracle schema to be programmatically associated to a specific client. Each client has a data-transfer schema (account type=“XFER”) and a data-processing schema (account type=“PROC”). This table is the mechanism that allows a given Oracle schema to only see the data associated to the given client in which the Oracle account is associated. When creating the required accounts for a TMSINT application client, the actual Oracle schema must be pre-existing in the Oracle database and will be validated using the Oracle view ALL_USERS based on user name. Creating or deleting entries does not actually create or drop the Oracle schema in the database but is more of a “registration” process which creates a relationship between the Oracle schema and a client as well as controls the selection of client data between the Oracle schemas. Additional SQL scripts are provided to create the Oracle schemas in the database which will default the Oracle password for accounts to the user name. For example, the SQL script to create a data transfer schema for client “INV” will create and Oracle user of TMSINT_XFER_INV and the account will have an Oracle password of TMSINT_XFER_INV. The Oracle database password may optionally be changed at any time using normal Oracle means (ALTER <username> USER IDENTIFIED BY <psw>;). When passwords are modified within the database, it is preferred that the corresponding password in the Oracle accounts table be updated as well. The Oracle passwords within the Oracle accounts table are used for query only and not used to connect to the database at the time of this document. SQL scripts are provided to easily allow for the registration and un-registration of Oracle accounts as well as suspending and unsuspending of the accounts by modifying the Active flag to “N” and “Y”, respectively. Suspending the Oracle Data-Transfer schema by setting the Active Flag to “N” “suspends” or prevents the data transfer activity. Unsuspending the Oracle Data-Transfer schema but setting the Active Flag to “Y” allows the data transfer activity to resume. The same actions can occur for the Data-Processing schema.

Data-Transfer Owned Tables (TMSINT_XFER_<client>)

Each client defined within the TMSINT is required to have a data-transfer schema. Data stored within this schema is applicable only to the client in which it is associated and is not intended to persist. The data-transfer schema is applied to a staging area only in which data will be extracted from the client's source CDR system for processing and subsequently re-incorporated back into the client's source CDR system where required.

TMSINT_XFER_HTML_EXTRACT table is the staging table that is used to store data extracted from the client source system. Client data is extracted from an HTML document (i.e. client datafile) and written to the TMSINT_XFER_HTLM_EXTRACT staging table in the original HTLM format. APIs are written to insert and delete data from the extract staging table. The APIs exist within the TMSINT_XFER_UTILS package owned by the TMSINT application administrator account (TMSINT_ADM).

Data-Processing Owned Tables (TMSINT_PROC_<client>)—Each client defined within the TMSINT application is required to have a data-processing schema. Within the data-processing schema a series of tables exist as shown table 11.

TABLE 11

| TMS Staging Tables | Current Client Coding Data | Client Historical Coding Data |
|---|---|---|
| TMSINT_PROC_INBOUND → | TMSINT_PROC_CODING → | TMSINT_PROC_CODING_JN |
| TMSINT_PROC_INBOUND_DTLS → | TMSINT_PROC_CODING_DTLS → | TMSINT_PROC_CODING_DTLS_JN |
| TMSINT_PROC_INBOUND_DERV → | TMSINT_PROC_CODING_DERV → | TMSINT_PROC_CODING_DERV_JN |

TMSINT_PROC_INBOUND (inbound processing) table is the TMS staging table that stores data directly obtained from the data-transfer HTML extract table TMSINT_XFER_HTML_EXTRACT after being transformed into a TMS useable record format. Generic APIs are written to programmatically obtain the HTML extract data, transform data, write the data to the inbound processing table, and subsequently mark the data-transfer extract data as having been successfully processed (i.e. copied to INBOUND). The APIs exist within the TMSINT_PROC_UTILS package owned by the TMSINT application administrator account (TMSINT_ADM).

TMSINT_PROC_INBOUND_DTLS (inbound details processing) table is the staging table that stores any ancillary data values obtained from the data-transfer HTML extract table that was transformed from HTML into a useable and meaningful format. If the client has no defined ancillary add-on columns in TMSINT_ADM_ADDON_COLS, then no data will be stored within the inbound details table; otherwise data is parsed from the HTLM data based on the corresponding HTLM_PREFIX value in TMSINT_ADM_ADDON_COLS. The records within the inbound details table are associated with a specific TMS coding record within the inbound table via the foreign key value INBOUND_ID. The data values within the inbound details table may optionally be used for TMS Drill-Down views to be viewable from the TMS application.

TMSINT_PROC_INBOUND_DERV (inbound derivation processing) table (i.e. “Derivation Path”) is the staging table that stores the TMS “Derivation Path” for those records processed in TMS that successfully code to a TMS dictionary term. When an inbound record successfully codes in TMS, the column TMS_DT_CONTENT_ID within the TMSINT_PROC_INBOUND table contains the TMS DictContentID of the dictionary term (DT) in which the VTA has been assigned in the TMS repository. Using the TMS DictContentID, the full TMS “Derivation Path” is derived and each column value stored as one record in the TMSINT_PROC_INBOUND_DERV table. The records within the inbound derivation table must be associated to a specific TMS coding record within the inbound table via the foreign key value INBOUND_ID.

TMSINT_PROC_INBOUND_DERV—The Oracle views TMSINT_ADM_DERV_PATH_LEVELS and TMSINT_ADM_DERV_PATH_COLUMNS are owned by the TMSINT application administrator and are used to determine what TMS dictionary levels are applicable to each dictionary “Derivation Path” and what column values are retrieved from TMS for each applicable dictionary level to be stored in the TMSINT_PROC_INBOUND_DERV table. Unlike the TMSINT_PROC_INBOUND and TMSINT_PROC_INBOUND_DTLS tables which are populated via client data, the TMSINT_PROC_INBOUND_DERV is populated based on “derived” TMS repository data.

TMSINT_PROC_CODING—After data within the TMSINT_PROC_INBOUND staging table is successfully processed in TMS, it is written to the TMSINT_PROC_CODING table and subsequently removed from the INBOUND staging table. Unlike the TMSINT_PROC_INBOUND table which is a temporary staging table, the TMSINT_PROC_CODING table data will persist and will represent a client's current TMS coding data. Generic APIs are written to programmatically transfer data from the staging table TMSINT_PROC_INBOUND to the TMSINT_PROC_CODING data table.

TMSINT_PROC_CODING_DTLS (coding details) table is the table that will store any ancillary data values for the parent record in the TMSINT_PROC_CODING table identified by the foreign key CODING_ID. If the client has no defined ancillary add-on columns in TMSINT_ADM_ADDON_COLS, then no data will be stored within the coding details table; otherwise data is copied directly from the TMSINT_PROC_INBOUND_DTLS table. The data values within the coding details table can be used for TMS Drill-Down views to be viewable from the TMS application.

TMSINT_PROC_CODING_DERV (coding derivation) table (i.e. “Derivation Path”) stores the TMS “Derivation Path” for those records in TMSINT_PROC_CODING in which the TMS_DT_CONTENT_ID contains a non-null value indicating there is a corresponding patient coding record in TMS_SOURCE_TERMS. The TMSINT_PROC_CODING_DERV table contains one record per derived column and derivation path level. Data is created in the TMSINT_PROC_CODING_DERV only from the TMSINT_PROC_INBOUND_DERV table.

Journaling Tables include the TMSINT_PROC_CODING_JN table, the TMSINT_PROC_CODING_DTLS_JN and the TMSINT_PROC_CODING_DERV_JN. TMSINT_PROC_CODING_JN table is a journal/audit table used to maintain a history of changes applicable to the TMSINT_PROC_CODING table. The TMSINT_PROC_CODING_DTLS_JN table is a journal/audit table used to maintain a history of changes applicable to the TMSINT_PROC_CODING_DTLS table. The TMSINT_PROC_CODING_DERV_JN table is a journal/audit table used to maintain a history of changes applicable to the TMSINT_PROC_CODING_DERV table.

### Built-In Data Recovery/Reload/Rollback Processes

The system described herein utilizes Web Services technology and built-in data recovery/reload processes to manage the source data files and metadata and handle accidental deletions, transfer interruptions, partial load, or other failures that may occur. If the data is partial loaded or deleted in the extract temporary staging tables during the source data/metadata extract, the formatting, and record creation in the data-processing INBOUND staging tables, the data can be removed/purged and reloaded subsequent times from the source EDC system. The integration has been written such that processing data subsequent times will not have an impact on previously processed data unless an update is required. During the system data processing into TMS, the data in the INBOUND table can be reprocessed and synchronized with the TMS data to ensure no loss of data.

We claim:

1. A method of collecting, monitoring and comparing data in a multi-variable, multi-participant clinical analysis system and integrating the collection and monitoring with a thesaurus database, comprising:
a. providing one or more computer-based collection units at user-facility locations for collecting medical data, validating said collected data, integrating the data with the thesaurus data base, and storing the integrated data therein from multiple participants in a clinical study, said computer-based collection unit including software-based instruction protocols for guiding the user of the data collection, monitoring and integration system through various procedural steps for the collection, analysis, comparison and storage of data entered for each of the multiple participants,
b. a remote main computer system connected to the computer-based collection unit at the user-facility, the main computer system receiving the uploaded integrated data from said computer-based collection unit for further processing and downloading new or modified collection instructions to the remote collection units,
c. providing a display means in communication with the computer-based unit for displaying data, instruction windows and graphics pertaining to the clinical study and the participants therein to the user of the remote collection unit,
d. providing data input software and an interfacing apparatus connected to the computer-based collection unit at the user-facility location to allow a user of the computer-based collection unit to interact with the data displayed in real time, wherein the user can edit the information shown on the display or input new information into the remote collection unit, wherein the input software and the interface apparatus cooperate for downloading and/or inputting new or updated clinical study details regarding the participants in the clinical study and uploading data from the remote data collection units to a data storage unit and wherein the computer-based collection units and the main computer system are synchronized so that the data accessed using the remote data collection units and the main computer system is the same.

2. The method of claim 1, wherein the data collection comprising creating, changing, or deleting data details, information parameters, and data values for each participant in the clinical study and storing those details, parameters, and values in the data storage unit for access by the main computer and the remote data collection units and the subsequent generation of reports of the data entered for each or all participants.

3. The method of claim 2 further comprising the steps of exporting data from the one or more computer-based collection units at user-facility locations, the exported data from the computer-based collection units imported to and consolidated at the main computer unit.
